(19) United States
(12) Patent Application Publication
(10) Pub. No.: US 2022/0001236 A1
(43) Pub. Date: Jan. 6, 2022

(54) COACHING, ASSESSING OR ANALYSING UNSEEN PROCESSES IN INTERMITTENT HIGH-SPEED HUMAN MOTIONS, INCLUDING GOLF SWINGS

(71) Applicant: Brian Francis Mooney, Dun Laoghaire (IE)

(72) Inventor: Brian Francis Mooney, Dun Laoghaire (IE)

(21) Appl. No.: 17/283,355

(22) PCT Filed: Oct. 9, 2019
(86) PCT No.: PCT/EP2019/077387

§ 371 Date: Apr. 7, 2021

(30) Foreign Application Priority Data
Oct. 9, 2018 (IE) S2018/0320
Dec. 4, 2018 (IE) S2018/0513
Apr. 18, 2019 (IE) S2019/0062
Jul. 2, 2019 (IE) S2019/0107

(51) Int. Cl. A63B 24/00; A63B 71/06; G06K 9/00

(52) U.S. Cl. CPC A63B 24/0006; A63B 2102/32; G06K 9/00342; A63B 71/0622

(57) ABSTRACT

The system automatically or partly automatically coaches and assesses a non-putting golf swing to increase the strength or distance of the swing. Increases are coached in the components of energy generated across specific individual joints of the player's body during the downswing. Increases are also coached in the efficiency at which the generated energy is transmitted to the clubhead. Fast or near-instantaneous feedback is provided to the player, based on measured changes in the components of energy generated in the specific individual joints and on the efficiency at which the generated energy is transmitted to the clubhead. Changes in 3D positions of the player's body segments or joints are tracked by inertial sensors or optical sensors and used in the calculation of the components of energy generated across the specific individual joints utilising an artificial intelligence system.

1. INTRODUCTION
1.1 Introductory Discussion.
1.2 Prior Art.
1.3 Definitions and Abbreviations.

2. SUMMARY USING ONE EXAMPLE OF THE INVENTION.

3. ANALYSIS TECHNIQUES.
3.1 Key Importance of PADJE Parameters.
3.2 Club Equivalents.
3.3 Defining Start and Finish of PADJEs.
3.4 Potentials of PADJE Joints.
3.5 PADJE Components.
   3.5.1 Joint-Power
   3.5.2 Powered-Angular-Displacement
   3.5.3 Powered-Angular-Velocity
   3.5.4 Powered-Angular-Acceleration
   3.5.5 Torque
   3.5.6 Time
3.6 Simplifications of PADJE Components.
3.7 Estimating Changes in Average-Torque from other PADJE Components.
3.8 Comparator Values.
3.9 Varying PADJE Components.
3.10 Phenomenon of PADJE-Proportions being largely unrelated to Skill.
3.11 Improving DRAPB, DRAPE and Span between DRAPB and DRAPE.
3.12 Transmission Efficiency.
   3.12.1 Improving Transmission Efficiency.
3.13 Preventing Injury during the Downswing.
3.14 Style-Variations.
3.15 Explanation for Unchanging PADJE Proportions and Transmission Efficiency Phenomena.

4. COACHING AND ASSESSMENT METHODS
4.1 Overview.
4.2 Particular Aspects of Coaching Unseen Parameters.
   4.2.1 Body-focuses and Non-Body-Focuses.
4.3 Coaching with Non-Body-Focuses.
   4.3.1 Coaching where PADJES or their Components are Targeted.
      4.3.1.1 Additional details on the Introductory preparation Step.
      4.3.1.2 Additional details on the Pre-Activation Preparation Step.
      4.3.1.3 Additional details relating to Feedback in the Swing.
      4.3.1.4 Additional details on the Immediate Feedback Step.
      4.3.1.5 Additional details on the Further Guidance Pre-Activation Preparation Step.
      4.3.1.6 Additional details on the Further Coaching Pre-Activation Preparation Step.
   4.3.2 Coaching where Transmission Efficiency Parameters are Targeted.
   4.3.3 Coaching where DRABE or DRAPE Parameters are Targeted.
   4.3.4 Coaching with Non-Body-Focuses where PADJEs are Not Targeted.
4.4 Coaching where Body-Focuses or Non-Body-Focuses are not Distinguished.

5. OTHER ACTIVITIES RELATED TO COACHING.
5.1 Assessment before Coaching.
5.2 Determining Kindred PADJEs.
5.3 Plan Formulation.

6. ASSESSMENT APPARATUS.
6.1 Overview.
6.2 First Example of Assessment Apparatus using Inverse-Dynamics.
   6.2.1 Summary of First Example of Assessment Apparatus.
   6.2.2 Details of First Example of Assessment Apparatus.
      6.2.2.1 Depth Sensor
      6.2.2.2 Capture Rate
      6.2.2.3 Variants with multiple synchronised Depth Sensors
      6.2.2.4 Body Segment Sensors, Inertial sensors.
      6.2.2.5 Measuring Impact
      6.2.2.6 Alignment of Force-Plates
      6.2.2.7 Grip-Division-of-Forces
      6.2.2.8 Club Characteristics.
      6.2.2.9 Inverse-Dynamics, Kinetic and Unseen-Parameters.
      6.2.2.10 User interface.
   6.2.3 First Example of Assessment applied to the Complete Swing.
6.3 Second Example of Assessment Apparatus.
   5.3.1 Variants on Second Example of Assessment.
   5.3.2 Comparison of First and Second Examples of Assessment.
6.4 Third Example of Assessment Apparatus, without Depth Sensor.
6.5 Use of a High-Speed Camera in place of a Depth Sensor.
6.6 BSIP Measurement, Apparatus and Methods.
   6.6.1 First example of BSIP Measurement, Apparatus and Method.
      5.5.1.1 Summary of First Example of BSIP-Measurement.
      5.5.1.2 General description.
      5.5.1.3 Variations of First Example of BSIP Measurement.
   6.6.2 Second Example of BSIP Measurement, Apparatus and Method.
   6.6.3 Third Example of BSIP Measurement, Apparatus and Method.
   6.6.4 Comparison of Examples of BSIP-Measurement.

7. COACHING APPARATUS.
7.1 Common Requirements for Coaching Apparatus.
7.2 First set of Examples of Coaching Apparatus—utilising Inverse—Dynamics.
7.3 Second set of Examples of Coaching Apparatus—not utilising Inverse-Dynamics.
   7.3.1 Variant where sensor means comprise a Depth Sensor and set of at least two Body Segment Sensors.
   7.3.2 Variant additionally using other already-known Information.
   7.3.3 Variant additionally using other already-known Information and Artificial Intelligence.
7.4 Third set of Examples of Coaching Apparatus—with simpler use or lower cost.
   7.4.1 Variant using a Depth Sensor or HSC and ANN—without Body Segment Sensors.
   7.4.2 Variant using a Depth Sensor or HSC and ANN without Body Segment Sensors, but with additional Clubhead Speed Measurement Means.
   7.4.3 Variant using Body Segment Sensors and Artificial Intelligence, without Depth Sensor or HSC.
7.5 Fourth set of Examples of Coaching Apparatus. Without separate Assessment.
   7.5.1 Variant using ANNs and multiple Inertial Sensors.
   7.5.2 Variant using ANNs and a Depth Sensor or HSC.
   7.5.3 Minimal variant using a reduced number of Inertial Sensors.

8. ACTIVITIES OTHER THAN GOLF DOWNSWINGS.

9. GLOSSARY OF ACRONYMS AND UNUSUAL TERMS.

### 1. INTRODUCTION

### 1.1 Introductory Discussion

The present invention provides an apparatus and method for coaching, assessing or analysing intermittent high-speed, high-energy, human motions or action-processes with repeated elements, where the underlying processes are largely internal and therefore chiefly not visible nor readily understood by an observer either in real time or in slow-motion visual playback. More particularly, the present invention provides an apparatus and method for coaching, assessing or analysing motion-sequences or action-processes of the type which occur in non-putting golf downswings.

The portion of a player's non-putting golf swing, where the processes are largely visible or can be readily understood by an observer, in real time or in slow-motion visual playback, have been extensively studied and are well understood by golf coaches and knowledgeable players. These processes include the player's address stance and grip, much of the player's visible movement and weight shift during the backswing, downswing and follow-through and the manner in which the player should direct the club head to strike the ball for desired direction, loft and spin. The processes also include adoption of correct strategies for different distances, terrains, weather conditions, club selections and many other related variables. All of these processes are of great importance in coaching a non-putting golf swing and, although complimentary to the subject matter of the present invention, are separate and distinct from it.

For many if not most players and coaches, the unseen processes which give rise to high and controlled clubhead speeds are likely to be the most enigmatic part of the golf swing because they have little or no real understanding of what they entail. It is largely unknown to coaches and players as to why players of similar physique, fitness and experience, playing the same club under identical conditions, can differ so widely in their abilities in transmitting energy to the ball at impact. In conventional coaching, improvement of these unseen processes largely depends on improvement in general fitness and strength and on reliance on a great deal of practice and experimentation with usually ineffective empirical methods, to subconsciously and inefficiently improve this most important aspect of the swing.

Very little useful prior art is available concerning these unseen processes. What is available is not widely known by players or coaches and appears never to have been used to assist practical coaching of the golf swing.

### 1.2 Prior Art

WO 2009/060011 discloses a method and apparatus for analysing a golf swing where the player and club are treated as a simplified system of linked rigid body segments through which energy is generated and transmitted to the clubhead. The overall physical mechanisms by which energy is generated and transmitted through the linked segments are disclosed and explained in considerable detail, apparently for the first time. In a preferred system, data is obtained from the player's ground-reaction forces and processed signals are assessed with an artificial intelligence means trained with data obtained from other measurement and assessment systems. It proposes methods and apparatus for measuring mechanisms or effects associated with energy generation and energy transmission. It also proposes an assessment system which largely involves comparing aspects of a player's measured performance of processes, related to the physical mechanisms or effects associated with energy generation and energy transmission through the linked segments, to equivalent aspects of performance of such processes by highly accomplished players. Coaching inference is drawn from the comparison.

WO2013/041444 also discloses a method and apparatus for analysing a golf swing where the player and club are treated as a system of linked rigid body segments, but in this instance with a much larger number of connecting joints, through which energy is generated and transmitted to the clubhead. The system utilises inverse-dynamics techniques and discloses determination of body segment inertial parameters and solutions for addressing issues of indeterminacies at the closed loops of the legs and arms in the linked chain of segments. The system is found to be capable of accurate and practical measurement of characteristics of energy generation and transmission. An assessment system is proposed for use with individual player instruction. This largely involves assessment of various qualities of the player's measured progression of joint power in the swing, including the sequences and relationships of the development of different blocks of joint power. A comparison is made between these measured qualities and the equivalent qualities of highly accomplished players. Coaching inference is drawn from the comparison.

1.3 Definitions and Abbreviations.

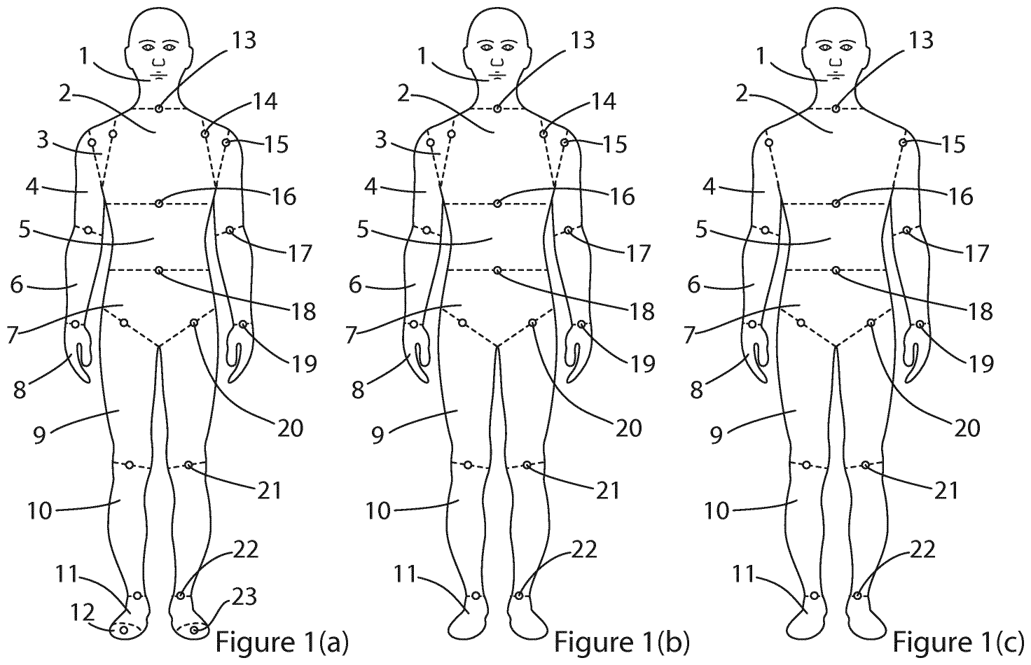

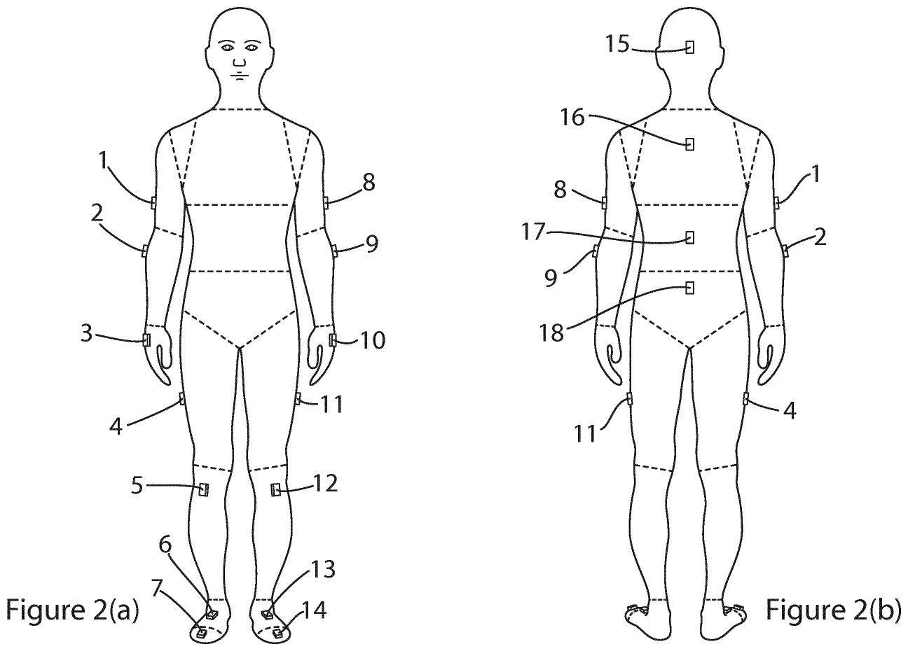

For the sake of brevity and convenience, henceforth throughout this specification, an individual executing a golf swing shall be referred to as a “player”, instructors or coaches shall be referred to as “coaches”, the terms “he” or “his” shall refer equally to male or female players, and the term “swing” or “golf swing” shall refer to a non-putting golf swing. Verbs or adjectives related to “coach” or “coaching” shall refer to either coaching by a human instructor or automated coaching or self-coaching without a human instructor using the apparatus or method of the invention. Players shall also be assumed to strike the ball in the most common direction from their right to their left side, although a mirror image of the principles will apply exactly the same to players who strike the ball in a direction from their left to their right sides.

Where reference is made to a “model” of the player, it shall refer to a model comprising rigid segments connected by joints. Models, of the types shown in FIGS. 1(a) -1(c), shall be used as examples. In FIGS. 1(a)-1(c), segment boundaries are indicated by dashed lines and joints are indicated by small unfilled circles. An index of reference numerals, used in FIGS. 1(a) -1(c), is shown below. For clarity, reference numbers for segments on the player's left side and joints on the player's right side are omitted in the figures.
1. Head (segment)
2. Middle upper trunk (segment)
3. Right upper trunk (segment)
4. Upper arm (segment)
5. Middle trunk (segment)
6. Lower arm (segment)
7. Pelvis (segment)
8. Right hand (segment)
9. Right upper leg (segment)
10. Right lower leg (segment)
11. Right foot (segment)
12. Right toes (segment)
13. Neck (joint)
14. Left inner shoulder (joint)
15. Left shoulder (joint)
16. Thorax (joint)
17. Left elbow (joint)
18. Lumbar (joint)
19. Left wrist (joint)
20. Left hip (joint)
21. Left knee (joint)
22. Left ankle (joint)
23. Left foot (joint).

The model, shown in FIG. 1(a), is depicted without the gripped club. It uses 20 joints, all of them powered, located at the left foot, left ankle, left knee, left hip, right foot, right ankle, right knee, right hip, lumbar, thorax, left inner shoulder, left shoulder, left elbow, left wrist, right inner shoulder, right shoulder, right elbow, right wrist, grip and neck. The connected segments are the left toes, left foot, left lower leg, left upper leg, right toes, right foot, right lower leg, right upper leg, pelvis, middle trunk, mid-upper trunk, left upper trunk, left upper arm, left lower arm, left hand, right upper trunk, right upper arm, right lower arm, right hand, head and club. The single grip joint connects the hands to the club. Throughout this specification, it will usually be referred to as the “20-powered-joint model”.

The model shown in FIG. 1(b) is identical to that in FIG. 1(a), except that it omits joints in the feet, between the toes and main portions of the feet. Throughout this specification, it will usually be referred to as the “18-powered-joint model”. The model shown in FIG. 1(c) is also identical to that in FIG. 1(a), except that it uses a single joint between each upper arm and the upper trunk, omits the ankle joints as a source of generated power and omits joints in the feet, between the toes and main portions of the feet. It therefore has 16 joints, 14 of which are powered. Throughout this specification, it will usually be referred to as the “14-powered-joint model”. This model is easier to use with magnetic motion-capture and was employed in determining some of the data disclosed in this specification. Other jointed segment player models may also be used. For example, the trunk may comprise multiple segments interconnected by joints along the region of the spine. The neck joint, between a head segment and mid-upper trunk segment, may be replaced with a joint between a head segment and neck segment, and a further joint between the neck segment and middle upper trunk segment.

With respect to these models, the direction of “proximal” to “distal” shall refer to the direction along the chains of connected segments away from the feet or toes, or away from the head, towards the club. The direction of “distal” to “proximal” shall refer to the opposite direction away from the club towards the head or towards the feet or toes.

The anatomical positions of the joints and segment boundaries may be identical to those disclosed in prior art document WO2013/041444, other than the foot joint which lies approximately between the toes and metatarsal bones of the foot, and also the boundaries between a foot segment and toes segment, which may comprise a plane through the foot joint, parallel to the frontal or coronal plane when the model is in a standing position with feet flat on the ground.

Unless otherwise stated, the term “downswing” refers to that portion of the swing from the top-of-backswing to impact with the ball. For most normal swings, top-of-backswing is preferably taken as the earliest of the following two top-of-backswing events—where the player's pelvis changes direction of rotation from backswing to downswing and where the club-shaft changes direction of rotation from backswing to downswing. The term “backswing” refers to the portion of the swing from address to downswing, and the term “follow-through” refers to the portion of the swing following impact, in the same general direction of rotation.

In addition to referring to the articulations in the body model, the term “joint”, or a named joint, shall also be used to refer to the joint and its associated muscle group or to activities associated with that joint. For example, left knee joint energy refers to the energy generated across the left knee by the muscle groups acting about the left knee joint. Also, throughout the specification it shall also refer only to energy generated at the joint rather than energy transmitted across or through the joint. It should be noted that energy generated across a joint (joint energy) and energy transmitted across a joint, are two entirely different parameters. The difference may be illustrated by the example of a player's wrist joints in a golf downswing. For a typical player, about 4.6% of his total joint energy is generated across the wrists, as these joints have relatively small muscle mass associated with them. However, about 95% of the total energy transmitted to the club is transmitted across the wrists, since all of the energy generated in the body, other than that at the wrists and grip, must pass through the wrists. Throughout the specification, where reference is made to actions by a processor, these should normally be understood to mean actions by an electronic processor using software. It should also normally be understood that appropriate and relevant algorithms are used within the software where required, although these will not usually be specifically stated and explained unless the required algorithm is one that would not be capable of implementation by those skilled in the art. Also, where a reference is made to a processor or system processor, this should normally be understood to refer to one or a plurality of processors, and to processors located within the apparatus or located remotely from the apparatus. Where reference is made to data being available to a processor or system, this may refer to data being available from memory means within the processor or memory means accessible from a remote location. It may also refer to data which is not held in memory, but is accessible in other ways, including being calculated by a processor when requested. It may also refer to data which is obtained from a database which is regularly changed or updated.

2. Summary Using One Example of the Invention.

Features of the invention shall now be summarised using an example where a golf swing is coached, assessed and analysed in particularly important aspects for which there is little or no understanding in prior art. These aspects relate to the hitherto unknown reasons as to why one player can have a far more powerful and controlled swing than another, even though both players appear to be equal with respect to physique and fitness, have equal experience and have swings which visually appear to be the same. The summarised specific example of the invention involves an initial assessment and subsequent coaching of a golf swing.

The portion of the non-putting swing which is particularly relevant to the present invention comprises the downswing from top-of-backswing to impact, during which the player generates energy in various muscles across the body and transmits a proportion of that energy to the club head at impact with the ball. The processes or parameters in this portion of the non-putting golf swing, which are relevant to the present invention, shall be referred to as “unseen-processes”, or as “unseen-parameters”. At a fundamental level, the invention usually includes, as one of the principal objectives of the coaching method, an increase or maximisation of the sum of positive energy generation in the muscle groups acting across individual joints of the body across the downswing. These energy generations across individual joints are referred to as positive across-downswing joint energies (PADJEs).

It has been found that in natural swings, increases in individual PADJE or total PADJE, on average, result in very close to directly-proportional increases in the amount of energy transmitted to the clubhead by impact. It has also been found that coaching a player's unseen-parameters with distance clubs, such as driver or long iron clubs, will assist in optimising unseen-parameters across all of the player's non-putting clubs.

PADJEs are largely assessed and coached using individual PADJEs or sets of PADJEs referred to as kindred PADJEs. The occurrence and format of kindred PADJEs varies widely between players and coaching systems. For the great majority of players, the most important component parameters are the powered-angular-displacements of individual joints. The torques of individual joints, although of less significance, are also important. The components of powered-angular-velocity, joint power and PADJE time duration of individual joints are also used, but have been found to usually be of less relative importance in coaching. PADJEs are also assessed and coached in relation to the points in the downswing-rotation-angle at which PADJEs begin and end, where rotation-angle refers to the general rotation of the club shaft in the downswing. Commencing the beginning and end of PADJEs angularly earlier with respect to downswing-rotation-angle, has been found to significantly assist the maximisation of total PADJE.

PADJEs are also assessed and coached by exploiting a discovered phenomenon that players typically have random-like uneven distributions of PADJE proportions which vary widely between players and are not significantly related to their skill levels, such that for most players at all skill levels there is usually very significant potential for improvement if the underperforming PADJEs can be identified and targeted in coaching. A potential explanation for this, perhaps surprising, phenomenon is given later in the specification.

The effectiveness of the player's set of PADJEs is also enhanced by improving the efficiency of its transmission to the clubhead. This also exploits a discovered phenomenon, similar to that related to PADJE proportions, again somewhat surprisingly, transmission efficiency also varies greatly between players, with similar proportions of inexperienced players and highly accomplished players having transmission efficiencies well above average and well below average. Accordingly, there is usually potential for improvement for any player who does not already have a swing with a transmission efficiency which is significantly higher than average.

Apparatus used in the example, includes assessment apparatus and coaching apparatus. Assessment recognises the need to take scientific account of the complex differences between players. The assessment apparatus determines, with a high level of accuracy, the player's unseen-parameters before coaching commences. It also determines the occurrence and format of any kindred PADJEs. Its results are used to formulate a coaching programme and act as a comparison against which progress can be measured when coaching commences. The coaching apparatus assists in coaching the player to improve his vitally important unseen-parameter performance.

In the specific example, across a local or regional population of players, assessment takes place at a central location and coaching more often than not takes place at multiple other locations. One type of higher-level coaching is typically sited at a golf-dedicated venue, or sports-dedicated venue, where a professional coach oversees the instruction of the player. The other type of coaching location involves player practice or lower-level coaching and is typically a home-use venue, where a human coach is not required and where instruction is automatically given by the apparatus processor.

In the assessment, the player's kinematic parameters are measured over the course of a set of swings with several different clubs, including a driver club or other distance club. The ground-reaction forces (GRFs) under his feet are simultaneously measured. The player's body segment inertial parameters (BSIPs) are determined either by using a procedure involving a depth sensor or by inputting a set of very easily measured key player parameters to an artificial intelligence located on the system processor, trained on a wide database of BSIP relationships. The player's grip division-of-forces over the downswing are similarly determined by inputting a set of very easily measured key player parameters to an artificial intelligence located on the system processor, trained on a wide database of grip division-of-forces relationships.

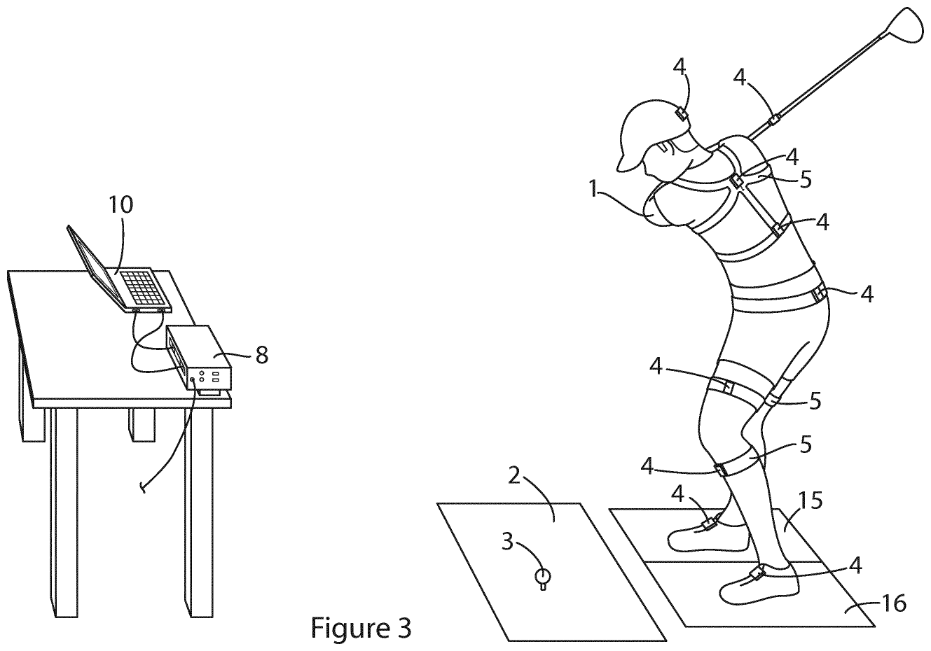

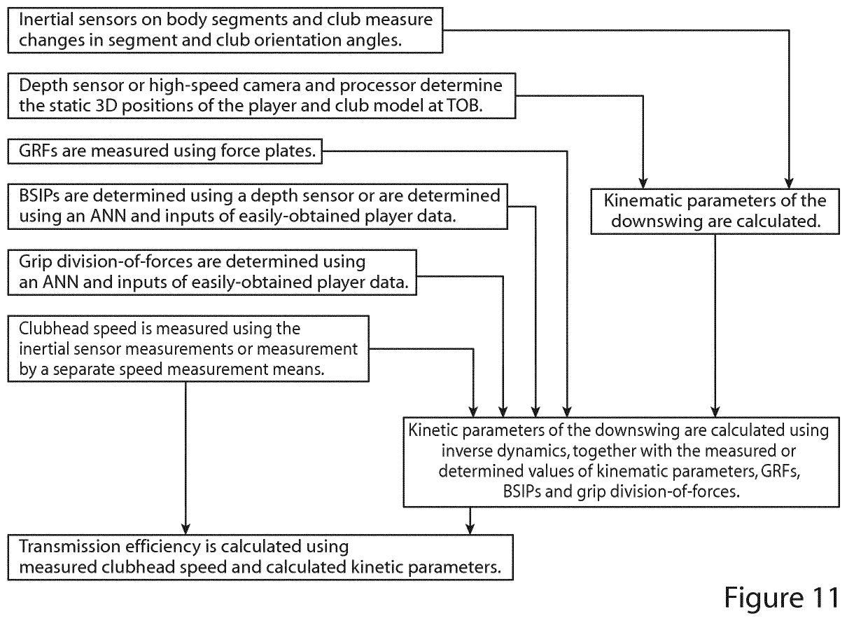

In one example of assessment apparatus, kinematic parameters are measured with a motion-capture system which comprises a low-cost depth sensor, and a set of miniature low-cost inertial sensors attached to the player's body segments and wirelessly connected to base, leaving the player completely free to move about. The depth sensor determines the player's position at the beginning of the downswing, and the inertial sensors track the movements through the remainder of the downswing. These, together with an electronic processor, a set of force-plates which measure GRFs, and knowledge of the player's BSIPs, are sufficient to rapidly and automatically measure and calculate the player's unseen-parameters. Reference is made to FIGS. 3 and 11, which depict a player being assessed by assessment apparatus and a flow chart showing the principal steps involved in the assessment, respectively. These figures are explained in greater detail later in the specification.

The processor compares the assessment results with comparator values, which account for relevant scientifically-established differences between players, to determine the most likely strengths and weaknesses of his unseen performance. The processor devises a recommended coaching programme, based on these comparisons, usually with one of the principal objectives being to increase the player's clubhead speed at impact by improving his unseen-parameters.

Coaching may be carried out using various approaches, including one where the player's unseen parameters are measured and specific individual PADJEs and kindred PADJEs and their components are targeted for coaching improvement. Before undertaking full swings in the coaching process, the player is guided and instructed as to what he is to do and, where appropriate, may be given familiarisation and practice routines relevant to his instruction. Where guidance or instruction is given immediately prior to taking practice swings, or in feedback during or immediately following practice swings, communication is given with a non-body focus, insofar as possible, rather than a body focus, to maximise use of the player's subconscious self-organising system. Body focused information and guidance is separately given before practice swings commence. Non-body focuses relate to goal targets, outcomes, or intended outcomes, such as hitting the ball further, while body-focuses relate to actions in the player's body.

In an example of higher-level coaching apparatus, the apparatus is similar to the assessment apparatus described above, but is significantly simpler, as it does not measure GRFs or include force-plates. There also may be a reduced number of inertial sensors, and these can be swapped between segments. It has an additional component which provides automatic fast feedback to the player following a swing. Data from the inertial sensors and depth sensor, together with data obtained in the player's earlier assessment, are inputted to an artificial intelligence system, which is arranged to predict the required unseen-parameters of the coached swing. The coaching apparatus is inexpensive and well within the capability of any coach to set-up and operate, requiring no calibration and very little technical skill.

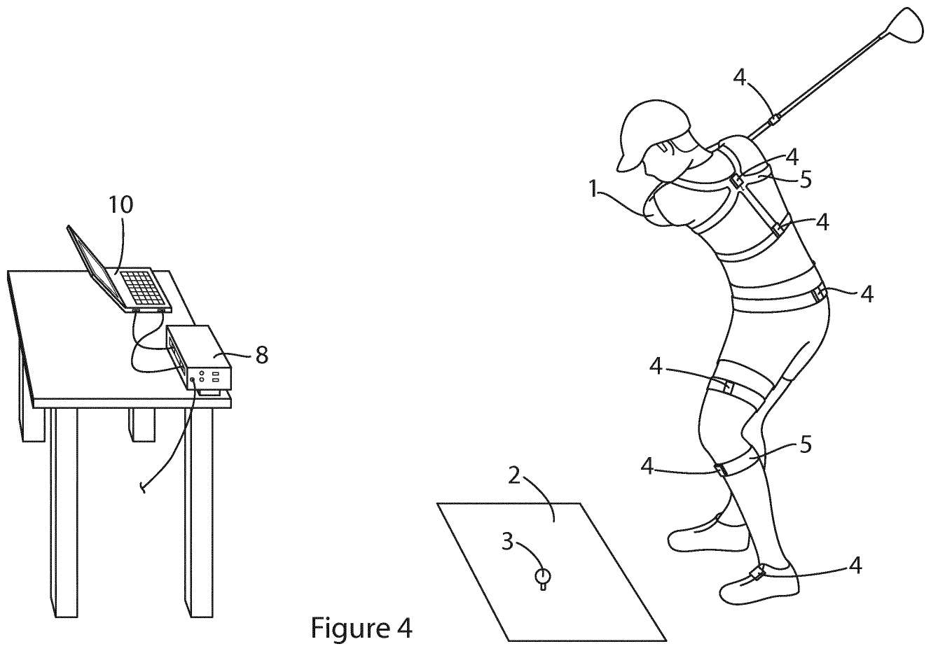

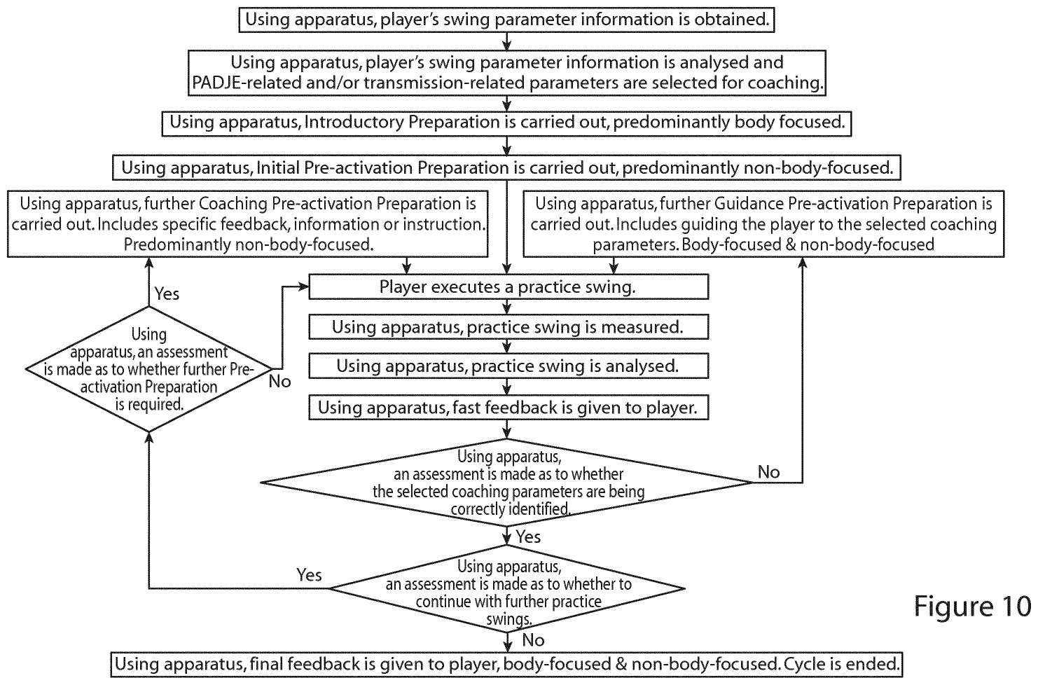

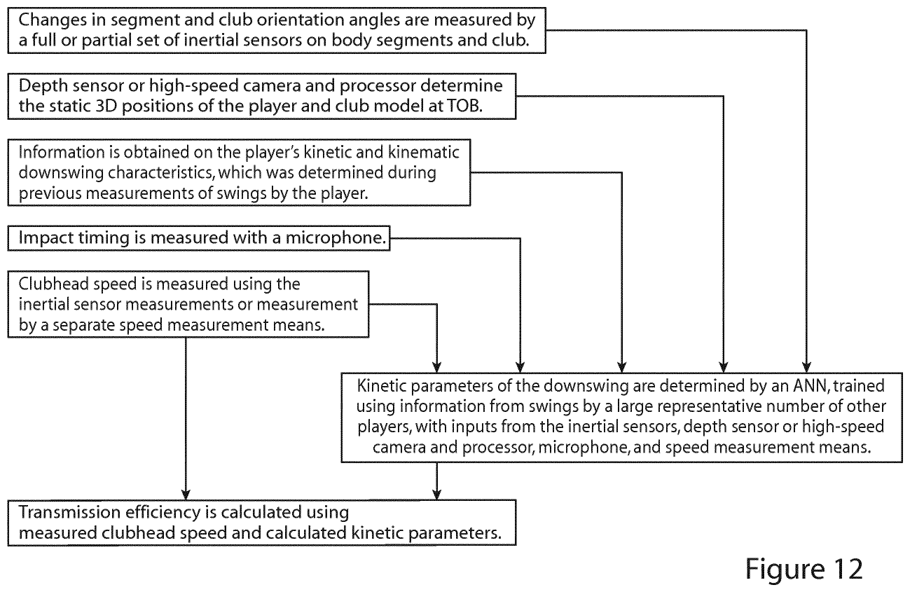

Reference is made to FIG. 10, which depicts a flow chart showing the typical principal steps involved in coaching using coaching apparatus. Reference is also made to FIGS. 4 and 12, which depict a player being coached by coaching apparatus as described above and a flow chart showing the principal steps involved in the measurement apparatus used as part of the coaching apparatus, respectively. These figures are explained in greater detail later in the specification.

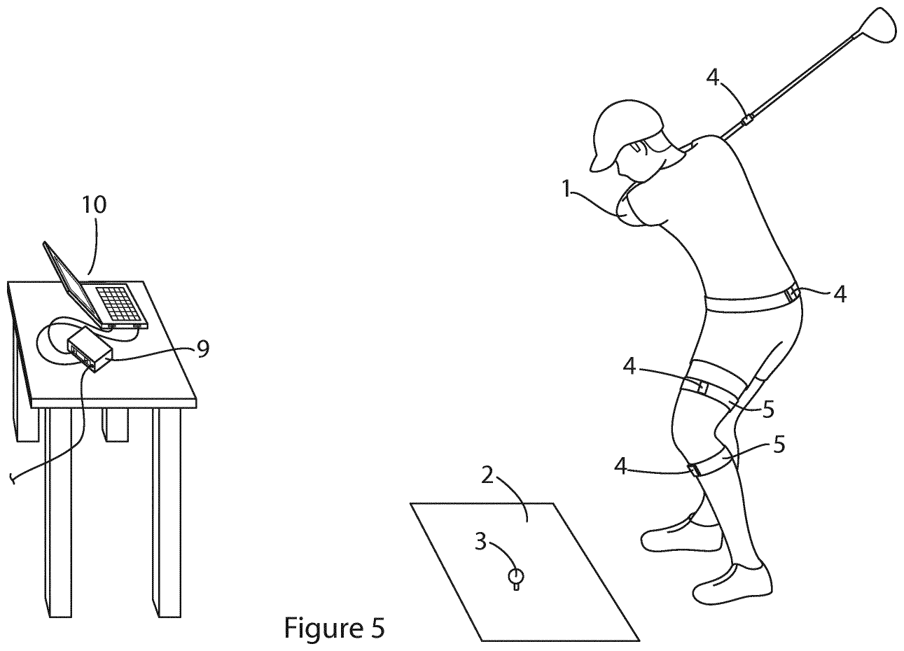

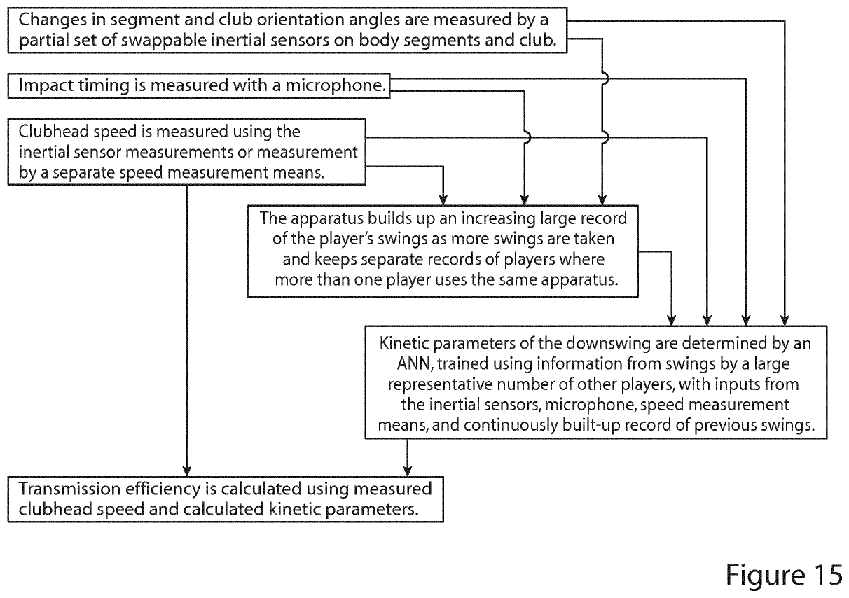

In an example of lower-level automatic coaching apparatus, the apparatus is similar to the higher-level apparatus described above, but omits the use of a depth sensor and also the need for a separate assessment. When a player is first tested, his first few swings are used to obtain the equivalent of the assessment used in higher-level coaching. This is built up each time the player uses the system, since sensors will be placed on different sets of segments in ongoing use by the player. The software is arranged to accommodate multiple players using the same equipment. This equivalent assessment is obtained from a dedicated artificial intelligence, such as an artificial neural network, trained on data from a large representative group of players, and with end-use inputs including readily-available individual-player details and the swing measurements obtained from the inertial sensors and impact measuring microphone. A separate artificial intelligence is used for coaching. This uses similar inputs to the earlier-mentioned dedicated artificial intelligence, but also includes additional inputs obtained from the most-up-to-date results from the assessment. Although the level of accuracy is not as good as that of the higher-level coaching example, and is much less suited to instruction by a professional coach, it is sufficient to coach the majority of commonly required unseen-parameters. The lower-level example has advantages over the higher-level example of being capable of being even easier to use and set-up, and therefore being well within the capability of an unaided average player. Reference is made to FIGS. 5 and 15, which depict a player being coached by coaching apparatus as described above and a flow chart showing the principal steps involved in the measurement apparatus used as part of the coaching apparatus, respectively. These figures are explained in greater detail later in the specification.

3. Analysis Techniques.

3.1 Key Importance of PADJE Parameters.

A key aspect of the present invention relates to an insight that, for an individual player, the efficiency of energy generation and transmission to the club head in the downswing is not an especial characteristic of natural accomplished play and that individual players do not typically significantly improve the transmission efficiency of their swings from a lower-than-average to a higher-than-average level as they improve their swings, where transmission efficiency, which for clarity will usually be hyphenated to ‘transmission-efficiency’, is calculated as the ratio of energy generated by the player to energy transmitted to the clubhead at impact. A further insight of the invention relates to a realisation that the above-mentioned characteristic of energy generation over energy transmission applies particularly to the generation and transmission of positive energy generated across the joints rather than negative energy absorbed across the joints. Because they are discussed frequently throughout the specification, for sake of brevity an individual positive across downswing joint energy will normally be referred to by its acronym ‘PADJE’, or plural ‘PADJEs’. The term ‘total PADJE’ refers to the sum of all PADJEs generated in a player or player model across the course of a downswing. Also, throughout the specification the term ‘negative energy’ is synonymous with ‘negative joint energy’ and always refers to energy absorbed across a joint. The term ‘negative joint power’ refers to the rate at which energy is absorbed across a joint.

An R-squared coefficient of determination of 0.6428 was found for the relationship between total PADJE and clubhead energy at impact, across the full set of player's driver swings in the research database described later in this specification. This indicates a relatively high correlation in view of the nature of the data being measured. The R-squared value was found to have a value of 0.9123 for 50% of players, where the highest 25% and lowest 25% in transmission-efficiency were excluded, indicating a very high correlation. Furthermore, a proportion of the difference between the two values appeared to be caused by outlier values, containing relatively high measurement errors, which are included when the full set of players is used.

Together with other evidence, which will be discussed later, these insights also lead to a realisation that in a normal natural swing the positive energy transmitted to the clubhead at impact is, on average, roughly proportional to the sum of the PADJEs generated at all or most of the joints of the player. A further important related insight is the realisation that these parameters, although currently unrecognised and unknown in prior art, can be measured and calculated by practical means and can be advantageously exploited in assessment and coaching of the golf swing.

Although negative joint energy and swing transmission-efficiency losses are to some degree inevitable in the downswing, it appears that they naturally accompany typical play, and where energy is successfully generated, negative energy and transmission-efficiency losses will usually naturally accompany it, in the same or similar proportions which occurred in the player's previous play, without the need for coaching intervention to prevent a greater than proportional increase. However, as explained later in the specification, transmission-efficiency can be improved by coaching.

Depending on circumstances, coaching may be most effectively carried out by coaching individual PADJEs or by coaching particular sets of PADJEs. These particular sets can comprise as few as two or three PADJEs. Henceforth, for the sake of brevity, the PADJEs belonging to such a particular set, shall be referred to as “kindred PADJEs” and joints relating to kindred PADJEs shall be referred to as “kindred joints”. The optimum arrangement for kindred PADJEs will depend on the particular PADJEs being coached and on the characteristics of the individual player. As will be explained later in the specification, players vary widely in the magnitudes of their individual PADJE proportions, that is their individual PADJEs expressed as a proportion of their total PADJE, and this variation, inter alia, prevents the formulation of any simple universal rules governing optimum arrangements. As will also be explained later, the statistical distribution of PADJEs and PADJE proportions across a wide range of players appears to indicate that the differences in optimum arrangements for kindred PADJEs arises more from the individual player's cognitive or motor learning state than from immutable physical interconnectivity between the action of the player's joints, although proximity or interconnectivity of joints does appear to sometimes play a part. Methods and systems for determining optimum arrangements for kindred PADJEs for individual players are disclosed later in the specification.

The outcomes or intended outcomes of the coaching exercise typically comprise an increase in clubhead speed or clubhead energy at impact, or an increase in the related parameters of ball speed, ball distance travelled or a combination of ball loft and distance travelled. These outcomes or intended outcomes can be readily measured by prior art methods, including ball or clubhead speed measurement by a radar tracking device, visual distance estimation on a driving range or distance measurement of a ball on a golf course using a GPS or laser rangefinder device. However, a fundamental coaching problem arises in attempting to use measurements of these outcomes or intended outcomes in coaching practice, where successive practice swings can only result in small incremental increases from swing-to-swing, because the magnitude of these incremental increases is invariably swamped and masked by the much larger combined values of other inevitable variables. These variables typically include routine measurement errors, variability in playing conditions and temporary interference with general swing performance caused by the novelty of the exploratory practice swing. These circumstances prevent useful swing-to-swing feedback being returned to the player where reliance is placed on direct measurement of one of these outcomes or intended outcomes.

it is an important insight of the invention, that these outcomes or intended outcomes can be coached with much greater accuracy in feedback from swing-to-swing by coaching and measuring specific elements of the overall swing, which are recognised to have known relationships with the outcomes or intended outcomes and which are amenable to much more accurate measurement of changes from swing-to-swing. As will be explained later in this specification, PADJEs and components of PADJEs have such a known relationship with the outcomes or intended outcomes and can be coached with accuracies which are not swamped or masked by larger combined values of the aforementioned inevitable variables. To this end, the invention provides methods and systems by which PADJEs and components of PADJEs are used to coach the outcomes or intended outcomes using accurate feedback between successive practice swings. A particular aspect of this insight is that PADJEs are not directly connected to these intended outcomes and are active or occur in a location which is remote from them, in that the PADJEs occur in the player's body while the intended outcome occurs somewhere between the club at impact and the trajectory of the ball, thus providing an advantageous link between the body-focused activities within the body, of which the player is not overtly conscious, and the non-body-focused activities of the club and ball of which the player is overtly conscious. The term ‘impact’ is used to describe the notionally instantaneous collision between the club and ball. Impact is not, of course, instantaneous, but occurs over a very brief period of time when the ball becomes elastically squashed against the clubface and then bounds away from it. Kinetic energy is transferred from the club to the ball during impact, and for convenience of explanation throughout this specification, impact will be treated as if it were a point in time when this energy is transferred. The point in time may be referred to as ‘impact’ or ‘at or just before impact’.

A further aspect of the invention involves the following insight. Where a player increases the magnitude of an individual PADJE or set of kindred PADJEs in a natural swing, on average this will usually cause a corresponding proportional increase in energy transmitted to the clubhead at impact, where the term ‘natural swing’ refers to one executed in normal natural play or practice, rather than one forced in an unnatural way. Thus, in natural swings, on average, energy behaves as if it is to a large degree independently generated across independent joints or across kindred sets of joints of the body and independently transmitted to the clubhead. By ‘independently’ is meant that the generation of energy at an individual joint or set of kindred joints and subsequent transmission to the clubhead in a natural swing, from a coaching perspective, acts in such a way that it can be treated in coaching as being independent of energy being generated at any other joint and transmitted to the clubhead. With respect to energy generated and transmitted, the various individual joints or sets of kindred joints do not appear to act in any other grouped or coordinated way. For example, in a natural swing, if a joint or set of kindred joints which generated 20% of a player's total PADJE has its generated energy increased by 10%, the energy ultimately transmitted to the clubhead at impact will on average usually be increased by approximately 2%, since 10% of 20% equals 2%. This also is supported by the applicant's test results. This is perhaps a somewhat surprising finding in light of the complicated energy generation and transmission processes disclosed in prior art document WO 2009/060011, where it might have been expected that it would have been necessary for complex cooperation between multiple joint and muscle systems to cause a significant increase in energy generation and transmission to the clubhead. That the all-important ‘unseen-parameters’ can be coached as largely independent elements, or small groups of kindred elements, targeted at individual joints of the body very much contrasts with traditional coaching methods which tend to favour coaching of much more wide-ranging body movements. An explanation for this discovered phenomenon is suggested later in the specification.

A yet further insight of the invention relates to a realisation that the phenomenon provides a very advantageous method for precisely targeting weaknesses in the unseen-processes of a swing, down to the details of components of PADJEs in individual joints across the swing, and coaching those weaknesses with relative pinpoint accuracy.

As previously mentioned, the term ‘unseen-parameters’ or ‘unseen processes’ refers to parameters or processes related to energy generated in various muscles across the body and transmitted to the club head, over the course of the downswing. Although the great majority of unseen-processes in the downswing are not visible to an observer, either in real time or in slow-motion visual playback, there are some related aspects which are partly visible and these part exceptions will be explained in greater detail later in the specification.

The basic steps involved in selecting and coaching an individual PADJE or set of kindred PADJEs of a player's swing may include the following. The individual PADJE or set of kindred PADJEs is selected and then separately coached to increase the magnitude of energy generated across the selected individual joint. The increase in energy generation causes a greater amount of energy to be transmitted to the clubhead. The proportional increase in the amount of energy transmitted to the clubhead will roughly average (the increase in the individual PADJE or set of kindred PADJEs) x (the original proportion of these PADJEs to total PADJE). From test results it has been found that there is a statistical variation in the proportion of energy transmitted, but taken over multiple swings, the average proportion will be roughly that indicated above.

The basic processes involved in determining and analysing a player's set of PADJEs and then coaching some of the individual PADJEs to increase their magnitude, which in turn increase clubhead energy at impact, may include the following stages. The player's PADJEs are collectively determined and collectively assessed but the individual PADJES or sets of kindred PADJEs selected for coaching are separately coached. This highlights a further advantage of the invention, in that it allows collective determination and analysis which conveniently allows easy identification of the PADJEs which can be most advantageously coached, and then in turn allows the identified PADJEs and sets of kindred PADJEs to be separately coached, conveniently avoiding coaching those joints which are less suited to coaching. In the final step, the increase in the amount of energy transmitted to the clubhead will roughly average (the increase in the sum of the coached PADJEs) x (the original proportion of the coached PADJEs to total PADJE).

Needless to say, increases in clubhead energy at impact are directly accompanied by increases in clubhead speed at impact, since clubhead energy and speed follow the relationship energy=½ mv², where m is the mass of the clubhead and v is the velocity or speed of the clubhead. Where the club strikes the ball in the normal way, increased clubhead energy and speed causes increased ball speed and distance travelled.

It will also be appreciated from prior art document WO 2009/060011, that even with the exclusion of negative energy and portions of the swing other than the downswing, the unseen-processes of the swing are extremely complex and comprise a large number of relevant variables with widely varying characteristics. They include the various intricate and transmission mechanisms by which energy is generated and transmitted to the clubhead. Prima facie, these complex matters would appear to present potentially formidable barriers to practical coaching of unseen-processes and understanding by coaches and players. However, as will be explained later in this specification, these barriers are overcome in the present invention.

Another important aspect of the present invention relates to an insight that a great many of the mechanisms, processes and parameters of unseen-processes, including some of those listed in the previous paragraph, are not especially correlated with higher skill or coaching improvement, but rather usually occur naturally in the swings of most players whose skills range from modest to highly accomplished. With the exception of those specifically mentioned later in the specification, they can therefore be disregarded for practical routine coaching, or assessment with a view to coaching, with little or no loss of accuracy in the results. This appears to be unknown in prior art, although a related aspect of certain prior art motor learning theory recognises the ability of the human system to ‘self-organise’ complex movements under the various physical and informational constraints or limits that confine the movements. The relevance of the self-organisation process is discussed later in this specification.

These usually disregarded and usually unneeded parameters involve many of the characteristics of PADJEs and include the contiguity and relative sequencing of blocks of energy generated at the different joints, since it appears that these naturally follow from successful generation of energy in typical swings and are not significantly correlated with accomplished play. Similarly, smoothness, rates of ramping-up, peaking, and ramping-down of blocks of energy generated at the different joints as muscle groups switch on and off, appear to naturally follow from or accompany successful generation of energy in typical swings and in consequence do not normally require coaching intervention.

Other usually disregarded and usually unneeded parameters include those related to the backswing and follow-through portions of the swing. Analysis of the downswing includes its commencement at TOB, which coincides with the end of backswing. Backswing has been found to involve no unseen-parameters significant in routine coaching, other than its shared position with the commencement of the downswing, which is covered by downswing analysis. All energy has been delivered to the club head and transmitted to the ball by the time the impact event occurs, and the subsequent follow-through plays no role other than to deaccelerate and re-stabilise the player and club, although post-impact segment kinetic energy and potential energy can provide information on inefficiencies and other characteristics in the downswing which can be relevant to transmission-efficiency. These activities do not otherwise appear to involve any unseen-parameters which are significant in routine coaching.

Additional usually disregarded and usually unneeded parameters include the vector characteristics of forces and torques associated with the generation of PADJEs. In typical routine coaching of unseen parameters, in most cases it has been found sufficient to deal solely with the magnitudes of the resultant forces, torques, powers and energies.

The invention also teaches that an initial check to identify particular idiosyncratic errors or techniques among these usually disregarded and usually unneeded parameters can sometimes be advantageous. This can be readily carried out in the assessment discussed earlier. Such checking may be done by ascertaining whether or not the various parameters fall within ranges normal for a player with similar levels of skill and physique, and values falling outside these ranges flagged for the attention of the system, the coach and/or the player. Such checks may be automatically carried out by a processor associated with the measurement system. Values falling inside the typical ranges can usually be ignored in routine coaching, but those outside the typical ranges may require coaching attention. It has been found that values falling outside the typical ranges are most commonly associated with faults or less accomplished play but are sometimes associated with higher levels of skill.

An example of the processes involved in selecting the appropriate range of unseen-parameters for coaching a player is illustrated by the following steps. The player's broad range of unseen-parameters are first measured or determined. Some of these will be routinely selected for all coaching and assessment, because they are deemed to be universally relevant to all or the great majority of swings. Other unseen-parameters are deemed only to be relevant to normal coaching if they fall outside certain limits of ordinary play. These limits are scientifically established from values of corresponding parameters by appropriate comparator values, taking appropriate account of relevant differences between players. The parameters outside limits of ordinary play will sometimes signify highly accomplished or unaccomplished play performance, either of which is likely to be relevant to coaching and analysis. Comparator values are discussed in greater detail later in the specification.

The position with respect to usually disregarded and usually unneeded parameters may be summarised as follows. Where an initial routine check identifies no particular idiosyncrasies in the player's swing, or where no particular idiosyncrasies are suspected, all parameters, other than PADJEs and their components, downswing-rotation-angle beginnings and ends, and energy transmission-efficiency parameters, can be conveniently disregarded for purposes of routine coaching and assessment with little or no loss of accuracy in the results. Downswing-rotation-angle beginnings and ends (DRAPBs and DRAPEs) and energy transmission-efficiency are explained in detail later in the specification.

3.2 Club Equivalents.

A further important insight of the present invention involves a realisation that for the individual player, his subconscious learning processes, concerned with unseen aspects of the swing, have strong similarities for all non-putting clubs. Furthermore, when a player alters his unseen-parameters for one non-putting club type, this will tend to alter the equivalent unseen-parameters for all other non-putting clubs, with the alteration being most similar between clubs which are closest in distance, where distance refers to the typical ball hitting distance of the club. This insight has been confirmed, inter alia, by tests carried out by the applicant where it was found that in the case of an individual player, the values of individual PADJE proportions remain surprisingly similar for all non-putting clubs played by that player, with about half being within 10% of each other. This contrasts with the values of individual PADJEs as a percentage of total PADJE for the same type of club but between different players, which have far greater variation in PADJE proportions. This holds equally between different players of similar skill level. This is of great significance in analysing and coaching unseen aspects of the swing, because coaching performance with one non-putting club type will very advantageously tend to automatically coach performance with other non-putting club types. This characteristic again appears to relate to the self-organising abilities of the human motor learning system, which is discussed in greater detail later in the specification.

Throughout this specification, the term “PADJE proportion” or “PADJE proportions” shall refer to the value of a player's PADJE or PADJEs, respectively, expressed as proportions or percentages of total PADJE for that player.

It will usually be found easier and more productive to primarily coach the invention with distance clubs for several reasons. One reason is that clubhead speed at impact provides a very convenient and easily understood measure of performance. Another reason is that clubhead speed at impact comprises a greater proportion of the skill required for such distance swings than it would for other non-putting swings.

One of the main benefits of the invention with shots where the primary requirement is not maximum distance, is that the improving player will have greater power available to him on these shorter shots and the consequent option to hit a more lofted shot where such is preferred, for example where a higher shot without run-on is preferred, or where a ball is being hit out of rough terrain or to pass above an obstruction. In these cases, the more powerfully hitting player may be enabled to use a more lofted club which would not otherwise be possible for him. There are, of course, many other separate skills not directly related to unseen-parameters required for shorter shots, but these skills are well known and well satisfied in prior art coaching and quite separate to the present invention.

3.3 Defining Start and Finish of PADJEs.

A potential difficulty of dealing with an individual PADJE is that it usually does not have a clearly defined start and finish or two examples of PADJEs may be very similar across their important central bulk but may start and finish quite differently. For example, one PADJE may start with a drawn-out very low joint power and not properly increase in magnitude for some time, whereas another, which is otherwise very similar, may quickly start up and attain an average level of joint power. This characteristic has potential problematic implications for the calculation of meaningful average values describing the various characteristics of the PADJE or comparable values between two PADJEs. It also has obvious problematic implications for consistently assessing angular measures in the swing cycle, such as downswing-rotation-angle at PADJE beginnings and ends, as discussed later in this specification. The present invention provides a simple and convenient method for overcoming these potential problems, believed to be unknown in prior art, which can be advantageously exploited in coaching and assessing unseen-processes in a golf swing.

The method involves selecting a notional but consistent start pointing for each individual PADJE based on a proportion of the final measured generated energy of the joint in the downswing and similarly a notional but consistent finishing position for the joint, again based on a proportion of the final measured generated energy of the joint in the downswing. Start proportions between about 10% and 20% of the total joint energy value, and finish proportions between about 80% and 90% of the total joint energy value have been found suitable for all joints in the 14-powered-joint model, with start and finish proportions of 15% and 85%, respectively, found to give good results for all individual PADJEs for all parameters tested. The choice of start and finish proportions is a compromise between minimising the often untidy and inconsistent starts and finishes of PADJE generation and minimising omission of portions of the PADJE. However, potential omission disadvantages are mitigated by the values determined always being used in comparison to other values that are trimmed in the same way, and also because if both the start and finish are similar trimmed, the actual central position remains largely unchanged in cases where the original PADJE starts and finishes solidly.

Throughout this specification, the term “PADJE” should be understood to also apply to that portion of a PADJE value which lies between start and finish proportions as described above.

Various methods may be used to estimate the starting or finishing points, such as 15% and 85%, where measured data on PADJE values over the downswing are intermittent due to the typical capture characteristics of measuring apparatus. One method is to use the apparatus processor to fit the intermittent data to a most-likely curve, based, for example, on knowledge of the shapes of typical PADJE values for the relevant joint and player type, or knowledge of the likely shape of the curve from previous tests on the same player, using processes which are well known in prior art. Where a player undertakes an initial assessment, the intermittent characteristics of the data may also be improved by taking an average of multiple test swings and applying the starting and finishing point to the average set of data.

Potential problems in estimating starting or finishing points of PADJEs which comprise two separate contiguous blocks of energy are conveniently mitigated by the fact that, joints which typically have such characteristics, such as the left hip joint, tend to have relatively larger and lengthier PADJEs and therefore much larger numbers of data capture points which can be used by the system processor to reconstruct the contiguous curves of the blocks of energy.

3.4 Potentials of PADJE Joints.

The PADJEs of a player's swing vary considerably in magnitude, with some more amenable than others to coaching unseen-processes. The right knee joint is much less suited to being coached to increase its proportional contribution to total PADJE. This appears to be due to the role it plays in the asymmetric golf swing, where the left knee typically contributes a far higher level of energy. Right knee PADJE is usually proportionately small for all players at all skill levels.

As a means for comparing players' skill in executing the unseen-processes of the downswing, a “downswing-handicap” is defined and calculated which compares the player's unseen-parameters in the downswing with a particular “distance club”, such as the driver club, to those of players using the conventional formal handicap system. Throughout this specification, the term “distance” club, in addition to driver club, may also include woods, hybrid clubs and long irons. In a preferred system, for a large group of players across the range of handicaps, the energy of a standard weight driver clubhead at impact is plotted against official handicap and the regression equation of a line of best-fit constructed, representing an average plot for all players in the group. An individual player's downswing-handicap is then found by finding the intersection of value of the energy of his driver clubhead at impact with the line of best-fit for the group. This provides a handicap number which is familiar to coaches and players but which discounts all factors other than the energy of the clubhead at impact, which is of course directly related to the speed of the clubhead at impact. Usually an average value of a number of swings by the individual player is used to smooth out variations in his performance. Different best-fit curves are also used for male and female players because the handicap systems for males and females are not directly equivalent. It is important to note that in the downswing-handicap system, the equivalent number to scratch or zero handicap is also zero, but more accomplished play is represented by a number preceded by a “minus” symbol. This differs from the conventional golf handicap system which has the peculiarity that more accomplished play is conventionally given a number preceded by the term “plus” or a positive symbol and less accomplished play is given a number without symbols. The use of handicap systems of this type comprises a supporting aspect of the invention.

The following average PADJE proportions have been determined by the applicant for a 14-powered-joint model using a database of many thousands of swings from about 350 players with downswing-handicaps ranging from around −5.0 to 33.0. This database shall be referred to as the ‘research database’ throughout this specification. The average percentage proportions of PADJE are calculated to be: left knee 15.7%, right knee 4.2%, left hip 17.1%, right hip 19.5%, lumbar 8.7%, thorax 10.0%, left shoulder 5.6%, right shoulder 8.2%, left elbow 2.6%, right elbow 3.0%, left wrist 2.1%, right wrist 2.6%, grip 0.6% and neck 0.7%. The seven highest energy-generating joints of these powered fourteen joints, in order of magnitude, are right hip, left hip, left knee, thorax, lumbar, right shoulder and left shoulder. They comprise about 85.0% of total joint energy. For most joints, averaged across a large representative group of players, average PADJE proportions are very roughly proportional to the muscle mass associated with the joints. Interestingly, this also indicates that the average usage of muscles in the golf downswing is largely distributed in proportion to the general distribution of muscles across the regions of the body from distal to proximal.

As already mentioned, a particular exception is the right knee which averages only a little over a quarter that of the left knee. A less pronounced exception is the left shoulder, which averages only a little over two thirds that of the right shoulder. Throughout the specification, references to any parameters associated with individual muscle-joint systems are usually referred to by the name of the individual joint preceding the parameter. For example, where referring to the PADJE or PADJE proportions of the muscle-joint system associated with the left knee, the terms ‘left knee PADJE’ or ‘left knee PADJE proportions’, respectively, are used.

Across the downswing-handicap range 0-20, it has been found that there is little difference in the PADJE proportions of large numbers of players when they are grouped by downswing-handicap and averages taken for each group. There are some significant differences where players have downswing-handicaps better or worse than this range, with some of the most important being as follows. Left knee proportion is similar for downswing-handicaps of <0 and 0 to 20, but somewhat lower for those >20, the averages being 16.1%, 16.4% and 12.4%, respectively. Lumbar is higher for downswing-handicaps <0, middling for those 0 to 20 and lower for those >20. Thorax is similar for downswing-handicaps <0 and 0 to 20, but higher for those >20.

Right knee PADJE proportion is much lower for downswing-handicaps <0, middling for those 0 to 20 and higher for those >20, the averages being 3.0%, 4.2% and 5.4%, respectively. As previously mentioned, right knee PADJE should usually be treated differently to all other joints from a coaching perspective. Although it obviously plays a role in supporting the player during the downswing, its absolute value does not vary very much between players, is far less than the potential energy generating capacity of the joint, and does not appear to be of significance in directly contributing to the generated energy transmitted to the clubhead. Usually, the right knee joint can be disregarded in routine coaching, even though this will not always be specifically stated in general comments occurring throughout the specification.

The values of PADJEs and PADJE proportions can be usefully used for selecting or prioritising joints for coaching when the objective is one of maximising total PADJE. All other things being equal, emphasis can be advantageously given to those joints which typically have the highest average PADJE proportions across a broad range of comparable players, because those joints have the greatest absolute potential for players in general. All other things being equal, emphasis can also be advantageously given to particular joints for which the coached player is found to be most below average comparator value, because these particular joints have the greatest catch-up proportional potential for the particular player. Comparator values are discussed in greater detail later in the specification.

Where it is necessary to prioritise PADJEs for coaching, prioritising factors can be given based on a combination of the typical average absolute proportional magnitude of the PADJE, as discussed earlier, and the catch-up proportional potential of the PADJE for the particular player, as discussed above.

3.5 PADJE Components.

A further aspect of the invention involves the insight that individual, kindred and total PADJEs can usually be more accurately and meaningfully assessed and coached by additionally identifying and using their constituent components and the relationships between the PADJEs and these components. Such components include joint power, powered angular displacement, powered angular velocity, powered angular acceleration, torque and time. Joint power refers to positive joint power across one or more joints of the player's body. Angular displacement refers to the angular change in the included angle between the segments connected by the joint and angular velocity refers to the velocity of that angular change. Angular acceleration refers to the rate of change of angular velocity. Torque refers to that parameter applied across individual joints of the player's body. Powered angular velocity, powered angular displacement and powered angular acceleration refer to angular velocity, angular displacement and angular acceleration applied to the relevant individual joints of the player's body when powered. The term “powered” is added to the parameters angular-velocity, angular-displacement and angular acceleration to indicate that the parameter is a kinetic parameter in that it applies only to that portion of the movement of the joint which is powered. There is an important distinction between these kinetic powered parameters and the kinematic parameters of angular velocity, angular displacement and angular acceleration which may or may not be powered, or may be powered over just part of the parameter's movement or duration. From ordinary human external observation of such parameters in general human movement, it is usually not possible to determine whether or not energy is being generated at a moving joint at any particular point or at all. Where the joint is powered, the terms “powered-angular-displacement”, “powered-angular-velocity” and “powered-angular-acceleration” are used throughout this specification.

One set of basic relationships between PADJEs and their components include: PADJE=(joint power)×(time); PADJE=(torque)×(powered-angular-displacement); PADJE=(torque)×(powered-angular-velocity)×(time); and PADJE=(moment of inertia)×(angular acceleration)×(powered-angular-displacement).

Another set of relationships involve the vector values of some of the components and include: PADJE=(torque vector)×(powered-angular-displacement vector); PADJE=(torque vector)×(powered-angular-velocity vector)×(time); and PADJE=(moment of inertia)×(angular acceleration vector)×(powered-angular-displacement vector).

A further important part of the invention relates to an insight that aspects of the kinematic component parameters of angular-displacement and angular-velocity could be used in a practical manner in the analysis of unseen-parameters, if the profile of their kinetic proportions could be established over the course of the kinematic parameter for some or all of a player's joints in a golf downswing and if those profiles followed a predictable pattern. Following this insight, the swings of large numbers of players were tested with a view to establishing the intervals over which energy was generated over the course of the kinematic parameters, and also the rate at which it was generated. It was found that in the 14-powered-joint model in typical golf swings, all joint movements of the body in the downswing were accompanied by energy generation across the joint itself. It was also found that the profiles of these energy generations were sufficiently similar for all players, scaled to the overall quantum of energy generated at the particular joint, to allow the kinematic values to be used as proportional estimates of the kinetic values. This insight is not at all obvious because a player's joints can, of course, move without any energy being generated across the joint and indeed much of the movement of the various joints occurs due to energy generated at other joints. The findings indicated that energy generation across these movements does not normally involve significantly irregular differences in patterns between swings of different players, and therefore the use of average values representing characteristics of a PADJE would not normally mask irregular pattern differences which would otherwise need to be accounted in a swing analysis. This allows certain varying components of a PADJE, including torque, joint-power and powered-angular-velocity, to be meaningfully represented by single average magnitude values for the entire PADJE.

A further aspect of the invention relates to a realisation that the basic relevant components of PADJE, have different levels of usefulness and effectiveness in coaching unseen-processes, both in general and with respect to particular joints and skill ranges. This has been confirmed in extensive tests carried out by the applicant and is believed to be unknown in prior art. It can be advantageously exploited in swing assessment and coaching. A brief comparison shall now be made between the joint energy component parameters of joint-power, powered-angular-displacement, powered-angular-velocity, powered-angular-acceleration, torque and time. There are other derivative parameters which may sometimes prove useful, including peak values of some of the parameters already mentioned. These are not discussed in this specification but may prove useful for more detailed analysis or for inclusion in an initial more comprehensive assessment of a player's swing.

3.5.1 Joint-Power

Joint-power has usually the greatest proportional influence on PADJE, because of the typical relatively little-changing value of time duration in the relevant mathematical relationship. It is of particular use in coaching processes where the progress of the swing is analysed as parameters vary through the downswing. Its usefulness is limited where completed PADJEs are analysed because it can be difficult for coaches to explain the parameter and difficult for ordinary players to envisage or use it in swing practice with fast feedback.

3.5.2 Powered-Angular-Displacement

Powered-angular-displacement also has considerable proportional influence on PADJE, and is usually the most important component parameter where a completed PADJE is analysed. It is closely related to powered-angular-velocity, with their average values being directly related by the parameter of time. Variations in powered-angular-displacement typically account for the greater part of a discovered phenomenon, which is referred to as the ‘PADJE-proportions phenomenon’ and which is discussed in detail later in the specification.

Because of its discovered relationship with the kinematic parameter angular-displacement, the kinetic parameter of powered-angular-displacement has the advantages of being the parameter which is most easily explained by coaches and most easily understood by ordinary players and is accordingly more easily used in swing practice. It can therefore be used in coaching both in its own right and as a part substitute for joint-power.

In the 14-powered-joint model, for players of all skill levels, the powered-angular-displacement of most joints usually increases significantly as a player increases the PADJE of the joint. An exception is the right knee for all skill levels. Exceptions also occur at all skill levels except lower skill ranges for lumbar, left shoulder, right elbow and left wrist joints. References to higher and lower skill ranges allude to typical performances across portions of the downswing-handicap range, with higher skill ranges referring approximately to downswing handicaps of about 6 or better (i.e. lower handicap number), and lower skill ranges referring approximately to downswing handicaps of about 16 or worse (i.e. higher handicap number). These approximate skill range terms are used throughout this specification and reflect the make-up of the research database, referred to earlier. Powered-angular-displacement usually increases a little more than joint-power with increasing PADJE for thorax, left elbow and right elbow joints and hugely more for left wrist joint. Powered-angular-velocity usually increases a little more with increased PADJE than powered-angular-displacement for the right wrist joint. The thorax joint usually has significant increases with increasing PADJE in the order powered-angular-displacement, joint-power and powered-angular-velocity. The left wrist joint usually has significant increases with increasing PADJE for powered-angular-displacement but not so for joint-power or powered-angular-velocity. The principal reason for such differences between powered-angular-displacement and powered-angular-velocity relates to the way the time parameter varies as the PADJE is coached and increased.

3.5.3 Powered-Angular-Velocity

Powered-angular-velocity is fairly closely correlated with joint-power and as such also has considerable proportional influence on PADJE. As previously mentioned, it is also closely related to powered-angular-displacement and is also associated with the PADJE-proportions phenomenon, although usually somewhat less than powered-angular-displacement.

Although its usefulness is often eclipsed by its closeness to powered-angular-displacement, because of its discovered relationship with the kinematic parameter angular-velocity, it can be easily understood and readily used in swing practice.

As will be explained later in the specification, powered-angular-velocity, in combination with powered-angular-displacement, can be used to assist in the estimation of torque where this latter parameter cannot otherwise be determined, as sometimes occurs with certain types of low-cost measurement apparatus.

3.5.4 Powered-Angular-Acceleration

Powered-angular-acceleration has been found to be of little additional practical benefit in PADJE analysis and coaching for several reasons. First, it is difficult for the ordinary player to distinguish between angular acceleration and angular velocity. Second, its influence can at least be partly represented by the parameter powered-angular-velocity, with acceleration being viewed as increasing velocity. Third, it is not useful when expressed as an average over time, because joints tend to accelerate and then decelerate over the course of a PADJE, with one at least partly cancelling the other. For these reasons, this parameter is considered to be of little practical use in routine coaching of unseen-processes and is not discussed further in this specification.

3.5.5 Torque

It can be seen from the PADJE component relationships that, all other things being equal, any increase in the torque component of an individual PADJE will result in a direct proportional increase in the PADJE. However, it has been found that although the absolute value of torque does typically increase with improvements in unseen-parameter skill for some joints, in relative terms with most individual joints it usually decreases in proportion both to the particular individual PADJE and its fellow components of average-powered-angular-displacement or powered-angular-velocity. This may at least be partly explained by the following two circumstances. First, and probably most importantly, consciously increasing torque, where additional effort is attempted, is more natural and easier for a player than increasing the components of powered-angular-displacement and powered-angular-velocity in the unnatural high-speed, side-swiping golf swing movement, and therefore ready increases in torque have to some extent already been obtained by the player. Second, when higher PADJEs are achieved, the muscle group is usually operating over an extended range and is therefore likely to operate at lower torques at the extended extremities of the range, thereby reducing the overall average torque values.

In the 14-powered-joint model, with increasing PADJE values, it has been found that absolute increases in average values of torque are usually absent for left shoulder, right shoulder, left elbow and right elbow joints. Increases are mixed between moderate and none at all for lumbar and thorax joints. They are moderate for left knee and left hip joints. They are relatively high across the full skill range for the distal joints of the left wrist, right wrist, grip and neck, which are relatively less important due to having much lower average PADJE magnitudes.

Although torque is usually of less importance than powered-angular-displacement, this is not always the case. Its importance relative to powered-angular-displacement varies in different circumstances, but a useful appreciation may be obtained by comparing the components of average-torque and powered-angular-displacement in the individual joints which have the highest and the lowest PADJE magnitude absolute differences compared to their average comparator values, which are explained later in the specification. The following has been observed for representative samples of players across the research database of driver swings for the highest PADJE magnitude absolute difference in the swing. The powered-angular-displacement is on average about 4.25 times more responsible than average-torque for it being the highest. For the lowest PADJE magnitude absolute difference in the swing, powered-angular-displacement is on average about 7.5 times more responsible than average-torque for it being the lowest.

Although average-torque is on average less responsible than powered-angular-displacement for these highest and lowest PADJE differences, when taken on an individual player or individual swing basis, it sometimes plays a more important role. A useful appreciation may be obtained from the following numerical comparison. Where a highest PADJE magnitude difference occurs, in about 10% of swings the relative powered-angular-displacement component is low, and in about 25% of swings the relative average-torque component is low, where low refers to being lower than average comparator magnitude and therefore contrary to overall trend. Where a lowest PADJE magnitude difference occurs, in about 3% of swings the relative powered-angular-displacement component is high, and in about 38% of swings the relative average-torque component is high, where high refers to being higher than average comparator magnitude and therefore contrary to overall trend. In both cases, the term ‘relative’ refers to the component value compared to its average comparator value.

It may be noted that the relatively lower sensitivity of torque to performance, compared to the sensitivity of powered-angular-displacement to performance, indicates that the differing types of fast-acting and slow-acting muscle fibres well-known in prior art, are unlikely to significantly account for the large differences in unseen-parameters between different players.

3.5.6 Time

It can also be seen from the PADJE component relationships mentioned previously, that, all other things being equal, any increase in the time duration component of an individual PADJE will result in a direct proportional increase in the PADJE. However, it has been found that significant time increases or decreases do not typically occur with increases in PADJE and that increasing the time component will not usually present an advantageous coaching strategy. One reason for this relates to the speeding up of the swing as the level of joint energy generation increases. Accordingly, with respect to coaching unseen-processes, other than powered-angular-acceleration, the time component is usually the least important of the identified components discussed above, although it is still retained for more detailed analysis and assessments.

3.6 Simplifications of PADJE Components.

A further aspect of the invention involves an insight that simplified versions of various PADJE components can be used in coaching unseen-processes with little or no loss in effectiveness and with significant reduction in system measurement and calculation requirements. These simplified versions also result in easier explanation and improved understanding by the player and coach.

One such simplification involves substituting the magnitudes of the resultant of the 3D vector values for the PADJE vector components of powered-angular-displacement, powered-angular-velocity and torque. This causes the set of directional and magnitude values of each of the X, Y and Z components to be replaced by a single simple number in the case of powered-angular-displacement or by a single simple number at each time-related or angular position in the progress of powered-angular-velocity, torque and joint over the course of the PADJE. Tests by the applicant have indicated that such substitutions provide parameters which are effective for coaching unseen-processes.

Another such simplification involves substituting the average values of powered-angular-velocity, torque and joint power for the changing values of these parameters at each time-related or angular positions over the course of the PADJE. These substitutions arise from a realisation that powered-angular-velocity, torque and joint power patterns over the course of a PADJE tend to be similar across different skill levels. Tests by the applicant have indicated that these substitutions also provide parameters which are effective for coaching unseen-processes.

The two aforementioned simplifications can be advantageously combined to provide an effective, easy-to-use and easy-to-understand set of PADJE components involving powered-angular-displacement, powered-angular-velocity, torque and joint power. To simplify wording through the remainder of this specification, henceforth, unless otherwise stated, the terms “powered-angular-displacement”, “average-powered-angular-velocity”, “average-torque” and “average-joint-power” should each be understood to mean those values with the simplifications applied. These are the single value for the PADJE of resolved powered-angular-displacement of the joint, and the single values over the course of the PADJE, of average resolved powered-angular-velocity or speed of the joint, average resolved torque magnitude across the joint, and average joint power, respectively, where the term ‘resolved’ refers to resolving the X, Y and Z components of the 3D directional values into a single combined value. For added clarity, hyphens have been added to the terms.

Where these parameters are used, along with the time component, the mathematical relationships with PADJE are transformed to the following: PADJE=(average-torque)×(powered-angular-displacement); PADJE=(average-torque)×(average-angular-velocity)×(time); and PADJE=(average-joint-power)×(time).

As will be discussed later in the specification, in routine coaching, where PADJE components are analysed or coached, it is sometimes only necessary to consider the components of powered-angular-displacement and average-torque.

3.7 Estimating Changes in Average-Torque from other PADJE Components.

A further insight of the invention relates to a realisation that information on changes in the average-torque of a PADJE can often be inferred or estimated from changes in a combination of the kinematic parameters of that PADJE, including changes in the combination of angular displacement and angular velocity of that PADJE, or changes in the combination of angular displacement and time duration of that PADJE. This can be particularly useful in circumstances where it is difficult or inconvenient to directly measure the kinetic parameter of torque or average torque.

The insight includes a recognition that, where all other parameters remain unchanged, powered-angular-displacement and powered-angular-velocity, or powered-angular-displacement and time, will not change in proportion to each other unless changes occur in other parameters and that, usually these changes will largely or wholly comprise a change in torque or average torque in the particular PADJE. Also, for a given change in angular displacement, changes in time duration are proportional to changes in angular velocity, because average angular velocity multiplied by time equals angular displacement. As previously mentioned, the powered-angular-displacement and powered-angular-velocity of a PADJE are usually equal to the angular displacement and angular velocity, respectively, of that PADJE.

3.8 Comparator Values.

Evaluation or analysis of the player's measured unseen and seen characteristics usually involves comparison of the values of these characteristics to relevant comparative values. For purposes of clarity, these values will be termed ‘comparators’ or ‘comparator values’ throughout the specification. Comparators are of various types, including ‘average comparators’ and ‘target comparators’. In all cases, emphasis is placed on using the most scientifically-appropriate and scientifically-calculated data in defining comparators and calculating comparator values.

The term ‘average comparators’ refers to comparators which are deemed to best describe the average values, both absolute and relative, found in the most relevant parameters of players or most relevant parameters of the most relevant players. They do not assume the existence of an ideal swing or ideal player, but seek the most relevant matches based on knowledge of the subject player's unseen and seen characteristics. The term ‘target comparators’ refers to comparators which usually comprise coaching targets. Examples include values based on a targeted improvement above the average comparator value, or values based on a targeted improvement above the subject player's previous measured performance.

Comparator values involving other players can usually be readily calculated with a processor means using regression analysis on selected information from a representative database of player information, which includes players' unseen parameters and physical details.

Database information will usually be selected for swings with the same distance and general club type. Where limited database information is available, interpolation may be used to increase the range of clubs covered. For example, if the subject swing uses a 6-iron club, database information may be interpolated from a combination of 5-iron and 7-iron, if these are the closest available data.

Subject players may be matched to the most relevant types of database players with respect to the subject comparator type. For example, with respect to player skill, if the subject comparator type is directly related to individual PADJE or PADJE component characteristics, the controlling parameter in the regression analysis will often be the value of total PADJE. If the subject comparator type is more related to DRAPB or DRAPE, the controlling parameter in the regression analysis will often be the value of clubhead energy at impact. If the subject comparator type is related to individual downswing negative joint energy, or its components, the controlling parameter in the regression analysis will often be the value of total downswing negative joint energy. If the subject comparator is directly related to transmission-efficiency, the controlling parameter will often be the value of clubhead energy at impact, and the database may additionally be selected using a gravitational potential energy (GPE) style variation basis.

The most relevant database player type may additionally be based on other relevant player characteristics, including physique, age, sex and whether the player is a professional player, regular player or otherwise.

3.9 Varying PADJE Components.

Unseen-parameters which vary with the progression of PADJEs through the downswing can also be useful in analysing and coaching unseen-processes. These parameters include each individual PADJE's varying non-averaged joint power, non-averaged powered-angular-velocity, non-averaged torque, and elapsed angular-displacement as the downswing progresses. The progress of the downswing may be measured in time or angular measure. An example of angular measure is club-shaft angle in the swing plane or projected onto the swing plane or frontal plane.

The varying parameters can be useful in comparing the development of a player's PADJEs and components of PADJEs, over the course of a swing, against appropriate comparators.

Various techniques can be used to automatically compare a set of varying data in one downswing with those of another when using a processor. One technique involves showing or analysing two swings, or downswings, synchronised by time or angular measure. In this instance, one is the subject swing and the other a comparator swing based on relevant scientifically-established differences between players. The technique may use side-by-side visual representations of the two swings and/or side-by-side tables of data of the varying parameters of the two swings. This technique can particularly suit coaching where the player or coach is directly involved.

Another technique involves representing the values of each set of swings or downswings by the coefficients of wavelet or Fourier series. Such systems can readily identify and summarise differences between a player's swing and a comparator swing based on relevant scientifically-established differences between players. This technique can particularly suit analysis by a processor.

3.10 Phenomenon of PADJE-Proportions being largely unrelated to Skill.

A further aspect of the invention relates to an insight that players have widely differing patterns of PADJE proportions, that these differences have very little correlation with player skill, and that recognition and identification of the differences present further opportunities to increase players' unseen performance. The term ‘PADJE-proportion’ refers to the value of an individual PADJE expressed as a proportion of total PADJE. This realisation, which is believed to be completely unknown in prior art, has been tested and confirmed by the applicant across a great many swings by a large number of players. The insight is partly confirmed by the contrast between, on the one hand, the high variation in PADJE proportions between swings with the same club by different players of identical downswing-handicaps and physique and, on the other hand, the previously-mentioned low variation in PADJE proportions between swings with different clubs by the same player. The phenomenon shall be referred to as the ‘PADJE-proportions phenomenon’ through this specification. A possible explanation for this phenomenon is given later in this specification.

As previously mentioned, of the various PADJE components, the phenomenon is usually most strongly correlated with powered-angular-displacement, but is also strongly correlated with powered-angular-velocity.

An additional element of this aspect of the invention relates to an insight that this finding can be advantageously exploited in swing coaching and assessment. The pattern across the downswing typically comprises energy generation in all joints occurring in the usual player models, but usually with some significantly higher and some significantly lower than the average proportions for the player's comparator group. For clarity, these are referred to as ‘high-proportions’ and ‘low-proportions’, respectively, in this specification. The subconscious development of these high-proportions and low-proportions of PADJE in a particular player varies from player to player and does not appear to correlate significantly with the player's latent potential to become or not become a highly accomplished player.

From information calculated from the research database, discussed earlier in this specification, there appears to be little or no significant differences between the average proportions of PADJE generated by different joints across the broad downswing-handicap group ranging from −5 to 20 and only minor differences between this broad range and the range of less skilled players with downswing-handicaps >20. These minor differences chiefly comprise higher left knee proportions and sometimes higher lumbar proportions in more skilled players. They also comprise higher right knee proportions in less skilled players, which is largely due to the roughly similar absolute value of right knee PADJE across all skill ranges. Average left wrist proportions and right shoulder proportions may also be higher with more skilled players.

However, where not just considering overall player averages, there are two significant differences in the statistical variation in distributions of high-proportions and low-proportions for different joints. One of these is that joints with small average absolute PADJEs tend to have higher statistical variation than those with larger absolute PADJEs. In the case of the 14-powered-joint model, the following four powered joints, which tend to have relatively small proportional PADJEs, right knee, grip, neck and right elbow, all tend to have much higher than average statistical variation in their high-proportions. One possible reason for this may be that the PADJEs of these joints are not particularly important in the overall swing and they can be subconsciously neglected or over-emphasised by the player with little effect on his swing. Another possible reason is that the small absolute values of these PADJEs, which are partly swamped by the much larger absolute values of the other PADJEs, are more affected by random measurement errors. The other significant difference again involves the right knee. This joint appears to play a very minor contributing role in energy generation, with most of its muscle energy potential unused, allowing it to very easily contribute a larger but seemingly unneeded supply of energy. The other ten powered joints, on average, tend to have less statistical variation of their high-proportions, with the right hip frequently having the least variation. Other than these average differences in variation of high-proportions, there appears to be little significant average difference in distribution patterns of high-proportions and low-proportions between the 14 joints.

It has been found that some players have large variations from average for their skill and physique group, and that other players have small variations from average for their skill and physique group, and that there appears on average to be no significant difference in the transmission-efficiency of these types of players with respect to the percentage of PADJE transmitted to the ball at impact. It has also been found in the 14-powered-joint model that variations well above average and well below average commonly occur for all individual joints.

As discussed earlier in this specification, in the 14-powered-joint model, seven specific powered joints account for almost 85% of total PADJE. Although these seven joints tend to have less relative variation of their high-proportions on average than the other seven joints, their results are more of interest because of their high combined proportion of generated downswing energy. A portrayal of the average distribution of these seven joints is given by the following average statistics. 34.0%, 14.3%, 3.9% and 0.8% of individual joints, have low-proportions which are >80%, 80%-60%, 60%-40% and <20% of average proportional value, respectively. 27.7%, 14.7%, 7.6%, 3.7% and 2.3% of individual joints have high-proportions which are 20%-40%, 40%-60%, 60%-80% and >100% greater than average proportional value, respectively

High-proportion and low-proportion PADJEs are of particular importance where they occur in those proximal joints which normally have relatively high energy-generating levels, including the left knee, left hip, right hip and lumbar joints. Over the research database, the average amount by which high-proportion PADJEs in these high energy-generating joints each exceed their average comparator values is around 45% corresponding to an average absolute value each of about 25-30 Joules. For example, across this database of players, where the average value of a particular proximal PADJE is about 60 J, a player who subconsciously promotes that PADJE to one with high-proportions, will typically increase its value by around 45% to about 87 J.

It is a further insight of the invention that the widespread existence of these high-proportions and low-proportions, somewhat randomly distributed across player skill and physique, indicates that typical players use far less than their full muscle potential to maximum effect in the downswing. The insight can provide guidance in the coaching process to overcoming the subconscious impediments to increasing the activity of the individual player's less-active joints to levels more in line with the more-active joints of other players who have the same physical energy-generating potential.

The methods and systems of the invention are particularly suited to overcoming problems in getting a player to successfully alter his ingrained subconscious pattern because it provides a way to very accurately assess and target the weaknesses of all potential PADJEs and provides a way to coach those under-utilised PADJEs with relative pinpoint accuracy. As will be seen later in the specification, it also provides methods and systems which provide the player with accurate fast feedback during coached practice swings.

High-proportions can also be of importance where a player's performance has deteriorated due to matters which have adversely affected the generation of energy at one or more of the high-proportion joints because this will likely cause a detrimental unsettling or reversing of the player's subconscious PADJE pattern. For example, where a player with a particularly elevated high-proportion experiences deterioration in the performance of his system of muscles and joints, perhaps due to natural aging, the muscles or joints associated with the high-proportion joint are more likely to be the ones which are already near their limits and therefore the ones to be first affected. Similarly, an injury to a high-proportion joint or its associated muscle system will likely cause some detrimentally unsettling or reversing of the player's subconscious pattern. Where such potential problems exist, measurement and analysis of the player's general pattern and high-proportions can be used to predict, prevent or diagnose such adverse occurrences and indicate appropriate remedies.

It is hypothesised that the reason why PADJE-proportions are usually largely unrelated to player skill is that when a player develops his initial skills in executing the downswing, he typically subconsciously assembles an initial pattern of individual PADJE proportional values which is largely retained as he improves his downswing skills over future periods, usually involving many years. His overall level of PADJE generation increases, but usually the relative proportions of PADJE generated at individual joints will remain similar to his initial pattern, although there are some exceptions as were discussed earlier. What is unexpected is not so much that there is variation in pattern between players but that for the individual player the initial pattern usually largely remains proportionately unchanged as the player improves his downswing skills. This phenomenon is particularly important for several reasons.

It offers at least one explanation as to why players frequently reach a limit or difficulty in improving their unseen-parameter performance. Because a player is somewhat subconsciously locked into a partly-fixed relative pattern of PADJEs, with attention usually subconsciously concentrated on a few individual high-proportions of higher-than-average PADJEs, he must elevate these already high high-proportions even further if the rest are also to be advanced. Knowledge of these subconscious impediments can be used by the coaching process to overcome the impediments and are discussed in greater detail later in this specification. Evidence supporting this hypothesis is given later in the specification.

3.11 Improving DRAPB, DRAPE and Span between DRAPB and DRAPE.

A further aspect of the invention relates to an insight that an improving player can usually increase the magnitude of his total PADJEs by beginning all or any of his individual PADJEs angularly earlier with respect to downswing rotation. The reason may be at least partly due to a spreading of the general pattern of PADJEs over a wider range of downswing rotation angles, thereby facilitating potential increases in powered-angular-displacement. Beginning angularly earlier usually does not cause PADJEs to begin time-wise earlier, because increasing PADJE is usually accompanied by a faster downswing. This parameter is always specific to individual joints, or sometimes groups of related joints, and shall be referred to as ‘downswing rotation angle at PADJE beginning’ (DRAPB). Because the term will be used frequently throughout the specification, for sake of brevity the synonym ‘DRAPB’, or plural ‘DRAPBs’ will usually be used. In this instance, the term ‘rotation angle’ refers to any characteristic angle which develops in one direction through the downswing, for example the angle described by the club shaft as it rotates through the swing plane, projected onto the swing plane, from top-of-backswing to ball impact. The phenomenon has been verified by extensive tests carried out by the applicant and appears to be unknown in prior art. It provides an example of the somewhat unexpected unseen or non-visible nature of energy generation in the golf swing, where it might otherwise be guessed that the pattern of unseen-processes would match the visible general pattern of club-shaft rotation in the downswing. An improving player can also usually increase the overall magnitude of his total PADJE by ending his general pattern of individual PADJEs angularly earlier, although the benefit is considerably less than beginning the individual PADJE earlier. This parameter shall be referred to as ‘downswing rotation angle at PADJE end’ (DRAPE). Once again, because the term will be used frequently throughout the specification, for sake of brevity the synonym ‘DRAPE, or plural DRAPEs’ will usually be used.

Where a general improvement takes place, the change in DRAPB is typically much greater than the change in DRAPE such that the angular span between them is increased. This angular difference shall sometimes be referred to as the ‘span between DRAPB and DRAPE’. Knowledge of these phenomena can be advantageously exploited in coaching unseen-processes. Also, reference to ‘improving’ DRAPBs, DRAPEs or spans between DRAPBs and DRAPEs, should be understood to mean coaching or causing earlier angular occurrence of the DRAPBs or DRAPES, or causing greater spans between DRAPBs and DRAPEs.

In some instances, commencing DRAPBs angularly earlier may accompany a more extended backswing and downswing. However, simply angularly extending the backswing and downswing will not in itself cause an increase in total PADJE. In prior art coaching it is well known that an unwarranted and unskilled extension of the backswing and downswing can be harmful to a player's control of his downswing.

The following general steps may be followed when an improvement is coached in a player's DRAPBs or DRAPEs. The player's set of PADJEs are collectively determined and collectively analysed. On the basis of the analysis, some of the individual PADJEs or sets of PADJEs which are kindred PADJEs with respect to coaching DRAPBs or DRAPEs, are selected and separately coached to cause earlier angular occurrence of their DRAPBs or DRAPEs. Subsequently, individual PADJEs or sets of kindred PADJEs are selected, which are not necessarily the same PADJEs as those selected to cause earlier occurrence of their DRAPBs or DRAPEs, and coached to increase their magnitudes. This in turn improves the overall swing, including increased clubhead energy and speed at impact.

It should be noted that an earlier angular occurrence of DRAPB or DRAPE of a player's particular joint is not directly linked to an increase in the magnitude of the PADJE of that joint, but rather the former tends to facilitate and accompany a more general increase of the player's set of PADJEs which may or may not include the PADJE which has had its DRAPB or DRAPE improved.

Because there does not appear to be an obvious direct relationship between the magnitude and the earlier occurrence of DRAPB or DRAPE of a particular individual joint, it can sometimes be advantageous to at least partly improve the player's general pattern of DRAPBs and DRAPEs across the principal major joints before coaching an increase in the magnitudes of the unseen-parameters of a particular joint.

Causing earlier angular occurrence of DRAPBs and DRAPEs usually accompanies and facilitates the processes of increased powered-angular-displacement and increased powered-angular-velocity in individual PADJEs. It should not be conflated with the kinematic phenomenon known in prior art as ‘wind-up’ where it is sometimes claimed that a player can deliberately coil his body towards the end of backswing to gain advantage at the start of downswing. Earlier angular occurrence of DRAPBs and DRAPEs can occur with all or any of the player's joints, with energy being generated angularly earlier in relation to the angular cycle of the swing from the top-of-backswing (TOB) event to impact, rather than before or at the TOB event as would occur with the claimed ‘wind-up’ phenomenon.

Highly-accomplished low-downswing-handicap players typically have spans between DRAPBs and DRAPEs around 15%-20% greater than unaccomplished high-downswing-handicap players. Earlier occurrence of DRAPB and the span between DRAPB and

DRAPE appears to be at least partly independent in their own rights. DRAPB usually occurs angularly earlier for more accomplished players for all joints. The span between DRAPB and DRAPE is usually greater for more accomplished players for most joints, but usually is more neutral for left elbow and right elbow joints and usually shorter for right knee and right wrist joints.

Comparators for DRAPBs and DRAPEs are more likely to involve regression control parameters related to clubhead-energy-at-impact or downswing-handicap values, rather than the typical regression control parameters related to PADJE values as discussed earlier.

These pattern-wise phenomena in the downswing cycle can also be measured by parameters other than the angle described by the club shaft in the swing plane as it rotates from top-of-backswing to ball impact. For example, it can be measured by the angle described by the club shaft in other planes, such as by projection onto the vertical plane, or by an angle described by the player's lower arms.

3.12 Transmission-Efficiency.

Transmission-efficiency is defined in this specification as clubhead kinetic energy, just prior to impact with the ball, divided by total PADJE. As already discussed, transmission of PADJE to the clubhead is, on average, no more than very weakly correlated with player skill. It also displays a wide and similar level of variation across the range of skill levels. This phenomenon shall be referred to as the “transmission-efficiency phenomenon” elsewhere in this specification. It is a further insight of the invention that transmission-efficiency can be improved by appropriate coaching to increase clubhead kinetic energy at impact.

With respect to club equivalency and transmission-efficiency, it has been found that the correlation of transmission-efficiency between clubs of different types is not as strong as the correlation of PADJE proportions between clubs of different types, which was discussed earlier. For individual players, there is close correlation between the transmission-efficiency for different distance clubs, ranging from drivers to 5-iron clubs, however, there is a gradual and steep decline in such correlation for increasingly shorter clubs. This decline in correlation is likely to relate to transmission-efficiency being increasingly less important for increasingly shorter clubs, where less attention is given to maximising energy delivered to the clubhead.

Somewhat similar to the PADJE-proportions phenomenon, it is hypothesised that the reason why transmission is largely unrelated to player skill is that when a player develops his initial skills in executing the downswing, he typically subconsciously assembles an initial pattern of transmission mechanisms which usually is largely retained as he improves his downswing skills over future periods, usually involving many years. His overall level of PADJE generation increases, but usually his transmission-efficiency will remain largely unchanged. What is unexpected is not so much that there is wide variation in transmission-efficiency between players but that for the individual player his initial transmission-efficiency largely remains unchanged as he improves his downswing skills. The evidence supporting this hypothesis is given later in this specification.

The somewhat unusual and unexpected characteristics of PADJE-proportions and energy transmission are probably at least partly responsible for the general and completely mistaken prior art belief that players have immutably different swings which prevent the golf downswing from ever being principally or fully coached on a scientific basis. Indeed, players do have very different swings, but these are scientifically assessed and accounted in the systems of the present invention. In contrast, traditional golf coaching has never had knowledge of or access to player's unseen characteristics and has largely relied on coaching a single idealised and ‘perfect’ swing, supposedly suited to all players.

3.12.1 Improving Transmission-Efficiency.

It has been found that the most important influencing parameters related to transmission-efficiency, which will be referred to as ‘transmission-efficiency parameters’, are the proportion of segment kinetic energy (SKE) which remains in the player's body at or immediately following impact, the amount of negative joint energy (NJE) absorbed in the downswing, the change in gravitational potential energy (GPE) of the player segments and club between the start and finish of the downswing and air friction (AF) losses during the downswing. Of these, the following approximate average losses in driver swings are found in the research database referred to earlier in this specification. SKE of about 96 J accounts for a little under 50%, NJE of about 57 J accounts for a little under 30%, GPE of about 36 J accounts for a little under 20% and AF of about 10 J accounts for about 5%. The total of these losses amounts to just under 200 J. For an individual player, SKE, NJE and AF losses are always present to some degree and always give rise to a loss in energy to the system. GPE, however, can give an energy gain or an energy loss.

Interestingly, there appears to be no significant correlation between transmission-efficiency and either NJE or GPE, taken across the averages for players in the research database.

Also, there is only very weak correlation between transmission-efficiency and SKE. This appears to indicate that on average, in this research database, energy lost in these processes is, on average, compensated by gains elsewhere, thereby maintaining average transmission-efficiency. However, when taken on an individual player basis, these losses are the principal causes for the wide variation in player transmission-efficiency, and where appropriate methods are used, have the potential to be reduced without concomitant loss elsewhere in the system.

It is also believed that the existence of biarticular muscles, including those which can influence both hip and knee joints in a single leg, may sometimes cause inverse dynamics calculations to overstate PADJE value in one joint, and give rise to an artificial balancing value of NJE in the other joint. However, although this can cause an overstatement of actual NJE values, it is believed that the amounts are likely to be small compared to actual NJE values.

Various strategies can be adopted to improve transmission-efficiency as a means to increase clubhead energy at impact. One such strategy is to compare the player's overall transmission-efficiency with appropriate comparators for that player and to pursue an increase in transmission-efficiency if the comparison shows it to be significantly below average comparator value, but not to pursue it if it is not significantly below average comparator value. Another strategy is to separately compare the player's transmission-efficiency with respect to SKE, NJE or GPE values with corresponding SKE, NJE or GPE average comparator values and to pursue improvements to one or more of those which are significantly worse than the average comparator values, but not to pursue improvements with those which are not significantly worse than average comparator values.

A further strategy is to prioritise the improvement of SKE over the improvement of NJE or GPE, partly because SKE is usually much larger than NJE or GPE, and also because NJE is more difficult to coach or understand, and GPE is usually associated with a particular style-variation which might not be amenable to change. A particular strategy, where SKE is coached, is to reduce SKE losses by coaching a reduction in the build-up of speed in segments which are judged to have excess speed after impact. An alternative strategy, where SKE is coached and excess speeds are present, is to retain the initial build-up of speed and to coach a reduction in SKE losses by causing the already built-up excess speed in segments to be slowed down prior to impact, using internal processes that transfer as much as possible of this energy to the clubhead before impact.

Where SKE, NJE or GPE are chosen for improvement, it will usually be advantageous to track their development through the course of the downswing and either compare their continuous profiles or their values at different points over the course of the downswing with those of appropriate average comparator values or of values better than average comparator values. Differences between them and average comparators over the course of the downswing can indicate where and why the losses are occurring and point the way to remedial action. For example, where a player is found to have excess SKE in his arm segments at impact, the comparison will indicate whether the problem lies with delivering too much kinetic energy to the arms in the middle stages of the downswing or not extracting sufficient energy from them in the lead up to impact. Analysis of this type can be readily carried out by an apparatus processor.

3.13 Preventing Injury During the Downswing.

A further aspect of the invention involves improving the strength of the swing to prevent injury to the player during the downswing. This can be done either by coaching the player in a manner which avoids relevant parameter levels known to cause injury, or to coach a reduction in relevant parameter levels which are deemed to be causing injury or are deemed to be close to causing injury or likely to cause injury. It can also be done by providing alerts or warnings that parameters are approaching close to causing injury to the player so that remedial action can be taken. The relevant parameters include the downswing parameters, including magnitudes, average magnitudes and peak magnitudes, of torques, powered angular displacements, angular displacements, powered angular velocities, angular velocities, and joint powers which are excessive or deemed to be excessive.

The relevant parameters can be readily measured and analysed by an apparatus processor providing it with sets of comparator value relationships for the above-mentioned relevant parameters, with the comparator values taking the player's physical characteristics into account along with any history of relevant past injuries, weaknesses or illnesses. Different levels of closeness to likely injury may be used to trigger different actions, including, for example, advisory alerts and serious warning. Combinations of comparators may also be taken into account, as several high values arising simultaneously in adjacent joint regions of the body can have a cumulative injurious result. Comparator values may be set using knowledge from experts in prevention of golf-related injuries. Relevant comparator values will invariably be much higher than ordinary comparator values for normal play.

3.14 Style-Variations.

Prior art recognises that broad proportions of players can use different technical styles where both styles are considered to represent accomplished swing performance. These are sometimes referred to as ‘style-variations’. The term should not be conflated with the ability of an individual to achieve the same movement outcome in different ways, which is also recognised in prior art. One common identified style-variation relates to the change in gravitational potential energy, between the top-of-backswing and impact, of many segments of the body, principally including all trunk segments and excluding the arm and hand segments and the club segment. Many accomplished players have a significant negative exchange of gravitational potential energy in these segments over the downswing, with these segments tending to elevate and extract gravitational potential energy from the system, which is typically more than compensated by additional muscle activity which generates additional positive joint energy. Other accomplished players do not do this or do it to a much lesser extent. This appears to be unknown in prior art. Another identified style-variation relates to the degree of relative rotation about the spine between the shoulders and hips. Some accomplished players execute a relatively large degree of rotation in the downswing and other accomplished players hardly do it at all or to a much lesser degree. This style-variation is well known in prior art, although its relation to PADJE proportions appears to be unknown.

It has been found that these style-variations are not on average accompanied by significant differences in average PADJE proportions, and thus no allowance need be made for style-variations when assessing and coaching a player. The reason for this would appear to be due to the player's largely unchanging PADJE proportions as the player increases his level of skill over many years, including developing or changing his style variation. However, as previously mentioned, changes in gravitational potential energy over the downswing can affect transmission-efficiency.

3.15 Suggested Explanation for Largely Unchanging PADJE-Proportions and Transmission-Efficiency Phenomena.

It has been hypothesised earlier in this specification that, based on available information, the most likely reason for the phenomena of PADJE-proportions and transmission-efficiency being largely unrelated to skill is due to these patterns largely remaining unchanged as the typical player improves his downswing skills, usually involving many years. It has not been possible to directly test these hypotheses for individual players over long periods of time, because the insights into and discoveries of these phenomena are of relatively recent date. Instead, the hypotheses are based on careful analysis of available data, including data held in the earlier-described research database.

The following characteristics are indicated by these data with respect to the phenomena of PADJE-proportions. There is a very wide variation in PADJE proportions between different players and, of primary importance, the PADJE proportions pattern has little or no correlation with skill. Taken over all players, average PADJE proportions are approximately proportional to average muscle distribution, but PADJE proportions vary widely for individual players irrespective of their individual muscle distribution. Furthermore, most players have a few very high individual PADJE proportions and a few very low individual PADJE proportions. However, a small minority of players have fairly even PADJE proportions, similar to the overall averages. These high and low proportions occur with roughly equal frequency for all PADJE joints. In addition, all PADJEs appear to vary in a fairly smooth Gaussian distribution about the overall average. An individual player will have almost identical PADJE proportions for all his swings, and very similar PADJE proportions between clubs of different distance. Furthermore, the statistical characteristics of the patterns is almost identical for the various skill levels, in these various ways; the patterns of proportional PADJE magnitudes are statistically roughly identical, including their relative standard deviations and variances; and the patterns of selection of individual PADJEs which are likely to have high or low proportions are statistically roughly identical, again including their relative standard deviations and variances. In addition, no significant correlation has been found between players' physical characteristics and their PADJE proportions.

From the above, it appears that as players typically gain skill over the years and increase the overall magnitude of their total PADJE, either, a) they are continually or occasionally gradually swapping their PADJE proportions around in a statistically unchanging manner, or b) they are continually or occasionally swapping their PADJE proportions around in a statistically unchanging manner in discrete jumps from one state to another, or c) they maintain the same or very similar PADJE proportions and statistical characteristics over the period. It is the applicant's belief that it is very unlikely that either of the first two possibilities, a) or b), can be valid because it seems inconceivable that players would be regularly swapping around these very important PADJE characteristics as they increase their skills to wind up with sets of characteristics which have as much chance as being those of an unskilled player as of a skilled player. On this basis, it is the applicant's belief that the third possibility c) is far more likely to be what actually occurs.

Very similar arguments apply to the phenomenon of transmission-efficiency being largely unrelated to skill being due to these patterns largely remaining unchanged as the typical player improves his downswing skills, usually involving many years. In this instance, instead of the set of individual PADJE proportions, the arguments concern the set of individual energy transfer mechanisms associated with each PADJE. The statistical arguments are the same for both.

The phenomena of largely unchanging PADJE proportions and largely unchanging transmission-efficiency as players become more accomplished, as discussed above, do not appear to be adequately explained by traditional motor control or motor learning theories. Traditional motor control theory favours a central cognitive learning process, whereby a person obtains sensory information, interprets that information internally, and then responds to that information. It is believed that a better understanding of the phenomena can be obtained from relatively recent, alternative motor learning theory, allied with some insights obtained by the applicant from the statistical characteristics of the research database information, which will now be used to suggest an explanation for the phenomena.

According to this more recent motor learning theory, when a human is tasked with a relatively complex movement, there will be multiple biomechanical movement variables available to organise the movement, providing many different possible ways to respond to the task. These movement variables are sometimes referred to as ‘degrees-of-freedom’ in prior art. They include the possible actions of joints, muscles and motor units of the body involved in the various ways of effecting the movement. However, in a new complex movement there will usually be far more movement variables than can be organised all at once. Nevertheless, the human motor system, in common with that of many animals, has a subconscious capability of using greater numbers of these movement variables by coordinating the movement variables, assembling them into groups, re-organising them and controlling them as groups of movement variables. This grouping is an important part of a process which is frequently referred to in prior art as ‘self-organising’ or ‘self-organisation’. This self-organising ability occurs under the physical and informational constraints which limit the movements. According to this motor learning theory, these constraints help the system to re-organise as a functional coordination pattern. As the individual person becomes more skilled at a particular type of task, he develops a wider repertoire of these groups of movement variables. The self-organising process is also capable of modifying or combining these groups of movement variables to adapt to changing external environmental or internal body circumstances, and the groups are capable of being assembled or disassembled as needed.

When a player first learns to execute a golf swing, the required downswing movement will usually be quite unfamiliar and his motor system will typically be unable to organise the vast majority of his available movement variables. In response, his motor system will spontaneously limit them by freezing or partly limiting joint movements, to reduce the required movement to a much smaller and more controllable number of movement variables. This initial self-organisation typically results in a stiff, jerky swing which is unlikely to connect properly with the ball or to hit it any appreciable distance. With practice, the player's motor system will self-organise various of the movement variables into manageable groups which can be combined or modified to execute an increasingly more skilled swing, with muscles more relaxed and joints allowed freer movement. It will also assemble an increasing repertoire of these groups with sufficient flexibility to cope with changing swing requirements or conditions.

Assuming the above motor learning theory to be largely correct, it is hypothesised that when the player's motor system reduces the large available number of movement variables in the early stages of self-organising the complex golf swing, its self-organising capability is stretched and it first discovers a path to improving, optimising or increasing the functionality of just one or a very small number of individual PADJEs, where the term ‘increasing functionality’ should be understood to mean improvement or optimisation which recognises variability within people and between people. Because all players commence this process in a relatively unskilled state, and because there are a very large number of available movement variables, the choice of PADJE being selected in the initial attempt at improvement or increasing functionality occurs in what appears to be a random manner, not related to the ultimate skill level of the player. When this early stage of self-organisation has been completed and the player's self-organising motor system has found what it subconsciously deems to be a workable solution to the task of successfully executing a golf swing, it is hypothesised that it rarely returns to its starting position to commence additionally improving or increasing the functionality of the PADJEs passed over on the first round. Instead it usually tries to improve PADJE aspects of the swing by involving further movement variables to increase overall performance in the already-established overall pattern of the swing, with the already selected PADJEs leading this type of improvement or increased functionality. The player's conscious desire to hit the ball further does not appear to signal the self-organisation process to cause the laggard PADJEs to break out of the existing pattern and catch up with the already leading PADJEs. This may be because the player is completely unaware, both consciously and subconsciously, of having uneven PADJE proportions which do not uniformly utilise the energy generating potential of his body. Indeed, the uneven characteristics of energy generation in player's bodies is undetectable to such a degree by players in general as to be completely unknown in prior art up to the discoveries now disclosed in this specification.

Similar circumstances appear to apply to the mechanisms which determine the transmission-efficiency of the player's swing, except that in this case, they entail the movement variables involved in transferring energy generated at the joints to the clubhead. The player's conscious desire to hit the ball further does not appear to signal the self-organisation process to search for more efficient ways to transfer PADJE energy to the clubhead. Similar to the position with uneven PADJE proportions, this may be because the player is completely unaware, both consciously or subconsciously, of having scope to improve, optimise or increase the functionality of his transmission-efficiency or a need to improve transmission-efficiency. Again, similarly, unevenness in player's transmission-efficiency is undetected to such a degree by players in general as to be completely unknown in prior art up to the discoveries now disclosed in this specification.

The phenomenon of transmission-efficiency typically remaining approximately unchanged, as a player increases his skill, is closely related to the phenomenon of increased PADJE energy, on average, giving rise to an approximately proportional increase in energy delivered to the clubhead. The explanation may also be stated in the following way. Where PADJE is increased in a naturally improved swing, the player's self-organising process is able to deliver that increase in the same learned manner as his system did before the increase, with the same set of movement variables approximately transmitting the same proportion of generated energy on average, and therefore the same level of transmission-efficiency on average.

4. Coaching and Assessment Methods

4.1 Overview.

Various examples of coaching methods and apparatus, in accordance with the invention, are given through the specification, along with methods and apparatus for assessing the player prior to coaching. The elements of these examples may be mixed, combined or altered to suit varying player and market requirements. In all cases, the ultimate intended outcome is to improve the strength of the swing, as previously defined, including any combination of increasing, or preventing a decrease in clubhead speed at impact, ball speed and ball travel, alongside preventing, or reducing the risk of injury in the swing.

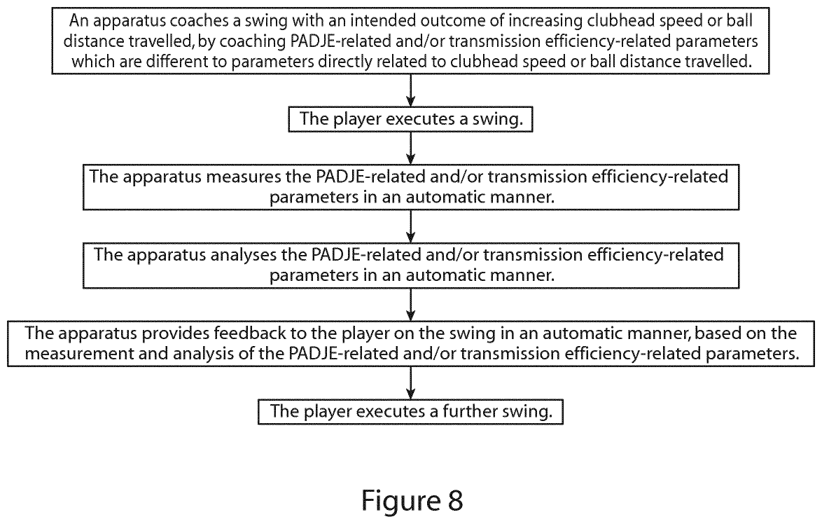

An example of some of the basic elements of coaching in accordance with the invention are shown summarised in the steps set out in the flow chart in FIG. 8. In a first step, an apparatus coaches a swing with an intended outcome of increasing clubhead speed or ball distance travelled, by coaching PADJE-related and/or transmission efficiency-related parameters which are different to parameters directly related to clubhead speed or ball distance travelled. In a second step, the player executes a swing. In a third step, the apparatus measures the PADJE-related and/or transmission efficiency-related parameters in an automatic manner. In a fourth step, the apparatus analyses the PADJE-related and/or transmission efficiency-related parameters in an automatic manner. In a fifth step, the apparatus provides feedback to the player on the swing in an automatic manner, based on the measurement and analysis of the PADJE-related and/or transmission efficiency-related parameters. In a final step, the player executes a further swing.

In the particular example shown, the intended outcome is an increase in clubhead speed or ball distance travelled, the apparatus is automatic and feedback is given directly to the player. In other examples, the intended outcome can include other aspects of increasing the strength of a swing, including increasing in clubhead energy or speed, increasing ball speed or the combination of ball loft and travel, or preventing or reducing the risk of injury in the swing by reducing forces, joint torques or joint angular displacements in the body which are deemed to be excessive. In other examples, one or more of measurement, analysis or provision of feedback may be executed with apparatus which is only partly automatic. This may occur, for example, where a human coach may make interventions and override one of the otherwise automatic processes, or where the analysis apparatus is confronted with a novel situation for which it is unable to make a judgement without expert human intervention. Finally, in other example, the apparatus may provide feedback to parties other than the player, including to other means which controls aspects of the ongoing coaching process with the player.

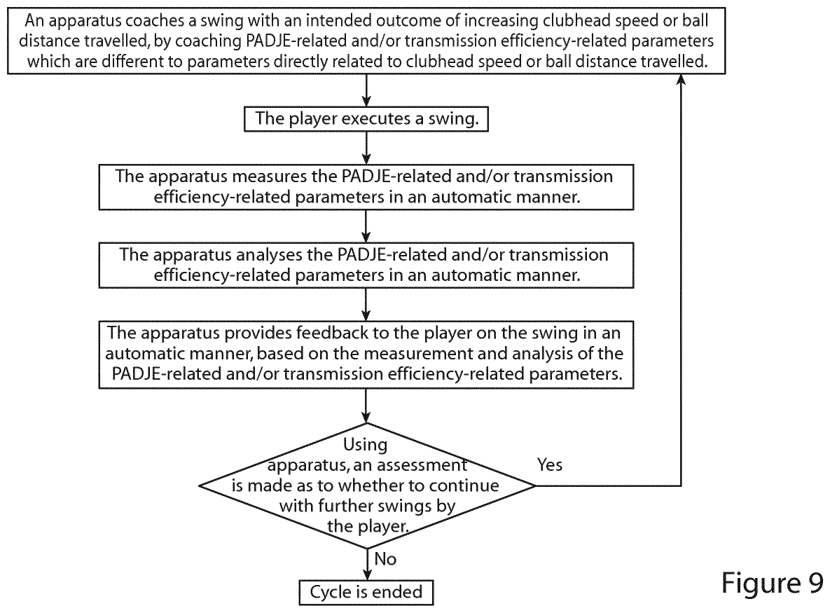

A further example of some of the elements of coaching in accordance with the invention are shown summarised in the steps set out in the flow chart in FIG. 9. This is similar to FIG. 8, but shows an additional step where the apparatus assesses whether or not the player should execute a further swing and repeat the processes of coaching, measurement, analysis and feedback. These processes are repeated in a continuing cycle until the apparatus determines that a further swing should not be executed, thereby ending the cycle. In other examples, some of the steps may be varied. For example, the coaching step may occasionally or frequently be omitted prior to the player executing the swing, allowing the player practice swings with information being obtained by simple feedback alone. The feedback step may also be occasionally omitted where a coaching exercise involves many repeated cycles.

Coaching is usually preceded by assessment of the player's characteristics and performance, particularly in relation to kinetic parameters, as this provides a basis for planning appropriate coaching exercises and providing measures against which the player's progress can be judged.

4.2 Particular Aspects of Coaching Unseen Parameters.

Coaching, using the scientifically-based principles of the present invention, provides a relatively direct path to improving, or increasing the functionality of energy generation through the body in the downswing, and its subsequent transmission to the clubhead by impact. This is not available through other coaching methods, which are inherently based on empirical, non-kinetic approaches. However, while the novel character of the new invention might be expected to raise some initial challenges for coaches and players not accustomed to them, it is believed that these can be overcome because the changes in movement patterns required by the new principles, largely comprise only magnitude variations within the player's existing repertoire of motor learning movement patterns.

Although many of the basic principles of the present invention can be coached using elements of traditional coaching techniques, further aspects of the invention include coaching methods which differ from traditional techniques. Traditional coaching in golf typically follows a prescriptive method of step-by-step practice drills aimed at achieving a particular motion pattern or template which the coach believes to be the correct way of carrying out whatever is being coached. All too often a common correct pattern is erroneously assumed for all players. Also, in traditional coaching, the player is ordinarily instructed with a focus on the movement of the player's body parts.

General sports coaching methods which follow a more recent and non-traditional view of the human motor learning system, promote a different approach which is believed to be more suitable for coaching the present invention. They differ from the traditional approach in several ways. One important difference involves a rejection of the assumption that a common or idealised movement pattern or template exists for all players. This point is particularly relevant to the present invention which recognises that each player commences with an individual and distinct set of relevant swing pattern parameters, and that these should be coached using particular and differing appropriate methods. These individual characteristics include the player's body segment parameters and the parameters describing his ability to execute a golf swing, including PADJEs, PADJE components, DRAPB, DRAPE and energy transmission characteristics, all of which may be measured or determined using the methods and systems of the present invention.

4.2.1 Body and Non-body Focuses.

An important difference to traditional coaching involves a preference, where feasible, for avoiding an emphasis on deliberate conscious focusing on movements of body parts, in instruction or feedback, which will for sake of clarity be referred to as ‘body-focuses’, as opposed to an emphasis on focusing on the goal task or intended outcome, which give at least some emphasis to the results of the movements of body parts, such as, for example, a ball trajectory. For sake of brevity, these latter types will be referred to as ‘non-body-focuses’. Body-focuses and non-body-focuses are sometimes referred to in prior art as Internal-focuses of attention' and ‘external-focuses of attention’, respectively. These comments concerning body-focus and non-body-focus partly apply to the movement of the club. Where feasible, it can be better to have the effect further from the body movement. Throughout this specification, the term ‘intended outcome’ or ‘outcome or intended outcome’ should be understood to mean the external, or obvious and visible outcome, such as ball or clubhead speed or distance travelled, rather than to an unseen parameter such as an increase in a powered angular displacement, irrespective as to whether the player has adopted a body-focus or a non-body-focus.

The reason for preferring, where feasible, non-body-focuses, or at least a mixture of non-body-focuses and body-focuses, is that it is believed that a deliberate conscious focus on body segment or joint movement in instruction or feedback will tend to inhibit or distract the human motor system's natural ability to subconsciously self-organise the wider complex motor system and impede improvisation and skill adaptation. It is believed that, where properly executed, such self-organisation will lead to improved skill acquisition and better retention of the acquired skills.

Where an issue of body-focuses and non-body-focuses arises, it is usually much more critical for verbal or written communications, which inhibit the self-organising process much more than communications which are not verbal or written, such as more abstract tonal, sensory or visual communications.

The characteristics of the present invention give rise to various potential difficulties in successfully applying an exclusive, or emphasised, non-body-focus in coaching instruction or feedback because the unseen parameters being coached are inherently of a body related nature and also because the player has very little conscious insight into what his body segments and joints actually do, or ought to do, in the downswing. The player will typically be unable to achieve the solution without some form of guidance. It is an aspect of the present invention that these potential difficulties can be overcome and some of the many possible approaches are disclosed in various examples discussed over the following paragraphs. These approaches may be used in conjunction or alongside those general coaching methods and techniques of the invention, which are not directly related to the issues of body-focus and non-body-focus. The examples, or elements of the examples, may also be used alone or in combination with each other.

As previously mentioned, an aspect of the present invention typically involves the coaching of one or more individual PADJES or sets of kindred PADJEs with a view to each achieving an outcome of higher clubhead speed. The system relies on the player's self-organising ability to successfully transmit the increased energy generated in the coached PADJEs to the clubhead in a manner with a level of efficiency equivalent or similar to the player's customary level, usually without direct coaching involvement in the transmission mechanisms within the body. To achieve this in the most effective manner, the system requires the player to ideally focus on achieving one or more of the outcomes or intended outcomes, such as higher clubhead speed or ball distance, rather than focus on energy generation in specific body parts. At the same time, the system must coach the player to generate more energy at the monitored individual PADJE joint, which provides the required highly accurate feedback to the player on the swing-by-swing success of this individual component of the generation and transmission process. The use of PADJE measurement as a highly accurate proxy for the outcome or intended outcome feedback is particularly important in coaching where the inevitable disturbance of the coaching process can cause overall performance, related to the outcome or intended outcome, to be temporarily compromised, thus further preventing possible useful feedback from that outcome on a swing-by-swing basis.

4.3 Coaching with Non-Body-Focuses.

4.3.1 Coaching where Individual PADJES or their Components are Targeted.

An example of coaching with non-body-focuses, where individual or kindred PADJEs or their components are targeted, is summarised in FIG. 10. The figure comprises a flow chart which shows the processes summarised in a set of steps, with some of the steps being repeated as further practice swings are carried out.

In the first two of these steps, the player's swing parameter information is obtained and analysed and one or more PADJE-related parameters and/or transmission efficiency parameters are selected for coaching. These parameters may be referred to as ‘the selected coaching parameters’

The third step, which will be referred to as the ‘Introductory Preparation’ step, is carried out separately to, and at least several minutes before, the player commences practice swings. In some instances, parts of this step may be carried out several days or more before the player commences the measured and coached practice swings. The player is given introductory preparation for coaching the selected coaching parameters. Because it is carried out separately to the practice swings, it allows the use of body-focuses in instruction and practice.

The fourth step, which will be referred to as the ‘Initial Pre-activation Preparation’ step, is carried out immediately prior to commencing the activation of the first practice swing. The player is given further preparation for coaching the selected coaching parameters. Instruction and practice involve non-body-focuses and as few as possible body-focuses, but not so few that the player is unable to correctly explore his way to the selected coaching parameters when practice swings get underway. The non-body-focuses will typically include ‘overt’ goal-orientated directions, such as hitting the ball further, but also ‘covert’ non-body-focuses which will direct the player to explore improvement with the selected coaching parameters.

The fifth step involves the player executing a practice swing. The practice swing is immediately measured and evaluated by the system. In this type of context, throughout the specification, the term ‘system’ will usually refer to the automatic operation of the measurement apparatus, and the programmed apparatus processor or a combination of programmed apparatus processor and human coach, or in some circumstances, intervention by a human coach.

In the sixth and seventh steps, the practice swing is measured and analysed. Usually this is carried out automatically by the system.

The eighth step, which will be referred to as the ‘Fast Feedback step, involves the provision of feedback to the player. Feedback is arranged to be given very soon after the downswing is completed and typically signals whether or not the player is correctly targeting the intended areas for changes to his swing, and where these are correctly targeted, whether or not and to what degree they are being correctly improved.

From the results of the analysis of the practice swing, the system determines whether or not the selected coaching parameters are being correctly identified by the player. If they are not, a cycle is commenced where the player is given further pre-activation preparation to guide him to the selected coaching parameters, using both body-focused and non-body-focused information, and a further practice swing is taken, measured and analysed. This step is headed as ‘further Guidance Pre-activation Preparation’ in FIG. 10. As this repeating cycle progresses, the information is gradually given a greater proportion of body-focused information. Occasionally, coaching guidance or instruction may be omitted from some of the repeated cycles. This particular cycle is ended when either the player correctly identifies the correct selected coaching parameters in his approach to coaching matters, or the system decides that this particular approach is no longer suitable and takes appropriate action, as will be discussed elsewhere in the specification. If measurement and analysis show the emergence of other unplanned PADJE-related improvements, rather than the planned selected PADJE-related improvements, the system may consider the possibility of switching the coaching target to this new unplanned PADJE-related improvement.

If the player has correctly identified the selected coaching parameters, the system will at this point usually then decides whether further pre-activation preparation, in relation to coaching, is required before the player takes a further swing. If it is not required, then the player takes a further practice swing and the same cycle and set of system decisions is repeated until the system decides that further practice swings are not required. If further coaching pre-activation preparation is required, then this is given to the player, then the player takes a further practice swing and the same cycle and set of system decisions is similarly repeated until the system decides that further practice swings are not required. Further coaching pre-activation preparation will include specific feedback, information or instruction. These will be given with a predominantly non-body-focus. This step is headed as ‘further Coaching Pre-activation Preparation’ in FIG. 10.

In a final step, the cycle of practice is ended when the test goals have been achieved or when the system determines that the coaching plan requires modification, or when it is deemed that a limit has been reached where matters such as player fatigue will inhibit the learning process in this particular session. It can also be useful to arrange the system such that the player can influence the cycle if he is feeling fatigued. Final feedback is usually given to the player following the practice session. It is acceptable to include body-focused information in this feedback because the step is not immediately followed by further practice swings.

Although in the previous paragraphs, feedback is discussed in relation to player feedback, feedback communication may also be provided to a human coach. Although the human coach will not require feedback to be given in non-body-focus format, nevertheless he may need to be aware of the type of feedback being given to the player. Where a human coach is involved, he may also add further points of feedback or instruction based on his personal skill and experience.

4.3.1.1 Additional Details on the Introductory Preparation Step.

Further details of the introductory preparation step are given over the following paragraphs.

The introductory preparation step may include body-focuses because there is sufficient time and disconnection between them and the practice swings to avoid interference with the self-organisation process. Relevant instruction and guidance in this step may therefore include body-focuses which explain the purpose of the coaching session. They may be communicated by verbal, visual or other sensory means. Ideally, both instruction and guidance should support the player's search activities for task solutions, with respect to the self-organising processes discussed earlier.

The introductory preparation step may also include body-focused exploration and practice by the player of increased relevant angular displacement, angular velocity or muscle activation in the selected joints. This may involve exaggerated increase of such angular displacement, angular velocity or muscle activation. For example, the player may be requested to practice a swing movement with increased angular-displacement of a joint in the downswing to an extent which he has not previously achieved or even attempted

The introductory preparation step may additionally include physiotherapeutic conditioning of the selected subject joints with a view to improving relevant angular displacement and muscle activation.

4.3.1.2 Additional Details on the Initial Pre-Activation Preparation Step.

Further details of the initial pre-activation-preparation step are given over the following paragraphs.

In the Initial Pre-activation Preparation step, which occurs just prior to the first measured practice swing, the player is instructed and prepared for the selected coaching parameters using non-body-focuses and as few as possible body-focuses, but not so few that the player is unable to get started in subconsciously identifying the selected coaching parameters. The non-body-focuses will typically include an overt goal-orientated direction, such as hitting the ball further, but also non-body-focuses which will direct the player to explore improvement with the selected coaching parameters, which may be referred to as ‘covert’ non-body-focuses. Insofar as feasible, the system should provide context for the required practice for the player, to make it more relevant to real play. For example, the test area may be provided with a golf simulator and screen which shows an appropriate golf course terrain and moving image of a ball trajectory as would have been produced by the player's swing.

There are various covert approaches to preparing and instructing the player using non-body-focuses which are appropriate to this step. A selection of these is described below.

One covert approach involves the inclusion of hints or guides to the body-focus issues of attention while at the same time placing an emphasis on the non-body-focus issues of attention, but not so strong as to inhibit the player's self-organising capability.

Another covert approach involves using an appropriate analogy which hints at the desired body movement. For example, the player might be asked to visualise a particular movement of the club or trajectory of the ball. The player might also be invited to explore various undefined body movements to achieve a variety of movements of the club or trajectory of the ball to hit a particular target or achieve an increased distance. In another example, the player might visualise an imaginary flexible link between a relevant point in his body and the clubhead or ball, and to strike the ball with a view to maximising ball speed aided by an additional boost from that imaginary link. In another analogy example, the player may be asked to introduce some carefully selected element into his swing which resembles some other motion with which he is familiar. The analogies, hints or guides may be communicated visually, verbally or by other sensory means to the player. In an automated system, such communication can, for example, be conveniently given using pre-prepared material shown on a screen.

A further covert approach involves increasing the player's sensory awareness. One simple method, particularly viable where limb joints are being coached, is to use textured or compression materials in contact with skin surfaces adjacent or around the targeted joints, which will instantaneously heighten sensory awareness of the joint whenever it is moved, as the joint movement will cause the material to move relative to the player's skin close to where the joint articulates. Ideally, the materials should be comfortable to prevent masking of the signals received when the joint moves. Readily available compression garments can also be worn to generally increase sensory awareness around a limb joint. Sensory awareness can also be increased by activities such as dry-brushing the skin or massaging with a ‘spikey’ ball or foam roller, particularly around areas adjacent to the targeted muscle groups of the selected joints. Sensory awareness can also be increased by standing in bare feet during the swing. These activities can also beneficially improve mobility or flexibility in the applied area. Targeted stretching and muscle activation can also be applied to recruit specific muscle groups to facilitate the process of re-organisation of motor patterns, leading to new emergent patterns. Some of these sensory awareness approaches may also be usefully included in the Introductory Preparation step.

A yet further covert approach involves sending a low-level signal to the player's skin in the region of the selected joint and muscle groups, using means such as electrical stimulation or vibratory stimulation with a lightweight pad or sensor attached to the player's skin or segment. The signal may be supplied to guide the player to a joint which is to be activated.

Providing the signal as a guide can be useful at the outset of a set of practice swings, or when a player is having difficulty in activating the correct joint before coaching gets properly under way.

Another covert approach involves providing the player with a coaching aid which assists the planned activation of the selected joint. For example, if the planned activation was to increase the angular displacement of a particular joint, the coaching aid may be arranged to urge greater angular displacement when the included angle of the joint exceeds a set amount. The urging torque may be supplied, for example, by triggering the action of a preloaded spring, preloaded elastic element or small pneumatic cylinder.

A further covert approach involves using restraints to partly suppress or limit the activation of one or more joints adjacent to the selected joints, to encourage greater activation of the selected joint where the player attempts a general increase in movement in that general area. One suppression technique involves restraining the angular displacement of a PADJE using a physical restraint. Various types of restraints may be used to limit the movements of individual or groups of joints. Some suitable types are readily available at low cost and can be fitted simply and quickly, with an original intended use in medical applications not directly related to coaching. Restraints may comprise adhesive tape or compression materials or garments. They may also comprise simple strapped types, or girdles or harnesses which have the capability of restraining several joints, separately or together. They may also comprise readily-available mechanical braces which limit the angular movement of a joint between two angular and adjustable setting. Suppression may also be carried out by restraints with damper elements which limit the velocity at which a joint is displaced. They may additionally comprise restraints which constrain the 3D movement path of a segment about a joint. Ideally, restraints should be of an adjustable nature, such that the level of restraint may be changed, for example by tightening or loosening a strap. In general, where restraints are used, ideally, they should be varied in some way to encourage exploration and adaptation by the player's self-organising processes.

Another covert approach, similar to the previous approach, involves using restraints to partly suppress or limit one or more of the player's highest magnitude PADJEs which do not comprise selected joints which are directly associated with the selected coaching parameters. The purpose of suppression in this instance is to encourage the player's self-organising process to explore means to compensate the loss by increasing the activation of the selected coaching parameters.

As previously mentioned, some body-focuses may also be necessary, especially at the commencement of the set of practice swings, to direct the player correctly to the selected coaching parameters. These may include direct instruction relating to the relevant activity of the selected coaching parameter, together with practice movements before actually taking a measured swing.

4.3.1.3 Additional Details Relating to Feedback in the Swing.

An important aspect of the invention relates to a realisation that impediments exist which inhibit improvement of the unseen-downswing due to natural limitations in human feedback systems and that these can be overcome by providing appropriate communicated feedback from measured parameters using the methods and systems of the invention. The downswing differs from other parts of the swing in that the movement is so rapid, the downswing of accomplished players usually being less than 0.3 seconds, that the body and sensory system cannot make conscious corrective actions once the downswing has commenced. The player is faced with the formidable hurdle of not consciously understanding what it is that he must do to improve his downswing, which is overcome by very rapidly measuring, analysing the practice swing and communicating the results as feedback in an appropriate manner to the player, such that the player receives what appears to him to be near-instantaneous or fast relevant feedback on the swing, as he would in a more conventional human learning activity. Thus, the player can take a series of swings in close succession, and receive near-instantaneous or fast feedback, ideally with a non-body-focus, informing him as to what degree he has achieved improvement or deterioration in the unseen-parameters or transmission-efficiency-parameters, which are the subjects of the particular coaching session. The comparators against which the swing is judged may, for example, be his performance in an assessment which provided the comparative basis for the coaching session.

4.3.1.4 Additional Details on the Fast Feedback Step.

Further details of the fast feedback step are given over the following paragraphs.

Fast feedback on the swing given to the player, should be commenced as quickly as possible. Ideally it should be non-verbal, although very simple words may be used. The term ‘fast’ should be understood to mean that the feedback should appear to the player to be near-immediate or near-instantaneous. Ideally, it should signal whether or not the player is correctly targeting the intended areas for changes to his swing, and where they are correctly targeted, it should also signal whether or not and to what degree the selected parameters are being correctly improved.

There are various non-verbal and non-body-focus approaches, appropriate to this step, to provide the player with fast feedback. Some of these are described below.

One such non-verbal and non-body-focus approach involves a communicated signal indicating whether the targeted task is being achieved or not, and with some intuitive modification to the signal indicating the degree to which it is being achieved or otherwise. The communicated signal may also be arranged such that it provides two types of information, which can be useful where a target has two components. For example, where the targeted task is to increase a particular PADJE both by increasing its angular displacement and its average torque, the communicated signal may reflect the degree to which each of these components is improving or otherwise. Auditory feedback may be made available with different tones and intensity providing intuitive indications of improved or deteriorated performance, including the degrees of improvement or deterioration. Visual feedback may also be given which provides intuitive indications of improved or deteriorated performance. Feedback may also be provided by electrical and vibratory signalling to the player's skin or body segments, as already discussed.

Another related approach involves a communicated signal which additionally indicates whether and to what degree other concomitant changes are occurring in the swing, in particular concomitant deterioration of performance in other areas.

A further non-body-focus approach involves providing a sensory signal to a portion of the player's skin or segment adjacent the selected joint to signal that a particular joint has been correctly activated in the swing and also the degree to which it is being activated. The sensory signal may be similar to that described for use in the pre-activation preparation step and may comprise, for example, an electrical stimulation or vibratory stimulation with a pad or sensor attached to the player's skin or segment. The pads or sensors, and associated equipment, should be lightweight and unobtrusive. Where the signal is indicating that a joint is being correctly activated, a sensible quality of the signal, such as its intensity, may be increased or decreased to indicate increase or decrease in the intended improvement.

A yet further non-body-focus approach, with respect to enhancing sensory feedback signals sent to the player's skin or segment, is to commence the signals as rapidly as possible. This may be achieved in various ways. One method is to determine where improvement occurs by measuring a more easily and quickly measured relevant parameter. In particular, the system may prioritise the determination of that parameter and base feedback on that prioritised information. For example, where a targeted task is to increase the powered-angular-displacement of a selected joint, the system may prioritise the measurement and analysis of the kinematic parameter of angular displacement of that particular joint over other measurements or analysis. The determination may also be hastened by analysing changes in the early portion of the activation of the measured parameter and estimate whether or not it has improved by comparing its early portion with the early portion of the same parameter in previous swings executed in the set of practice swings.

Throughout this specification, the term ‘fast feedback’ should be understood to mean feedback that is prepared and communicated rapidly or without delay. It implies an intention to have the feedback prepared and communicated to the recipient, which will usually be the player, while the swing is still fresh in the recipient's mind. This type of feedback will usually be short and simple in nature to allow it be communicated quickly and also to allow it be communicated without a body-focus or with a lesser amount of body-focus. It may be of a type which will appear near-instantaneous to the player, as this is normally the way motor learning is achieved in a more natural human activity. It will usually be sufficiently fast that it is given and absorbed before the player takes another swing, or before the player is given further instruction or more verbalised feedback instruction. Ideally it is given within a few seconds of the swing being executed, if possible, within about five seconds.

Reducing the amount of time taken to communicate feedback from the downswing can be assisted by automating or at least partly automating each of the measurement apparatus, the analysis apparatus and the feedback provision apparatus, because an automated or at least partly automated apparatus will normally have the capability of acting faster than one which is dependent on human intervention or a greater degree of human intervention.

4.3.1.5 Additional Details on the Further Guidance Pre-Activation Preparation Step.

Where the player fails to accurately identify the correct selected coaching parameters in the practice swing, or is activating an unwanted mixture of unintended parameters along with the selected coaching parameters, it may be necessary to additionally include some body-focus feedback to get the coaching process properly underway. Appropriate approaches to such body-focus feedback include the same or similar approaches as those mentioned previously for the initial pre-activation preparation step and the introductory preparation step.

Where possible, variety should be introduced into such guidance from swing-to-swing. Feedback and instruction relating to such guidance may be communicated by any of the methods described elsewhere, sensory, auditory and visual, following a general rule that body-focuses should be used sparingly, but to whatever degree is necessary to assist the player in identifying the correct coaching parameters. As the player improves the level of identification, communication should move to a higher proportion of non-body-focuses.

4.3.1.6 Additional Details on the Further Coaching Pre-Activation Preparation Step.

The further Coaching Pre-Activation Preparation step arises in the swing-to-swing coaching cycle where the system deems it necessary to provide further instruction or feedback to the player to achieve the aims of the coaching session.

It is particularly important in this step that variety be maintained with feedback and instruction from swing-to-swing. One general way for maintaining variety is to manipulate the constraints which limit the player's performance to encourage the player to adapt. For example, for a particular movement, where a simulator and screen are used, different terrains may be displayed. In another example, the player may be requested to swing with different length clubs, for example, driver, wood and iron clubs, or with weights added to a club. Ball type may also be varied, ranging from a standard ball, to a light-weight practice ball, to no ball at all. Tee conditions may also be varied, for example swings with or without a tee. Where a tee is used, its height can be varied. Where a tee is not used, ground conditions can be varied, including use of a normal practice mat or hitting off a soft or an uneven surface such as a rumpled towel. Another variable which can be manipulated by the system over the course of a set of swings is the degree of pressure put on the player by the system, for example, by altering the instructed task goals.

Feedback may also be given by verbal or written communication, but normally this should only be done where non-verbal or non-written communication is deemed inadequate. Where verbal or written communication is given, it is better to use it economically and to try to avoid repetition and, where possible, not to provide it in successive practice swings. Where it is necessary to provide relatively complicated verbal or written feedback communication, it is sometimes useful to provide time for reflection by the player. Feedback and learning retention can also be made more effective by introducing an element of interest, challenge or fun for the player.

4.3.2 Coaching where Transmission-Efficiency Parameters are Targeted.

Similar principles to those expressed for PADJE coaching, apply to coaching targeted transmission-efficiency parameters, with respect to non-body-focuses, body-focuses, instruction and feedback. In the case of coaching segment kinetic energy (SKE), body-focuses will tend to involve body segments rather than body joints, negative joint energy (NJE) will tend to involve body joints, and gravitational potential energy (GPE) will tend to involve both body segments and joints.

4.3.3 Coaching where Individual DRABE or DRAPE Parameters are Targeted.

Similar principles to those expressed for PADJE coaching, also apply to coaching targeted individual DRABE or DRAPE parameters, except that in this instance the most important parameters are often the angular positions where individual DRABEs or DRAPEs start or finish, respectively.

Electrical or vibratory communication, similar to that already mentioned, can be particularly suitable for coaching DRABEs or DRAPEs. Rapid or fast feedback can be beneficial, and achieved in ways similar to that already described, including prioritising the determination of PADJE generation from changes in the kinematic parameters of angular displacement on the targeted joint, and also changes in the earliest portion of the activation of the measured parameter and estimating whether or not it has improved by comparing its early portion with the early portion of the same parameter in previous swings executed in the set of practice swings.

4.3.4 Example of Coaching with Non-Body-Focuses where Individual PADJEs are Not Targeted.

The invention also provides an alternative example of coaching with non-body-focuses where individual PADJEs are not targeted. This approach avoids body-focuses by limiting or partly suppressing the natural performance of one or a small number of high-proportion PADJE joints. For the sake of brevity, the process will generally be referred to as ‘suppression’ or ‘suppression of PADJEs’. The self-organising capability of the player's motor system is then used to cause other existing PADJEs to develop into new high-proportion or more highly-performing PADJEs, forcing provocative search and continuous skill adaptation during practice. It is believed that this may occur in a similar manner to that which has already been hypothesised to have occurred in the player's development of high-proportion PADJEs when he first learned to execute a swing. Although this approach has not yet been proven in long-term testing, where successful it has the potential advantage that it does not require targeting of particular PADJEs for coaching and therefore does not involve a body-focus which could inhibit the player's spontaneous self-organising process. It also has the potential advantage that it allows the self-organising process select the PADJEs to be improved, optimised or made more functional rather than attempting to force the selection on it, promoting more natural and effective skill acquisition.

In one set of examples of the method, a flexible exploratory approach is adopted when using this procedure to develop new high-performing PADJEs or, indeed, increasing the average magnitude of PADJEs in general. Different types and different degrees of suppression may be used in the exploratory process. For example, the coaching session may commence with suppression of the PADJEs at a relatively low level, and then gradually increase it to a relatively high level, at each stage adjusting some of the variables up and down a little, but with the trend towards an overall increase in suppression. The level of suppression may be temporarily held steady or reduced if the player experiences difficulty in maintaining a natural swing. The increase in suppression may be stopped when some of the unsuppressed PADJEs increase to average levels for their particular type, or even to levels of high-proportions for their type if the process continues at a reasonable pace. With the new increased PADJEs, monitored practice should be continued until this new pattern successfully stabilises. Throughout this process, the system or coach monitors the player's progress in this development and intervenes where appropriate. The level of suppression of the initial PADJEs is then gradually reduced alongside continued monitored practice, checking that the performance of the new increased PADJEs remains largely unchanged as the original high-proportion PADJEs are spontaneously restored to their original levels.

This process may require back and forth adjustments of the different variables of suppression, because the player's self-organising system needs, inter alia, to organise the transmission to the clubhead of this gradually increasing level of generated energy without loss of transmission-efficiency. Ultimately a higher level of PADJE is generated in the swing, and a corresponding higher amount of energy transmitted to the clubhead. Monitored practice is continued until a final stable pattern is achieved.

When the new PADJEs are increased or optimised and successfully eased into the player's repertoire of highly performing PADJEs alongside the original high-proportion ones, the process may be repeated to allow the self-organising capability find further high-performing PADJEs by suppression of all of the increased group of high-performing PADJEs. This process can be further repeated to find even more high-performing PADJEs, until all of the relatively important PADJEs have attained levels roughly consistent with, or better than, average comparator values.

Where a particular PADJE requires further attention, following the end of suppression, coaching may be carried out by direct targeting of that PADJE, as described later in the specification.

Some players are known to commence, prior to any coaching in the subject, with a relatively even spread of PADJE proportions relative to average comparator values, or with a relatively even spread of proportions of the major PADJEs. In this instance, suppression may be commenced with one or more of any of the major PADJEs, similar to the process described earlier for high-proportion PADJEs.

One suppression technique involves restraining the angular displacement of a PADJE using a physical restraint. Various types of restraints may be used to limit the movements of relevant joints, including the various types already described in relation to suppression in the pre-activation step where individual PADJEs are targeted.

4.4 Coaching where Body-Focuses or Non-Body-Focuses are not Distinguished.

Because the use of non-body-focuses has not been adopted, or not yet adopted, by the majority or traditionally inclined coaches and players, it is worth noting that coaching may be conducted in accordance with the principles of the invention without any reference to body-focuses or non-body-focuses or any distinction being made between them. A summarised example of such coaching, where individual or kindred PADJEs or their components are targeted, shall now be given. The example is very similar to that summarised in FIG. 10, but without any reference to body-focuses or non-body-focuses. Similar steps are followed, except that no attempt is made to distinguish between body-focuses and non-body-focuses in instruction or feedback. Although it is believed that coaching and learning retention is significantly more successful with judicious use of non-body-focuses and body-focuses, the methods and apparatus of the invention will also work successfully with the more traditional approach where non-body-focuses and body-focuses are not distinguished.

In the first two steps, the player's swing parameter information is obtained and analysed and one or more PADJE-related parameters and/or transmission efficiency parameters are selected for coaching. The third step, which is equivalent to the ‘Introductory Preparation’ step in FIG. 10 and the earlier description, is carried out before the player commences practice swings. In some instances, parts of this step may be carried out several days or more before the player commences the measured and coached practice swings. The player is given introductory preparation for coaching the selected coaching parameters. The fourth step, which is equivalent to the ‘Initial Pre-activation Preparation’ step in FIG. 10 and the earlier description, is carried out immediately prior to commencing the activation of the first practice swing. The player is given further preparation for coaching the selected coaching parameters. The fifth step involves the player executing a practice swing. The practice swing is immediately measured and evaluated by the system. In the sixth and seventh steps, the practice swing is measured and analysed. Usually this is carried out automatically by the system. The eighth step, which is equivalent to the ‘Fast Feedback’ step in FIG. 10 and the earlier description, involves the provision of feedback to the player. Feedback is arranged to be given very soon after the downswing is completed and typically signals whether or not the player is correctly targeting the intended areas for changes to his swing, and where these are correctly targeted, whether or not and to what degree they are being correctly improved.

From the results of the analysis of the practice swing, the system determines whether or not the selected coaching parameters are being correctly identified by the player. If they are not, a cycle is commenced where the player is given further pre-activation preparation to guide him to the selected coaching parameters, and a further practice swing is taken, measured and analysed. This step is equivalent to the ‘further Guidance Pre-activation Preparation” step in FIG. 10 and the earlier description. Occasionally, coaching guidance or instruction may be omitted from some of the repeated cycles. This particular cycle is ended when either the player correctly identifies the correct selected coaching parameters in his approach to coaching matters, or the system decides that this particular approach is no longer suitable and takes appropriate action. If measurement and analysis show the emergence of other unplanned PADJE-related improvements, rather than the planned selected PADJE-related improvements, the system may consider the possibility of switching the coaching target to this new unplanned PADJE-related improvement.

If the player has correctly identified the selected coaching parameters, the system will at this point usually then decide whether further pre-activation preparation, in relation to coaching, is required before the player takes a further swing. If it is not required, then the player takes a further practice swing and the same cycle and set of system decisions is repeated until the system decides that further practice swings are not required. If further coaching pre-activation preparation is required, then this is given to the player, then the player takes a further practice swing and the same cycle and set of system decisions is similarly repeated until the system decides that further practice swings are not required. Further coaching pre-activation preparation will include specific feedback, information or instruction. This step is equivalent to the ‘further Coaching Pre-activation Preparation’ step in FIG. 10 and the earlier description.

In a final step, the cycle of practice is ended when the test goals have been achieved or when the system determines that the coaching plan requires modification, or when it is deemed that a limit has been reached where matters such as player fatigue will inhibit the learning process in this particular session. It can also be useful to arrange the system such that the player can influence the cycle if he is feeling fatigued. Final feedback is usually given to the player following the practice session.

5.0 Other Activities Related to Coaching.

5.1 Assessment before Coaching.

A player's performance level, particularly with respect to unseen parameters, is typically assessed before coaching commences. Assessment provides an important basis for planning a coaching programme and for providing measures against which a player's progress can be evaluated. In an example of such assessment, a broad range of a player's unseen-parameters are determined from sets of measured swings including distance swings, each set with a different club distance type. The sets may, for example, comprise twenty driver swings, ten 5-iron swings and ten 9-iron swings, together with any necessary warm-up swings which should not be used to contribute to the measured data. Ideally, the player will use his own clubs or ones similar to them.

Much of the raw data will comprise intermittent frame capture data. These data are smoothed and converted to continuous format using conventional methods. For each club type, the data will additionally be statistically analysed for consistency between individual swings and also averaged to give a single set of averaged data. The unseen-parameters are determined, and commencing and finishing points, typically at about 15% and 85% of untrimmed PADJE, are set for all or most unseen-parameters. The player's determined unseen-parameter results are compared to comparator values relevant to the player.

A different set of comparators is typically used at an initial assessment stage and at the coaching stage. In an example of an assessment, a player and his swings are first extensively tested at the assessment and all significant potentially relevant unseen-parameters are measured. These are compared to a corresponding set of relevant comparators. A great number of these tested parameters will be relatively unimportant for routine testing of most players and where determined to be of relative unimportance, are excluded from the coaching exercise to streamline the coaching and calculation processes. To this purpose, limits are pre-determined to decide when a player's unseen-parameter of this type falls outside usual or average comparator values. Examples of unseen-parameters which are assessed in this way include timing parameters and peak joint power values which are not considered to be of coaching importance unless they are unusually high or unusually low.

When a player is assessed at a later coaching stage, it is no longer necessary to compare all of his initially determined parameters against the corresponding set of unseen-parameter comparators, and only a much narrower set, known to be particularly relevant for coaching the average player, are compared to a corresponding narrower set of comparators. This narrower set of comparators will often be confined to the test results of distance clubs. Where coaching relates to PADJEs, they will usually comprise the absolute and proportional magnitudes of individual PADJEs and total PADJE, the absolute and proportional magnitudes of the relevant components of the individual PADJEs, the DRAPBs and DRAPEs of the individual PADJEs, and the spans between DRAPBs and DRAPEs of individual PADJEs. Relevant components will typically include average-powered-angular-displacement, average-powered-angular-velocity and average-torque. If a particular player is found to also have other unseen-parameters which are deemed relevant to coaching his swing, they are added to, or included in, his set of unseen-parameters used in the coaching stage. Where coaching relates to transmission-efficiency, they will usually relate to segment kinetic energy, gravitational potential energy and negative joint energy.

5.2 Determining Kindred PADJEs.

Depending on the characteristics of the individual player, the type of coaching and apparatus being used, and the particular PADJE being considered for coaching, a PADJE may be more effectively coached individually or as part of a set of ‘kindred’ PADJEs. As previously mentioned, kindred PADJEs are defined as those PADJEs which are best, or deemed best, to be coached as a set rather than coached individually.

A player's kindred PADJEs, if any, may be determined by methods similar to that described in the following example. An artificial intelligence, such as an artificial neural network (ANN) is used to determine the most probable arrangement of individual and kindred PADJEs applying to the player. Where an ANN is used, the inputs to the ANN include the magnitude values of the player's PADJEs, which will provide his information on his PADJE proportions, and other details which will provide information on his downswing-handicap and transmission efficiency. The ANN will have been trained using a large and representative database of players using similar type coaching methods and equipment, and in addition to being provided with the details of PADJEs, downswing-handicap and transmission efficiency of these players, will also be provided with details, with respect to the individual database players, as to whether PADJEs have been found to best coached individually or as kindred PADJEs of other particular PADJEs. The ANN will then predict an initial recommendation for the end-user player for each PADJE to be coached, whether it should be coached individually or coached alongside a set of kindred PADJEs.

In the above example, when coaching commences, the system monitors progress and, based on its assessment of the monitored progress, determines whether the initial ANN prediction was correct or requires change. If the latter, the system then changes the coaching plan in whatever manner is judged to be appropriate to the coaching method being used. For example, if a human coach is involved in the coaching system, the automated part of the system will advise the coach of the change in prediction and appropriate changes made in the coaching programme. If a human coach is not involved in the coaching system, the automated part of the system will make appropriate alterations to the coaching programme, some of which may be communicated to the player, where appropriate.

In the same example, when the ANN is initially trained, information on coaching results with individual and kindred PADJEs is determined in practical testing of players by expert coaches. An initial ANN is produced which is usable by experienced coaches who are capable of modifying and improving the predictions with respect to correctly identifying kindred PADJEs. These improved results are used to further refine the ANN. Following such refinement on large numbers of players of varied skill and characteristics, the system will be suitable for use by less experienced coaches and fully automated systems.

In some circumstances it will be possible to coach a PADJE either as an individual PADJE or jointly along with kindred PADJEs. The system may determine the optimum way to coach the PADJE by taking account of the following considerations. Coaching such a PADJE as an individual PADJE can be advantageous where its potential for improvement is far greater than its kindred PADJEs because coaching attention can be directed solely to it. Coaching such a PADJE as a kindred PADJEs can be advantageous when the kindred PADJEs also have similar potential for improvement.

5.3 Plan Formulation.

A plan is typically prepared before coaching is carried out, following completion of an assessment of the player. Frequently, the plan will include an overall general objective of increasing total PADJE. In the case of distance shots, it largely concerns increasing distance, although the additional potential available energy provides many other benefits. In the case of shorter shots, it is primarily with a view to increasing swing options and/or improving overall controlled swing performance. The elements of the plan may include targeting of the most underperforming components of the larger low-proportion PADJEs, as these are likely to be the parameters with most potential for improvement. They may also include targeting the weakest components of the high-proportion PADJEs, as an increase in the high-proportion PADJE may allow the whole PADJE pattern to move forward. An alternative approach to coaching PADJEs may be one which does not target individual PADJEs or PADJE components, but suppresses the higher-performing PADJEs to allow the player's self-organising capacity to spontaneously decide the route to increasing other PADJEs.

The plan will also commonly include improving DRAPBs and DRAPEs of PADJEs in general, as general improvements in these parameters tend to facilitate coaching of all PADJEs. As previously mentioned, these may be advantageously coached before or alongside coaching PADJE magnitudes or component magnitudes, particularly powered-angular-displacement or powered-angular-velocity.

Unless the player is found to already have high transmission-efficiency, the plan may additionally include improving transmission-efficiency, as increases in transmission-efficiency will magnify the proportion of PADJE energy transmitted to the clubhead.

As noted earlier in this specification, for typical players at all skill levels, the greater part of positive downswing joint energy is generated by quite a small number of joints. This information can assist in formulating a more time-effective and cost-effective plan. Typical values for combinations of the major joints are as follows. The right hip joint alone accounts for about 19.5%. Right hip and left hip account for about 36.6%. Right hip, left hip and left knee, account for around 52.3%. Right hip, left hip, left knee and thorax account for about 62.3%. Right hip, left hip, left knee, thorax and lumbar account for around 71.0%. Right hip, left hip, left knee, thorax, lumbar and right shoulder account for about 79.2%.

6. Assessment Apparatus.

6.1 Overview.

In one set of examples of the invention, the assessment of the player's swing is made using measured kinematic parameters, ground-reaction forces (GRFs) and body segment inertial parameters (BSIPs). In each of the examples, a motion capture system measures the player's kinematic parameters during a set of swings. Force-plates simultaneously measure ground-reaction forces (GRFs). The player's body segment inertial parameters (BSIPs) are separately measured. The typical division of forces between the grip at the left and right hands is either separately measured, as are the inertial properties of the club, or values are taken from averages for comparable players or clubs. A processing means uses the measurements to calculate the kinetic parameters of the swing using inverse-dynamics, from which the unseen-parameters are determined. Systems which provide alternatives to inverse-dynamics are known in prior art and may also be used. They include forward dynamics and nonparametric regression and learning methods. The processing means also uses the measurements to calculate transmission-efficiency-parameters.

6.2 First Example of Assessment using Inverse-Dynamics.

6.2.1 Summary of First Example of Assessment.

The first example of assessment may be summarised as follows. The player is tested over a set of swings, using a motion capture system comprising an un-tethered set of inertial sensors, with one inertial sensor attached to the club and each of the player's principal body segments, and one or more depth sensors. The inertial sensors track the kinematic movements of the player and club over the downswing and into the early follow-through, and the depth sensors track the kinematic movements over the entire swing. Force-plates, under the player's feet, simultaneously track the player's GRFs during the downswing. The start and finish of the downswing are signalled by appropriate means, discussed later. Data from the depth sensors, inertial sensors and force-plates are synchronised and initialised at the start of the downswing. The depth sensor operates in real time and is provided with skeletal tracking software, modified to track a golf swing with particular emphasis on the top-of-backswing (TOB) event. The term ‘skeletal tracking’ is also sometimes referred to as ‘skeletal extraction’ or extraction of a jointed model of a human subject. The set of inertial sensors is un-tethered, that is to say it is not wire-connected to the stationary apparatus. The individual inertial sensors are of the miniature gyroscopic type and operate at very high capture rates. The typical division of forces between the grip at the left and right hands is either separately measured, as are the inertial properties of the club, or values are taken from averages for comparable players or clubs. Club properties may be determined by finite measurement analysis (FMA). Using the measured data from the depth sensor, inertial sensors, force-plates, measured BSIPs, and the data on grip-division-of forces and club inertial properties, the processing means uses inverse-dynamics to calculate the kinetic parameters of the downswing and from them calculates the required unseen-parameters.

Variants of the first example can also be used to measure more general kinematic and kinetic parameters of the golf swing.

6.2.2 Detailed Description of First Example of Assessment Apparatus.

6.2.2.1 Depth Sensor.

In the first example of assessment apparatus, a depth sensor is used to track the kinematic motion of the player over the entire course of the swing, from takeaway to end-of-follow-through, for a set of swings. The term ‘depth sensor’ includes sensors such as depth cameras or 3D cameras, and will be used in this context throughout the specification. The depth sensor operates in conjunction with software and processing capacity which is operable to extract a jointed segment model of a human subject from the captured image, commonly referred to as “skeletal-extraction”.

Depth sensing commonly operates using stereoscopic, time-of-flight or structured light systems. Frequently the depth dimension is used to distinguish the perimeters of objects, or division between objects, detected by the more conventional 2D camera image. Where skeletal-extraction software is used, it may compare the images to a large memorised library of “poses” seeking closest matches and identifies likely human body model segments in its images. Where a body segment is occluded or partly occluded, the system may use special algorithms to choose what it deems to be the most likely pose match for the occluded portions of the image. When all segments are identified, the software may then construct the jointed model of the player. In some proprietary systems, the selected closest-matches provide skeletal models with similar numbers of joints as used in inverse-dynamics calculations described in this specification. These joint positions are sometimes estimated by feeding the depth image data into a random forest decision algorithm, which compares the pixel positions to the database of comparison images.

Various problems may present themselves in attempting to capture a golf swing with a single depth sensor and skeletal-extraction software. Among these is the usually present occurrence of occlusion, where one part of the player's body obscures another, forcing the system to estimate the position of the occluded body part. In particular, where the depth sensor directly faces the player, the arms and hands obscure various parts of the body as they move through the swing. The player's upper body also turns through the swing, at first partly occluding one side of the upper body and then partly occluding the other side. Another problem relates to the difficulty for the system in distinguishing body parts which are close together or run parallel to each other. For example, the system can have difficulty in distinguishing the individual player's hands which are typically interlocked around the club grip, with wrists and adjacent portions of the lower arms moving closely together. A yet further problem relates to the lower accuracy in measuring depth as opposed to the outline or silhouette seen by the sensor, such that changes in position towards or away from the depth sensor are not measured as accurately as changes in position in other directions. An additional problem relates to typical capture rates and shutter speeds not being fast enough to adequately capture portions of the player and club in typical fast swings, in particular the club and to a lesser degree the hands and lower arms in the later stages of the downswing.

An aspect of the present invention is a realisation that these inexpensive, easy-to-use systems, despite these inadequacies, can be advantageously combined with other systems to measure a fast golf swing. Such combinations include the simultaneous use of inertial sensors over portions of the swing, which is discussed in further detail later in this specification. An additional aspect of the present invention is a realisation that the inadequacies of inexpensive depth sensor and skeletal-extraction systems in these matters can be mitigated without significantly increasing their cost or significantly diminishing their ease of use or set up. Various ways for dealing with these inadequacies shall now be described.

The capacity of typical proprietary skeletal extraction software encompasses a wide range of active scenarios and is necessarily much wider, deeper and more varied than is required for a standardised frontal or side view of a single human executing a golf swing. In the present invention, skeletal-extraction is modified during development to better suit tracking of the player in the golf swing in various ways, which include changes to the library of poses, changes to supporting software and changes to increase capture rate.

The modifications shall first be described for the simplest variant where there is a single motion capture depth sensor. In the modified library, poses are limited to a single view angle, such as a frontal view, of a single human character in the various phases of executing a golf swing. Particular emphasis is placed on the top-of-backswing (TOB) position and the movements immediately preceding and following it. The player model is made consistent with that used in the inverse-dynamics model, with the same joint and segment configurations. Ideally, players wear minimal or tight-fitting clothes, and hair restraining headwear where appropriate. The preparation of poses is simplified during its development by basing all on the more usual striking of the ball from right-to-left, and then either automatically generating during the development stage a further set of left-to-right poses by using a mirror image of the pose images, or by identifying and using a mirror image of the left-to-right captured image during end-use before comparing it to a library of right-to-left poses.

In a variation of the system, visual markers may be placed on the player, which move in unison with the most important segments or joints of the player visible in relevant views of the downswing. The markers are arranged to be readily detected by the depth sensor and are replicated in all images in the library of poses. The use of such markers can give two advantages. One potential advantage is a reduction in the need for minimal or tight clothing, because markers can be readily arranged to remain close to the player's segments throughout the movement, irrespective of the general tightness of clothing. The other potential advantage is that appropriately bright, fluorescent, reflective or otherwise more-easily detected markers can allow them be more accurately captured in high-speed movements at faster shutter speeds in poorer lighting conditions.

The system is also provided with additional supporting software which can assist in selecting, during end-use, the correct body model position when portions of the body are occluded.

Prior information on the typical or probable progression of the golf swing may also be advantageously used in the system's end-use selection of poses to match the sensor images. Such prior information includes the knowledge that the backswing sequence of captured images and the downswing to follow-through sequence of captured images are each largely a rotary movement of the arms, hands and club which are always in the same direction of rotation and that the speed of rotation of the hands and club usually change gradually as these rotation processes progress. Other parts of the body also tend to move in fairly typical gradual movements which progress through these processes. Such information is fused with the information from the sensor system allowing the most probably pose to be selected at each frame.

Prior information on the individual player being tested is also used by comparing the relative proportions of key skeletal dimensions in the pose to the known skeletal proportions of the player and using the results to help match the captured images in end-use to the most probable poses from the library. In particular, the player's skeletal proportions and joint interspacing can be used in this respect. This can improve accuracy in two ways. First, it matches the player's relative skeletal proportions to those in the pose. Second, it can help to determine correct segment depths where views are occluded and/or foreshortened. These techniques may be applied to the additional supporting software which assists in selecting the most probable poses in end-use, or it may be used to limit the set of poses made available to the system in the selection in end-use.

6.2.2.2 Capture Rate.

Within the available cost constraints, lens quality and depth sensor shutter speeds should be as high as possible. Low cost depth sensors are well capable of capturing the slower parts of the swing, including those parts close to TOB, in either outdoor or artificial light, but can produce blurred images with the faster parts of the swing in artificial light. So long as shutter speeds remain adequate for whatever parts of the swing are being captured, depth sensor frame rates should be increased as much as possible, and where economics and performance allow, sensors with higher frame rates should be chosen.

6.2.2.3 Variants with Multiple Synchronised Depth Sensors.

Additional synchronised depth sensors may also be positioned at other view-angles. For example, they may be positioned such that they view the player from the player's right side, with view-angles of about 45° and 90°. An additional depth sensor may also be positioned such that it views the player from the player's left side, with a view-angle of about 30°. In this latter instance, care must be taken to minimise the risk of the depth sensor being struck by the ball and to protect it with a guard in the event of collision. Additional depth sensors of this type can be used to obtain images where parts of the player or club are occluded in the frontal view but not in the additional view. It can also be used to obtain views which provide additional information for the processor, for example views with less foreshortening, or views which show better articulation of particular jointed segments.

In the present example, the swing is recorded by a depth sensor at each view-angle used in the coaching processes. It is advantageous to modify the library of poses used with each depth sensor to more accurately capture the golf swing at the view-angle which it uses. Where data from the depth sensor is used by a coaching system using the additional view-angles, the software modifications required to do this will already have been prepared during initial development for the coaching process and can be used without further significant cost in the initial development of the assessment process. In practice, it will be simplest to accommodate all view-angle poses in all of the depth sensors of the system and let the end-use pose selection process select the correct pose from the various sets. As previously mentioned, the number of poses required to accurately capture a single human executing a golf swing from a single view-angle is very small compared to the number required for general market use.

As will be seen later in this specification, some of the systems used in coaching employ different depth sensor view-angles and require assessment data obtained with the same view-angle as used in coaching. Data from such depth sensors can be used both to satisfy the coaching assessment requirements and to provide some or all of the other uses or advantages for assessment, mentioned above.

6.2.2.4 Body Segment Sensors. Inertial Sensors.

In the present first example of assessment apparatus, the apparatus comprises an additional sensor system which also tracks the movement of the player's segments. The addition of this system overcomes the problems of low capture rates and inaccuracy which would arise with sole use of depth sensors.

The additional sensor system comprises a set of inertial sensors which are non-wireless miniature MEMS (micro-electro-mechanical sensors) gyroscopic sensors, or MEMS combined gyroscopic and accelerometer sensors, one attached to each segment of the player model which adjoins a powered joint. The inertial sensors track changes in 3D angle. An inertial sensor is also attached to the upper region of the club-shaft. Where the inertial sensor is found to be sufficiently robust to withstand the shock of impact between the cub and ball, a second inertial sensor may be attached to the lower region of the club-shaft. The inertial sensors are arranged to measure angles at high capture rates. Typically, all body segments are measured at capture rates of approximately 250 Hz or more and club segments are measured at much higher rates, for example about 500 Hz to 1000 Hz. It will sometimes be found convenient to measure all segments at the higher capture rates and to later discard portions of those data streams which are not required, to keep the overall volume of data collection at more easily managed levels. The system is operable to detect the impact event with an accuracy effectively dictated by the highest capture rates, typically used for the club and hand segments, either through the downswing or in the very high-speed portion approaching impact. Various options for such detection are described in a later paragraph. The inertial sensors are automatically initialised and commence synchronised measurement and recording when automatically signalled by the system that TOB has occurred and automatically cease measurement and recording when the system determines the time point at which impact between the club and ball occurs, as discussed later. The changes in the magnitude of the resultant 3D angle at each joint and the time over which such changes occur, are determined by the changes in the included resultant 3D angles between each set of segments connected to the joint. The time-stamped results for all joints for each downswing are automatically wirelessly transmitted to the system either individually or in processed groups. The results are subsequently applied to the model, as recorded by the depth sensor at the point of TOB and initialisation, providing full kinematic movement of the entire model over the course of the downswing.

Particular attention is given to accurate determination of the timing and player's general model position at the TOB event by the depth sensor system, including provision of adequate numbers of poses to accommodate all TOB possibilities. Accurate capture of the TOB event by the depth sensors is facilitated by the slow and reversed movement of the club and player at TOB. Data from all of the depth sensors at the different view angles are meshed to provide the most accurate 3D position for the player model at TOB.

The inertial sensors are fitted to the player's segments by any of the many suitable means known in prior art, such as elasticated Velcro-connecting straps, pocketed gloves and lightweight pocketed shoulder-body harnesses. These assist in quick and accurate location of the sensors and connecting wires to the player and onboard controller.

The gyroscopes are of the type based on the Coriolis effect and are operable to measure up to about ±2000 degrees/second. Sensors of this type are manufactured in ever-increasing volumes at relatively low cost, with performance-to-cost rapidly improving year by year. MEMS sensors with gyroscope and accelerometer components generate smaller drift errors and greater stability and cost little more than those with gyroscopes alone. All other things being equal, these alternatives will usually have the relative advantage of generating smaller drift errors and having greater stability but may have the relative disadvantages of being more expensive, larger, heavier and requiring greater battery power. These relative advantages and disadvantages can change if a particular type finds large mass application elsewhere which can drive down its unit cost and improve its miniaturisation.

An important aspect of the invention relates to a realisation that because the downswing is of very short duration, typically about 0.3 seconds, significant drift errors do not arise with inertial sensors in the present application. A further important aspect relates to a realisation that TOB is a particularly suitable time to initialise the sensors due to, inter alia, slowness of movement at this part of the swing. An additional important aspect relates to a realisation that TOB is also a particularly suitable time to determine the 3D position of the player model using depth sensors due to slowness of movement at this part of the swing. A yet further important aspect of the invention relates to a realisation that the measured magnitude changes in angle are independent of the starting orientations and locations of the attached sensors at initialisation and therefore do not require calibration of the system or knowledge of such orientations or locations. This allows easy use of the system by non-specialised personnel. Unlike the inertial sensors of the invention, conventionally used inertial sensor systems need specialised personnel to operate and calibrate them.

The untethered sensor set may communicate with the system in different ways. At the current time of writing, suitable wearable wireless sensors have just become available on the market. They are very small, light in weight and are operable to individually communicate wirelessly with a stationary remote system, such as the apparatus processor, receiving the initialisation signal and returning data at collection speeds of about 500 Hz. These are technically suitable, but are currently not manufactured in large volumes and are therefore relatively expensive. It is expected that their cost will fairly shortly fall to acceptable cost levels as manufacturing volumes increase.

An alternative untethered sensor system, which is technically suitable and already available at low cost, comprises the following. Instead of communicating wirelessly and directly with the stationary base system of the apparatus, small lightweight sensors are individually wire connected to an ‘onboard’ controller attached to the player, most likely worn at his waist. This onboard controller synchronises and momentarily stores the high-speed signals from the wire-connected sensors and sends the partly processed results wirelessly to the stationary apparatus processor. This system can readily send initialisation signals to the individual sensors and collect data at the very high collection speeds required by the system.

The first described untethered sensor system has the significant relative advantages of being easier and quicker to fit on the player's segments and not having the encumbrance of wires connecting the sensors to an ‘onboard’ controller. The second described untethered sensor system has an immediate advantage in that its components are currently available at low cost. However, the former system will be preferred as soon as its components can be obtained at acceptable cost levels.

6.2.2.5 Measuring Impact.

Particular attention is required for measuring impact both because of its importance as a landmark in the downswing and because of the difficulties imposed by the very high clubhead speeds which occur at that point. Ideally, a measurement capture rate of around 500 Hz or better is used. There are various ways impact can be measured, each with potential relative advantages and disadvantages. In a first example, the system additionally comprises a fast-responding microphone system which is operable to detect and distinguish the sound of the club striking the ball. The software is arranged to limit detection, to the time range where impact is expected, to prevent accidental triggering by other sounds. The software also makes appropriate allowance for time delays from system responses and time for sound to travel to the microphone. In a second example, a high-capture rate inertial sensor is attached to the lower end of the club shaft, and the impact event is detected by changes in its output data where the clubhead experiences a rapid deceleration at impact. This requires an inertial sensor and fixing between sensor and club which are capable of withstanding the shock transmitted from the clubhead at this part of the club. Some inertial sensors are capable of withstanding the transmitted shock. Tests have indicated that the event is not readily detectible from the output data where the sensor is positioned higher up the club shaft.

6.2.2.6 Alignment of Force-Plates.

It is necessary to accurately align the reference frame of the force-plates with the reference frame shared by the depth sensor and set of inertial sensors. This can be done in several ways, two of which are described below.

In circumstances where the depth sensor is known to be of sufficient accuracy, a set of target markers are positioned in known positions on the force-plates in view of the depth sensor system. Position readings of the targets are then used to directly align the frame of reference of the force-plates with the frame of reference of the depth sensor system. The arrangement is simplified by ensuring that the depth sensors are always positioned at predetermined heights, distances and angles from the force-plates. When the inertial sensors are aligned with the depth sensor system at their initialisation at the top-of-backswing position, as previously described, they also will then be aligned with the frame of reference of the force-plates.

Where the depth sensor system is not of sufficient accuracy to directly align its frame of reference to that of the force-plates, the alignment is carried out by the player following instructions to position his feet against specially-provided markings on the surfaces of the force-plates at the address position. The markings may comprise several pairs of markings in different colours and outlines to accommodate different player address stance dimensions. The markings guide the player to position each foot an equal distance from the horizontal centre line between the two force-plates and at equal distances from the front line of the set of force-plates. When the system senses that the backswing is under way, it initialises the inertial sensors on the feet and then reinitialises them at the top-of-backswing position, the latter initialisation occurring when aligning the depth sensor system and inertial sensors as previously described. If the readings of the inertial sensors on the feet indicate that their positions have not changed between address and top-of-backswing, the system uses the top-of-backswing initialisation to align the frames of reference of the inertial sensors and force-plates. If movement has taken place, the frames are aligned with an appropriate adjustment to take account of the change in positions between address and top-of-backswing.

6.2.2.7 Grip-Division-of-Forces.

Indeterminacy arises in the inverse-dynamics calculations concerning the division of forces at the grip between the left and right arms, which cannot be solved from the kinematic and GRF measured data alone. As previously mentioned, the division can be determined in various ways. In one of these, the division typical to the player is measured in a separate activity, using apparatus which measures the division of forces from the player's grip to his left and right arms, comprising a partly divided grip on a club fitted with strain gauges. The arrangement determines the typical relative proportion of forces related to the grip at the left and right hands through the downswing. Apparatus of this type is described in prior art document WO2013/041444.

Grip division-of-forces may also be determined without direct measurement of the parameter. The determination is carried out with simpler apparatus, and reduced cost and skill requirements and can be used either for swing assessment or swing coaching. In one variant, the division is taken to be equal for each arm. In another variant, the division is taken to be that previously measured for other players, either as a fixed proportion to each arm throughout the downswing, or as varying proportions as the swing progresses through the downswing. The data may be matched to that of players similar to the subject player, based for example on a selection from downswing-handicap, gender, age and/or physique type. An artificial intelligence, such as an ANN, may be used to assist the matching process.

Alternatively, proportional values for the division, which have been separately determined for players comparable to the subject player, can be applied to the calculations. The division may also be roughly estimated by assuming equal forces between the left and right arms.

6.2.2.8 Club Characteristics.

Data is also obtained or measured concerning the inertial and flexural properties of the club used in the swing.

Ideally, the player will usually use his own clubs, as it has been found that a change of clubs can affect a player's performance. This is normally accommodated by assessing certain characteristics of the player's clubs. Clubhead weight and shaft length are easily measured and results inputted to the system apparatus. Shaft flexural type is usually one of a very limited number of types, which will be visually obvious, and easily selected for input to the system apparatus. Properties of the club face, including loft, are not relevant because measurement of clubhead speed, rather than ball speed, is used in the calculations of the present invention. Accordingly, the system can accommodate, without any adjustment, any clubface properties found in a player's own clubs. Movement measured by the system motion capture sensor for each swing provides the principal basis for dynamic inputs to the relevant equations. A system similar to this is described in prior art document WO2013/041444, although in this instance, players are tested with a limited variety of standard clubs rather than their own clubs.

6.2.2.9 Inverse-Dynamics, Kinetic and Unseen-Parameters.

The inverse-dynamics calculations use a player model comprising rigid jointed segments similar to or the same as the jointed models described earlier. Values are calculated for the more distal segments, in a direction from the club and head towards the pelvis, using the distal kinematic measurements collected over the course of the downswing, together with the grip-division-of-forces, club flexural and inertial measurements, and distal BSIP measurements. Values are calculated for the more proximal segments, from the feet towards the trunk or mid-upper trunk, using the proximal kinematic and GRF measurements, also collected over the course of the downswing, along with the proximal BSIP measurements. The measurement of BSIPs is described later in the specification.

An inverse-dynamics method is used to calculate the net forces and moments across the joints of the body system, necessary to produce the observed or measured motions of the joint. The calculations are carried out step-by-step through the chains of connected segments. Newton's equation of force, relating mass and linear acceleration, is used to derive linear accelerations of the centres-of-mass, and Euler's equation relating moment of inertia and angular acceleration, is used to derive angular accelerations about the centres-of-mass. Apart from forces due to air drag and gravity, the net sum of applied forces and moments at the distal end of the club and at the end of the head are zero, because the distal end moves without external constraint. However, air drag forces are significant for club segments because of their relatively high speeds, and are appropriately accounted. Air drag forces are relatively insignificant for most segments of the player's body and in most cases, need not be accounted. Where a high degree of accuracy is required, allowance may advantageously be made for air drag forces on the hands and arms, particularly the lower arms. Gravity forces, readily calculated from the BSIP data, are accounted in all segments throughout the downswing. Forces between the feet and ground are given by the GRF measurements.

The segment-by-segment calculations usually terminate at the lumbar and thorax joints, ideally with calculations being made from both directions at each of these joints, such that values from proximal-to-distal and distal-to-proximal are obtained at both joints. The lumbar joint is positioned between the pelvis and middle trunk segments and the thorax joint is positioned between the mid-upper trunk and middle trunk segments. For a particular type of apparatus, the values used in the inverse-dynamics calculations at the lumbar and thorax joints can be decided by choosing that which is expected to be more accurate and reliable in the distal-to-proximal or proximal-to-distal calculations. In tests with one type of apparatus, it was found that distal-to-proximal calculations were better for the thorax joint and proximal-to-distal calculations were better for the lumbar joint.

Programmed software and a processing means calculate the player's unseen-parameters and other relevant parameters from the kinematic parameters and calculated kinetic parameters. A coaching plan is subsequently formulated from the calculated unseen-parameters and other relevant parameters. The same processing means may be used to carry out the inverse-dynamics computations, unseen-parameter calculations and formulation of the coaching plan.

Reference is now made to FIG. 3 which shows a perspective view of the player and first example of assessment apparatus. The inertial sensors are of the wireless type. The player is depicted executing a swing with a driver club. The playing mat and force-plates are shown recessed into the floor and have upper surfaces at floor level. The following is an index of the reference numerals used in the figures.
1 Player.
2 Playing mat.
3 Ball in tee or starting position.
4 Inertial sensor.
5 Inertial sensor strap or harness.
8 Combined depth sensor and base controller.
10 Computer or monitor.
14 Left foot force-plate.
15 Right foot force-plate.

Reference is additionally made to FIG. 11 which shows a flow chart which depicts the principle steps typically involved in the first example of assessment, as described above. These steps may be briefly described as follows. During the swing, inertial sensors on the player's body segments and club measure changes in segment and club orientation angles. A depth sensor or high-speed camera and processor determine the static 3D positions of the player and club model at TOB. The kinematic parameters of the downswing are calculated with a processor from these inertial sensor and depth sensor or HSC measurements. The player's GRFs during the swing are measured using force plates. The player's BSIPs are determined beforehand using a depth sensor or using an ANN and inputs of easily-obtained player data. The player's grip division-of-forces are also determined beforehand using an ANN and inputs of easily-obtained player data. Impact timing is measured during the swing with a microphone. Clubhead speed is measured during the swing using the inertial sensor measurements or measurement by a separate speed measurement means. The player's kinetic parameters of the downswing are calculated with a processor using inverse dynamics, together with the measured or determined values of kinematic parameters, GRFs, BSIPs and grip division-of-forces. Transmission efficiency is calculated with a processor using measured clubhead speed and the calculated kinetic parameters.

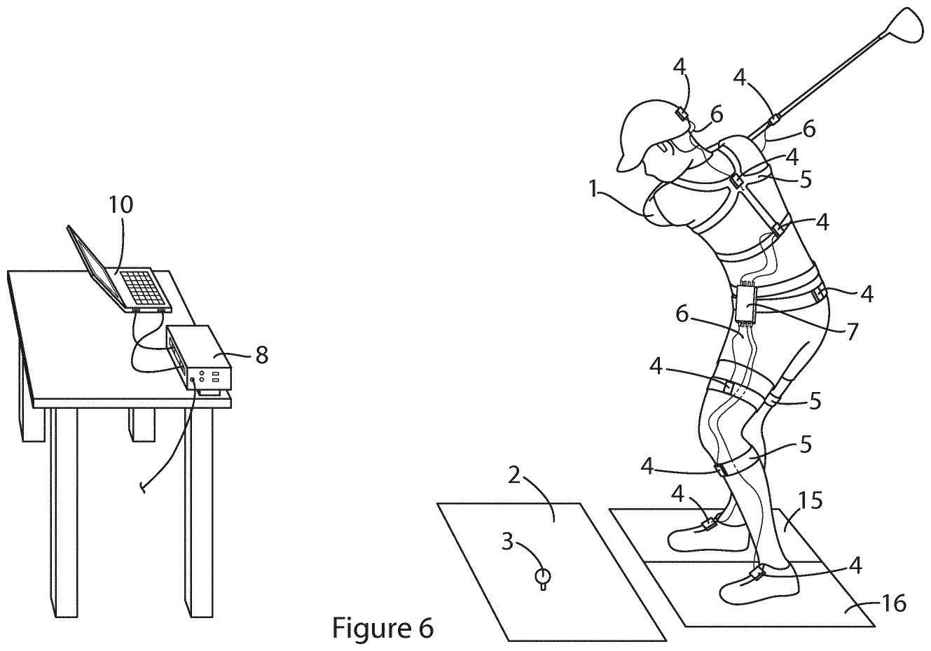

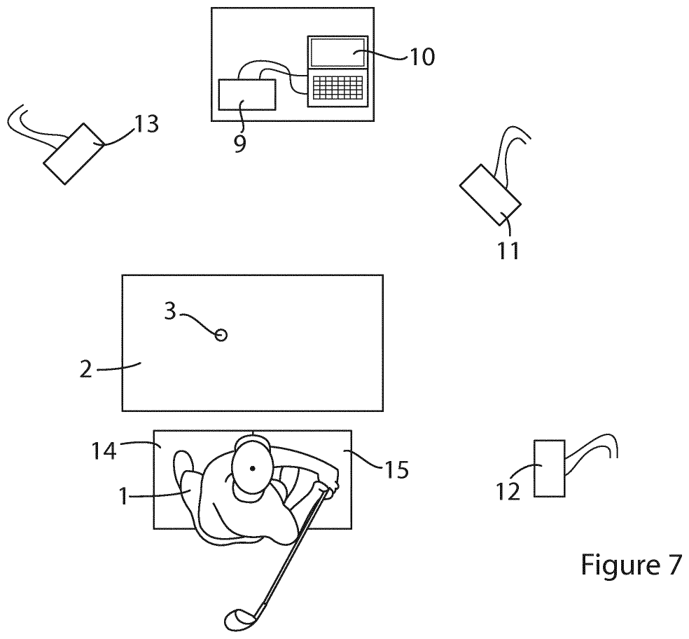

Reference is also made to FIGS. 6 and 7. FIG. 6 shows a similar view to FIG. 3. However, in this instance the inertial sensors are wired to an onboard controller mounted on the player, which in turn is wirelessly connected to the base controller. FIG. 7 shows a perspective and plan view, respectively, of the player and first example of assessment apparatus, which in this instance is in a format suitable for use with coaching apparatus which additionally requires depth sensor or HSC records at frontal, 45° clockwise, 90° clockwise and 45° counter clockwise view-angles. To simplify the figures, FIG. 7 shows only one depth sensor, omitting any which do not directly face the player and FIG. 8 omits the inertial sensors attached to the player and club. It also omits the supporting stands and connecting wires for the three depth sensors which do not directly face the player.

The following is an index of the reference numerals used in FIGS. 7 and 8.
1 Player.
2 Playing mat.
3 Ball in tee or starting position.
4 Inertial sensor.
5 Inertial sensor strap or harness.
6 Inertial sensor connection wire.
7 Onboard controller.
8 Combined depth sensor and base controller with frontal view-angle.
10 Computer or monitor.
11 Combined depth sensor and base controller, view-angle 45° clockwise.
12 Combined depth sensor and base controller, view-angle 90° clockwise.
13 Combined depth sensor and base controller, view-angle 45° counter clockwise.
14 Left foot force-plate.
15 Right foot force-plate.

6.2.2.10 User Interface.

A proprietary portable computer, linked wirelessly or by wire to the system base controller, can be used as a convenient and flexible user interface both for assessment and coaching apparatus. The screen and keyboard can be used for general communication between the user and system. The screen and speaker can be used to communicate feedback and instruction or aspects of feedback and instruction. FIGS. 3-7 depict a portable computer linked to the system base controller.

6.2.3 First Example of Assessment Apparatus applied to the Complete Swing.

The first example of assessment apparatus, as described above, measures and assesses the downswing with high accuracy, including calculation of kinetic parameters and unseen-parameters. Other parts of the swing are measured at a lower level of accuracy and without determination of kinetic parameters.

Where required, the first example can be modified to also measure and assess other portions of the swing with high accuracy and with calculation of kinetic parameters. This is achieved in the following manner.

In this instance, greater attention is also given to increasing the number and accuracy of depth sensor poses which identify the take-away and end-of-follow-though events in the swing. The depth sensor identifies the commencement of takeaway and backswing and initialises the inertial sensors and force-plates at that point. Accurate identification of this event is readily achieved since the movement is relatively slow and the initial sequence of poses is easily identified. Backswing inertial sensor data and GRF data are collected and recorded by the system. The depth sensor system re-initialises the inertial sensors and force-plates at the TOB event, as previously described, and from that point downswing inertial sensor and GRF data are measured and recorded, again as previously described. The impact event is identified and recorded by one of the systems previously described. Inertial sensor and GRF data continue to be measured and recorded from impact through to the end-of-follow-through event. The end-of-follow-through event, when player and club motion stop or significantly slow down, is identified by the depth sensor system. Accurate identification of this event is readily achieved since the movement is relatively slow and this final sequence of poses is again easily identified. Inertial sensor data and GRF data are similarly collected and recorded by the system.

As previously mentioned, inertial sensor information accumulates drift error disproportionately with increasing elapsed time. In the relatively unobtrusive, low-cost inertial sensor format proposed in the present invention, drift errors can start to become significant even over periods in the order of one to two seconds. The depth sensor system can identify the position of the player with reasonable accuracy when motion is slow or stopped at the take-away, TOB and end-of-follow-through events, but not at the high-speed impact event. Where the system is properly designed, significant drift error will not occur within the very brief downswing, which has a typical time duration of about 0.30 seconds. Errors can start to become significant with time durations which occur in the backswing, which is typically three times as long as the downswing, and follow-through, which is usually about twice the duration of the downswing. These errors can be largely eliminated in the following manner.

In the backswing, the angular positions of the model of the player are taken to commence from that measured at take-away or start of backswing by the depth sensor system. The changes in angle measured by the inertial sensors will then give one set of angle positions right up to the TOB event. A second set of model angle positions are obtained from the depth sensor system at the TOB event, which can then be worked backwards to the takeaway event using the measured changes in angle from the inertial sensors in reverse. The angular position determined for the position which is time-wise half way between takeaway and TOB should be roughly equal, and where it is not equal an average value can be taken. The time taken for this movement, from either direction, is about one and a half times that of the downswing, which is short enough to avoid significant drift errors. In the follow-through, a similar approach is adopted, although in this instance there is no depth sensor measurement available of the angular values at the impact event. Instead, the angular values in the forward direction are taken from the initialisation at the TOB event. The angular values in the reverse direction are taken from a point near the end of follow-through when the motion is slow enough to give a reasonably accurate depth sensor system reading. A mid position time-wise is then used to divide the follow-through into two portions with forward calculations from the impact event and backwards portions from the end-of-follow-through event, or when the above-mentioned depth sensor reading was taken. The values across the follow-through are then determined in a similar manner to that described for the backswing. Inverse-dynamics calculations can then be run for all of these values to provide the kinematic values, from which the kinetic values and unseen-parameter values can be calculated.

6.3 Second Example of Assessment Apparatus.

The second example of assessment apparatus using inverse-dynamics is similar to the first example except the portion of the apparatus for measuring kinematic parameters comprises a proprietary tethered magnetic motion capture system, instead of the un-tethered system using a depth sensor and set of inertial sensors, described in the first example. By tethered is meant that the sensors are wired, via an umbilical-like cable, from the player to a stationary base controller. A similar system operation and apparatus of this type is described in prior art document WO2013/041444.

Typical magnetic motion-capture systems, such as the Polhemus Liberty™ system, track the 3D positions and orientations of wired sensors attached to the player's segments in a magnetic reference field at a capture rate of 240 Hz. They require calibration and the attendance of skilled personnel when players are tested. While such systems have many advantages over optical systems, they have a disadvantage in that they can be subject to data capture distortion from surrounding metal materials, particularly ferrous materials. Potential problems can arise from metal beams or reinforcing in buildings or structures, and from metal present in force-plates or club shafts. The system described in WO2013/041444 teaches that it is not necessary to provide sensors on all segments being tracked, and twelve sensors are used with a 14-powered-joint player body model. Sensors are attached at the upper rear region of the left lower leg, rear of the left upper leg, upper rear region of the right lower leg, rear of the right upper leg, one side of the pelvis, rear of the middle trunk close to vertebra position T12, rear of the mid-upper trunk close to vertebra position T8, rear of the left upper arm, rear of the right upper arm, back of the left hand, back of the right hand and at the side of the player's head. Some of these positions are chosen to suit the position of the trailing umbilical set of cables. An additional sensor is attached at the front upper part of the club shaft below the hand grip of the club. Each lower arm is tracked by the hand sensor tracking the wrist joint and the upper arm sensor tracking the elbow joint. The overall movement of the lower arm segment is estimated by appropriate software algorithms based on knowledge of typical lower arm movement following the positions and orientations of the wrist and elbow joints. This algorithm takes account of the characteristic of the lower arm whereby simple rotation about its long axis does not occur about the elbow, but a more complex form of rotation occurs about a region significantly further along the lower arm. With the types of suitable magnetic sensors currently available, omitting lower arm sensors has the advantage of reducing cost, complexity and encumbrance of the player by additional sensors and wires on these relatively fast-moving segments.

6.3.1 Variants on the Second Example of Assessment Apparatus.

Other types of motion-capture, known in prior art, can also be used, including high-speed optical motion-capture and wireless magnetic motion-capture. Magnetic motion-capture has an advantage over high-speed optical motion-capture in that it does not suffer from occlusion or cross-over, which usually necessitate subsequent manual clean-up of the data. Manual clean-up is expensive, causes delays and prevents real-time operation. Capital costs of optical systems are also usually higher. However, optical systems have the relative advantages of being un-tethered and less cumbersome for the player. They are also capable of higher capture rates.

6.3.2 Comparison of the First and Second Examples of Assessment Apparatus.

The first example of assessment apparatus, using inertial sensors and depth sensors, has several important relative advantages over all of the second examples of assessment apparatus using proprietary magnetic or proprietary optical motion capture systems. Its capital costs are significantly lower. It is much simpler to set up and operate and does not require calibration by skilled technical personnel or the attendance of skilled technical personnel when players are tested. It also has additional specific advantages over systems using magnetic motion capture. It avoids the encumbrance to the player of the connecting wires tethered to the stationary system. It also avoids the problems of interference to sensor signals from surrounding metal and avoids the computational potentially-delaying workload of magnetic distortion correction and errors arising from incorrect magnetic distortion correction. In addition, because it is unaffected by adjacent metal, sensors can be fitted to the feet, thus allowing measurement of energy generated at the ankle and foot joints.

6.4 Third Example of Assessment Apparatus, without Depth Sensor.

A variant of the first example of assessment apparatus using inverse-dynamics and body segment sensors, omits the depth sensor which measures the set of absolute positions of body and club segments at TOB.

Inverse-dynamics calculations include the ever-changing gravitational forces on the body and club segments through the downswing. The gravitational forces can be determined if the relative changes in 3D joint angle are known together with the relevant BSIPs, time of impact and at least one set of absolute positions of body and club segments at any instant in the downswing. The relative changes in 3D joint angle, relevant BSIPs and time of impact are determined as explained in the first example. The set of absolute positions of body and club segments are determined as follows, as these are no longer being determined by a depth sensor.

From the body segment and club sensor measured results, the timing of the TOB event is determined by tracking the angular movements backwards from impact to the point where typical TOB stopping or reversals of angles occur. An artificial intelligence, such as an artificial neural network (ANN) is then used to predict the absolute positions of body and club segments at one or more points in the downswing, typically at TOB or impact, or both. For simplicity, throughout the specification, an ANN or related set of ANNs may both be referred to in the singular, ANN. Where an ANN is used, the inputs to the ANN include details of the angular changes measured by the inertial sensors between TOB and impact and relevant details of the player and club model geometry/BSIPs. Details of such angular changes may simply comprise the magnitude of the angular change at each joint between TOB and impact. The ANN is trained using a database of swings from a large number of players, with training inputs of the particular database swing/player corresponding to those in the end-use ANN. The training outputs are the absolute positions of body and club segments at TOB and/or impact of the particular database swing/player. In preparing the database, the absolute positions of body and club segments of database swings/players is obtained using any suitable motion capture means, including prior art means such as magnetic motion capture.

The absolute positions at TOB or impact, or an amalgam of both, are then used to determine the absolute positions of body and club segments throughout the swing. Where an amalgam is used, the TOB predicted positions may be preferentially used to determine the earlier positions of the downswing and the impact predicted positions preferentially used to determine the later positions of the downswing, with a gradual blend between the two over other parts of the downswing.

6.5 Use of a High-Speed Camera in place of a Depth Sensor.

As already mentioned, proprietary depth sensors usually comprise at least one camera which is operable to capture 2D images. However, these cameras are sometimes not suitable for capturing high-speed movements, of the type found in the golf downswing, in artificial light conditions without some significant blurring of the image. High-speed cameras with high quality lens and high shutter speeds can capture such images without significant blurring. Although it is possible to incorporate high-speed cameras in depth sensors, for various reasons, where downswing motion is being captured, it will sometimes be economically preferable to use a high-speed camera with suitable software instead of a depth sensor, the more accurate 2D image being preferable to a blurred 3D image. The loss of 3D can be partly compensated by judicious design and arrangement of markers fitted to the player's body segments and club, duplicated in the software library of poses to which each captured image frame is matched. Also, where accurate images are captured, particularly where markers are used, relative distances between marker points, or lengths of segments, captured in images, can be used to estimate the orientation of the segment in the third dimension from the 2D image, by comparison to the known distance or length it would be when viewed orthogonally. The substitution of a high-speed camera is more suited to movement capture than to slow or static position capture, such as capturing a player's near-stationary position at TOB, although it can be used to do this. At various points in this specification, where an application is described using a depth sensor, it should be understood that the depth sensor may also be substituted by a high-speed camera, which may be referred to by its acronym HSC.

6.6 BSIP Measurement, Apparatus and Method.

Values for body segment inertial parameters (BSIPs) are required in inverse-dynamics calculations. They define the 3D inertial properties of the segment, including centres-of-mass location and principal moments of inertia about each joint connecting it to the player model, within a local segment frame of reference. They also include distance between joints in a segment within that frame of reference. Although they are usually treated as fixed values in inverse-dynamics calculations, in the present invention they may sometimes assume variable values as will be explained later.

6.6.1 First Example of BSIP Measurement, Apparatus and Method.

6.6.1.1 Summary of First Example of BSIP-Measurement.

A first example of BSIP measurement may be summarised as follows. The player's BSIPs are measured using one or a set of depth sensors or HSCs, together with skeletal tracking software, modified to accurately determine the player's segment volumes and joint positions, relative to the segments, in predetermined static poses. A processing means calculates the BSIPs from these measurements. Its software is modified during development in a manner which is different to that used to track the player's kinematic movements.

Where a depth camera is used in this context, it is one which can sense a 3D image of the player and player segments without the need for manual palpation of the player or the provision of an electromagnetic field, as was described in prior art document WO2013/041444. Where a HSC is used in this context, it is one which operates with software to capture images and 3D information on the player and player segments, in real time and without manual clean up data, unlike the high-speed camera motion capture system also described in WO2013/041444.

6.6.1.2 General Description.

The first example of BSIP measurement shall firstly be described in its simplest application, where a single depth sensor, together with skeletal-extraction software, is used.

In summary, the skeletal-extraction software is modified during development to better suit the determination of BSIPs. In end-use, the player stands in a series of stationary poses at a fixed distance from the depth sensor, wearing types of clothing and background which are best suited for accurate depth measurement and outline recognition. These clothing requirements are more stringent that those required for assessment. The player's clothing is typically minimal, close-fitting and light in colour. Where relevant, the player's hair is restrained by suitable headwear. Orientations of limbs are specified at each pose. A depth image is captured at each pose. The player follows a set of instructions, which may be given automatically by the system or read from a display screen or instruction document by the player. Alternatively, some or all of the instructions may be given by an instructor. Throughout this specification, the terms ‘development’ and ‘end-use’ refer to initial product development and subsequent mass-produced end-use, respectively.

The poses used in the skeletal-extraction software are selected in development to identify individual segments, perimeter outlines of the segments, 3D surfaces of the segments and joint positions relative to the segments and in some cases joint positions relative to each other. The player stands in different poses at different orientations to the depth sensor, for example facing it and at 90 o, 180 o and 270 o to the facing position. The poses will typically include standing views with minimal occlusion, including ones with arms and legs held straight; ones with arms positioned with different angles between the trunk and upper arms, upper arms and lower arms, lower arms and wrists; with legs positioned with different angles between the upper legs and trunk, upper legs and lower legs, lower legs and feet; and with arms and legs held straight but separated away from contact with other segments. The depth sensor and system are arranged to detect if the captured poses conform to the instructions given to the player, and if not instruct the player to repeat the pose until a pose image of a correct category is obtained. For example, if the instruction is for a player to raise his right arm in a frontal view, the system would expect any one of the many raised-right-arm-in-frontal-view pose images to be detected, and if one of this category is not detected, the pose is rejected and the player re-instructed to assume the pose correctly. In end-use, fixtures may be provided to support raised legs or arms. The poses should also ensure that views are obtained of torso sides and inside surfaces of arms and legs, which are normally occluded in many standing positions. The resulting end-use captured images will usually include front, rear, left-side and right-side 3D views of all segments. The system does not assume exact symmetry between left and right sides of the body because there are small differences, and these small differences can become significant in calculated moments of inertia where linear values are magnified to the third or fourth power. The captured images contribute to identifying the various segments' identities, and the most likely values for their orientations, outlines, 3D surfaces, and joint positions. Since each segment will have been captured in many or most of the captured images, a set of likely values are obtained for each parameter of interest. Predefined weightings are applied to these values where there is reason to give more weighting to one over another. For example, joint positions in certain orientations are often better defined where a limb is bent at the joint than when it is straight. The outline of a particular segment surface, seen in a profile view, will usually provide a more accurate value for the region adjacent the segment outline, because of the higher inherent accuracy of the component 2D camera over the component depth camera. Poses at different angles to the segment allow an accurate map of the segment surface to be built up using this outline data.

In end-use, each segment image will have a known 3D local frame of reference including joint positions and one or more reference axes between the joint positions. Depending on the operating system used in skeletal-extraction, joint positions, which may partly be obtained as weighted averages of multiple captured pose images, may be established first. The perimeter outlines in different orthogonal views may then be established. The outlines are relative to the frames of reference and in some cases establish, in 2D, the points furthest from the long axis of the segment, although the 3D position of these points is not defined by them alone. Next, the average weighted depth surfaces are temporarily fitted to the frames of reference. In each orthogonal view about a long axis, the depth surfaces may then be forced to mesh with the established perimeters, pulling or pushing the entire temporary surface proportionately in or out. For simplicity, divisions between adjacent segments will usually comprise fixed planes which most closely approximate to the typical movement of the joint in the downswing and in most cases pass through the identified joint. The angles of the fixed planes may be set, relative to the model, in those planes indicated by the dashed lines in FIG. 1(a), 1(b) or 1(c), but appropriately adjusted to the particular pose.

In end-use, the captured information is geometrically scaled by any one of several methods. For example, the apparatus may obtain information on a dimension of an object positioned in the same field of view of the depth sensor system as other captured images and the processor may automatically determine the scale of other captured images in the same field of view by comparison to the scaled object. The object in the field of view may, be a fixed scaled target, such as a vertical scale or a dimension of the player or the club, where the dimension is separately determined and made available to the processor means. Such dimensions may include the player's height, a distance between pairs of body joints or the club length as seen in 2D in particular poses. The player model is made consistent with that used in the assessment motion capture and the inverse-dynamics model, with the same joint and segment configurations.

A software algorithm meshes the available captured information for each segment, determining its 3D surface and joint positions. The mass distribution of the segment is found by applying appropriate densities to the volume enclosed by the 3D surface. The algorithm also estimates an allowance for clothing thickness, based on predetermined adjustment factors. Accuracy may also be improved by appropriately adjusting segment parameters based on a comparison of the player's overall mass with the sum of the calculated masses of all the player's segments. The player's mass or weight is readily determined with an accurate weighing scales and adjustment made within the calculation software relative to the calculated segment masses. The player shall also have his height separately measured by methods well known in prior art.

Ideally, when the player's weight is measured, his body mass index, or BMI, is also measured, using readily available and inexpensive methods well known in prior art. His BMI is used to appropriately adjust the applied segment densities, since on average muscle tissue is known to be about 15% to 20% denser than fat tissue.

Information on the distance between certain sets of joints in particular predefined poses is also obtained from the captured images, and may be used to adjust the BSIPs of the final assembled model of jointed segments. Such sets include the distances between: the left shoulder joint and right shoulder joint; the neck joint and lumbar joint; the left hip joint and left ankle joint; the right hip joint and right ankle joint; the left shoulder joint and left wrist joint; and the right shoulder joint and right wrist joint. Changes in distance between these joint sets can provide useful indications of angular changes between the segments lying between the joints.

All of the segment's relevant BSIPs are readily calculated from these various calculated and adjusted values.

In end-use, for each segment, the mass, centre-of-mass location and principal moments of inertia are calculated by assuming a uniform density across each segment and applying appropriate specific density estimates, such as the following, appropriately adjusted for body mass index (BMI) as already described, to the volumes of each of these segments. Values of 1190 kg/m3 and 1050 kg/m3 are applied to the lower and upper leg segments. Values of 1130 kg/m3 and 1070 kg/m3 are applied to the lower and upper arm segments. Values of 1160 kg/m3 are applied to the hands and feet segments. Values of 1110 kg/m3 are applied to the head, middle trunk and pelvis segments. Values of 920 kg/m3 are applied to the upper trunk segments.

The BSIPs of the middle trunk segment tend to be far more variable than other segments, in that the middle trunk centre-of-mass changes significantly when the player changes from an upright position, to a position leaning forward in the swing, with the extreme forward position typically occurring around the time of impact. The change in centre-of-mass is partly due to the compression of the relatively flexible middle trunk segment as the player bends forward, curving the spine, with trunk mass being prevented or inhibited from expanding to the rear due to being partly contained by the spine. The change in centre-of-mass is also due to the effects of gravity as the player leans forward and centrifugal force as the player rotates in the swing. This change in centre-of-mass can be accommodated in the present example by taking one or more additional sets of BSIP measurements during development with the player in a typical leaning-forward position, such as the player's normal address position with a driver club. In end-use, additional centre-of-mass positions are calculated from these measurements and the system processor automatically varies the middle trunk centre-of-mass positions using a routine written into the software, varying with swing angle. In an alternative simpler but less accurate arrangement, the centre-of-mass from a single appropriate leaning-forward position, or from an appropriate compromise between the upright and leaning-forward positions, is used and applied to all positions through the swing.

6.6.1.3 Variations of First Example of BSIP Measurement.

In a variation of the first example of BSIP measurement, instead of building up the model of the player from the various measured and calculated segments, the system starts with one or more complete BSIP models of a player and then adjusts the most appropriate model as information is obtained from measurements and calculations.

In another variation, to improve the accuracy of depth capture, two or more depth sensors may be used, taking care to avoid interference between them. The depth sensors are positioned at different levels, with one directly above the other, each simultaneously capturing overlapping images of segments which are positioned at different levels. The resulting reduced capture area per sensor allows the sensors to be closer to the player to give greater depth accuracy. In another variation, which has already been briefly described in the earlier summary example of the invention, four sets of depth sensors are provided; one orientated facing the player's front, another towards the rear, another towards the left side and one towards the right side. In this instance, the player does not turn during testing and images are captured simultaneously from each sensor set. The player may face a single monitor which provides automatic pose instruction. This system provides increased player convenience and faster testing, but requires greater floor area and capital cost. The added cost will usually be justified where there is a high turnover of players being measured.

6.6.2 Second Example of BSIP Measurement.

In a second example of BSIP measurement, a set of easily measured player parameters are obtained and the results inputted to an artificial intelligence which predicts all of the required BSIP parameters.

The inputted parameters may include, for example, the player's height; weight; sex; age; whether right-handed or left-handed; whether swinging from right-to-left or left-to-right; and several simply-obtained measurements which indicate the distribution of body weight. These weight distribution measurements may include height from ground to hip, circumferences of waist and chest, and maximum circumferences of upper and lower arm segments and upper and lower leg segments. The required apparatus comprises a weighing scales, height measuring device and measuring tape, together with software and shared use of the general system processor.

The artificial intelligence may comprise an artificial neural network (ANN) trained using data from a large, representative group of players, where the training inputs are the same parameter types as the inputs to the end-use ANN and the training outputs are the same parameter types as the prediction outputs of the end-use ANN.

6.6.3 Third Example of BSIP Measurement, Apparatus and Method.

A third example of a BSIP measurement system is disclosed in prior art document WO2013/041444. In this instance, the apparatus comprises a processor, specialised software and a magnetic motion capture system with a stylus sensor.

The shapes and volumes of body segments are calculated from predefined simplified geometric representations of the segments, defined by specific anthropometric measured landmarks on the segment boundaries, most segments having eight landmarks. In end-use, the player is fitted with magnetic sensors on his segments and stands in the magnetic field of the motion capture system. A trained technician palpates and measures the segments, one-at-a-time, following stepped instructions from the processor, by positioning and activating the stylus sensor against the landmarks. It doesn't matter if the player makes small movements of his segments while this palpation process takes place, because the readings are taken relative to the frame of reference of the segment sensor which moves with the segment. When measurement is completed, the processor calculates the positions of joints and volumes of segments. It applies appropriate densities to the segments and calculates the relevant moments of inertia.

In the prior art system, the system assumes symmetry between the player's left and right sides of the body, to reduce the number of required measurements. However, to increase accuracy, it is better to separately measure each side.

6.6.4 Comparison of First, Second and Third Examples of BSIP Measurement.

The first example of BSIP measurement, using one or more depth sensors or HSCs, has several important advantages over the third example of BSIP measurement, using a magnetic motion capture system. It is potentially far more accurate, partly because it is measuring actual segment surfaces rather than estimating them with simplified geometric representations, and partly because it does not involve a contact process which can deflect the natural positions of the anthropometric landmarks. It requires no physical contact with the player and thus allows more privacy for the player and greater opportunity to advantageously use more minimal clothing. It is also a great deal faster, both for the player and operator. It requires minimal operator skill, is likely to produce more consistent results and is capable of being made fully automatic. Its capital costs are also far lower where the magnetic motion capture system is not otherwise required.

The second example of BSIP measurement has the following advantages over the first and third examples. It is fastest in use, both for the player and operator. Its capital costs are easily the lowest and its equipment is the most robust and least demanding of space. Its level of accuracy and consistency lies between those of the first and third examples and is suitable for all coaching applications. However, a system similar to the first or second examples is required for training the artificial intelligence of the second example.

7. Coaching Apparatus.

7.1 Common Requirements for Coaching Apparatus.

As previously mentioned, the coaching stage method of the present invention typically involves a repeated process of the player executing a swing, and the swing being measured and assessed with fast, or seemingly near-instantaneous, feedback communicated to the player, allowing him use the feedback to improve the next swing.

In addition to monitoring progress on the unseen-parameters being coached, a check is also made for unplanned concomitant changes in other unseen-parameters, in particular subconscious and unwanted deterioration in other unseen-parameters. Feedback communication, related to the unseen-parameters being coached and to other unplanned concomitant changes, may be accompanied by further instruction, tailored to the player's performance.

To effect this method, the coaching stage comprises additional apparatus to provide fast feedback and may also comprise further apparatus to provide appropriate coaching instruction and general feedback. Such apparatus includes processing means and communication means, which may comprise audible, visual and/or written communication means. Instruction may be given on a visual screen, by printed instructions and/or by audible communication from a speaker or earphone. Fast feedback to the player or other involved parties will usually be automatically given by the apparatus. More general instruction and feedback may be given automatically or by an attendant coach.

Coaching equipment may also comprise individual PADJE movement suppression means. It may also comprise signalling means to signal the location of joints and associated muscle groups, or timing related to the activation of such muscle groups, as previously described.

The various comments concerning increasing accuracy in depth sensor or HSC and inertial sensor assessment apparatus, where relevant, should also be applied to coaching apparatus throughout the specification. In all or most instances, any improvements in customising depth sensor and skeletal-extraction software for assessment and BSIP-measurement measurement apparatus can be equally applied to coaching apparatus at little or no extra cost.

Several examples of coaching stage apparatus are described in following paragraphs.

7.2 First set of Examples of Coaching Apparatus. Utilising Inverse-dynamics.

In a first set of examples of coaching apparatus, the apparatus used for assessment may also be used for coaching provided it has means to provide fast feedback communication following a coached swing. It will usually not be necessary to re-measure BSIPs or grip-division-of-forces. Care should be taken to ensure that data processing is arranged such that inverse-dynamics calculations do not unduly delay feedback communication.

Conventional optical motion capture systems, where potential occlusions necessitate significant manual clean-up for certain movements or joints, usually cannot be used as coaching apparatus for parameters involving those joints.

Where a first example of coaching apparatus is being added as a feature to an assessment apparatus that continues to be required to carry out assessment, its additional unit-cost is relatively small.

Reference is again made to FIGS. 3 and 11 with respect to the coaching apparatus described above, with comments similar to those made previously.

7.3 Second set of Examples of Coaching Apparatus. Not utilising Inverse-dynamics.

In a second set of examples of coaching apparatus, the apparatus comprises sensor means and processing means and, in many respects, may be similar to the first set of examples of assessment apparatus, except that it does not comprise force-plates or use calculations using inverse-dynamics. The player's BSIPs and grip-division-of-forces are normally assumed not to have significantly changed and, unless there is reason to believe they may have appreciably changed, the values obtained during the previous assessment are used again.

These example apparatuses are usually much less expensive to purchase, set up and run that the first set of examples of assessment apparatus. They typically require very little technical expertise to set up, run or maintain. Because they do not require fixed apparatus such as force-plates, they require less floor space and are easily transported or stored away.

7.3.1 Variant where Sensor Means Comprise a Depth Sensor or HSC and Set of At Least Two Body Segment Sensors.

In a variant of this second set of examples of coaching apparatus, sensor means comprise a depth sensor or HSC and a set of sensors attached to the player's body segments. The set may comprise a reduced number of operational sensors which can be attached to and swapped around between different body segments. In the present variant, the sensors comprise inertial sensors, or it may comprise a complete set or near-complete set. Advantages from using a reduced number of operational sensors, than used in the first example of assessment apparatus, include reducing the cost of sensors and supporting apparatus, reducing the work involved in fitting sensors to the player, reducing inconvenience or encumbrance to the player, reducing battery use and reducing the amount of data measured, assessed and recorded. Where coaching involves one or more specifically identified PADJEs, the player may be fitted only with those sensors required for segments which are most closely related to the parameter or parameters being coached. The sensors and supporting apparatus are arranged such that they can be fitted to any of the segments of the player's body. For example, if unseen-parameters of the left elbow were being coached, the most significant changes are expected in the left arm. Where just two sensors are used, they would likely be located on the left lower arm and left upper arm. If three are used, they would likely be located on the left lower arm, left upper arm and middle upper trunk or left hand. Where coaching does not involve specifically identified PADJEs, but selection is left to the player's subconscious self-organising process, as many sensors as are available can be positioned on segments adjacent those joints which are judged most likely to increase their PADJE magnitude. Sensors may be swapped around between swings to locate the PADJEs which increase in magnitude.

Usually, one or more high-capture rate sensors are also fitted to the club shaft to accurately record the development of club shaft angle and club speed. The sensors may be of the same type for the club and body segments.

In a particular embodiment of this variant, the apparatus may be used to measure powered-angular-displacement and powered-angular-velocity of any of the joints of the player model. It may also be used to measure relative times of the start and termination of powered-angular-displacement and powered-angular-velocity. In addition, the determination of club speed at impact provides a measure of the overall quantity of energy generated and transmitted to the clubhead at impact. These various measurements are used to determine whether or not, and to what degree, the player is successfully increasing, or otherwise, the magnitude of the particular parameter during the coaching session. Appropriate results are communicated to the player as fast feedback between practice swings.

Data from the inertial sensors may be collected and processed in a manner similar to that described for the first example of assessment apparatus. Where a reduced number of sensors is used, processing is simplified by the reduced number of sensors and the use of simple kinematic parameters.

Tracking and recording the relatively slow and much less important portions of the swing are also carried out by the depth sensor to provide an overall visual record of the entire swing.

The present variant of the second set of examples, in the basic format described above, has the relative disadvantage, compared to the first set of examples, of being incapable of determining changes in many of the kinetic unseen-parameters, including torque, joint energy and joint power.

7.3.2 Variant Additionally Using Other Already-known Information.

A further variant of the second set of examples of coaching apparatus shall now be described which has very similar hardware apparatus to the first variant, and includes most of its basic features, but which additionally obtains relevant already-known information on the player's swing which permits it to produce a much more detailed and accurate assessment of the player's coaching performance.

In a particular embodiment of this variant, the already-know information comprises three categories of information, shown below and labelled A, B and C.
A—Already-known kinetic and kinematic measurements and calculated results, obtained in the player's previous assessment using inverse-dynamics.
B—Already-known kinematic measurements taken at the same time as the player's previous assessment but with apparatus and methods of equivalent type to those used in the coaching-stage.
C—Already-known general information on appropriate comparator values from swings by other players, indicating how, on-the-one-hand changes in kinetic and kinematic measurements of a player taken with assessment apparatus using inverse-dynamics, vary with, on-the-other-hand changes in kinematic measurements of the same player taken with apparatus of equivalent type to those used in the coaching-measurement-stage apparatus.

The reference in C to “equivalent-type” swings refers to swings being of similar type, for example, distance swings with driver clubs. Appropriate comparator values may also sometimes refer to swings measured on previous occasions by the subject player.

7.3.3 Variant using Already-known Information and Additionally using Artificial Intelligence.

In another variant of the second set of examples of coaching apparatus, the already-known information is combined with the newly measured coaching information using an algorithm or artificial intelligence such as an artificial neural network (ANN).

A particular embodiment of this variant, additionally using artificial intelligence, will now be described. In this embodiment, the assessment apparatus using inverse-dynamics comprises a depth sensor or HSC, a full set of inertial sensors, force-plates and other items as previously described for the first example of assessment apparatus. The coaching apparatus comprises a depth sensor and a reduced number of inertial sensors or a complete or near-complete number of inertial sensors. The algorithm or artificial intelligence comprises an ANN.

Where a reduced number of inertial sensors is used, and where the particular embodiment is required to determine, for example, the unseen-parameters of the player's left knee in the coaching stage, the inertial sensors may be positioned on the player's left lower leg, left upper leg and pelvis. Alternatively, they may be positioned on the player's left lower leg and left upper leg. Data recorded in the coaching test comprises the time-stamped kinematic records of these leg and pelvis inertial sensors, the starting position of the model at initialisation as determined by the depth sensor, the recorded times of TOB and impact events, and various relevant parameters calculated from this data. Already-known-information set A is taken from the relevant unseen-parameters, kinetic parameters and kinematic parameters determined earlier in the player's assessment stage. It may comprise averages of these values for the set of equivalent swings taken by the player in that stage. Already-known information set B is the set of kinematic parameters measured by the inertial sensors on the player's left lower leg, left upper leg and pelvis, also determined earlier in the player's assessment stage for the same swings by the subject player as those in information set A. Already-known information set C is contained in a trained ANN, specifically dedicated to predicting the required parameters, which in this specific example are the unseen-parameters of the left knee. The ANN is previously trained using a database of pairs of swings with appropriate comparator elements of swings by other players, with the information set A and set B from one swing, together with information set A from the second swing, all comprising the training inputs to the ANN and information set B of the second swing comprising the training output. Where the coaching system uses PADJE suppression means, such as those previously described, the database of swings used in training the ANN may additionally use swings where suppression means are used. Information on which joints are suppressed may also comprise further inputs to the ANN. When the trained ANN is used in the coaching stage, its inputs will be information sets A, B and data recorded in the coaching test, as defined earlier. Its predicated output will include the required unseen-parameters of the left knee in the measured coached swing. As will be explained later, the ANN may also predict other unseen-parameters.

Because the number of potential unseen-parameter, kinetic and kinematic parameter inputs is large, it can be advantageous to use smaller numbers of them for use in the ANN. Such reductions can assist the output accuracy of the ANN, reduce the amount of processing required, and reduce the processing hardware. Numbers of potential inputs can be reduced by using average values over the course of swings, or average values across a number of swings. Inputs relating to joints which are not directly included in the required outputs may be eliminated completely or greatly reduced in number. Optimum sets of inputs for various outputs can be fairly readily found by trial and error testing of data prediction on an existing database where the actual outputs are already known.

Database information required for training and testing a wide range of ANNs can be quite rapidly acquired from the normal operation of assessment-stage and coaching-stage apparatus of the invention as players are routinely tested.

In addition to predicting the magnitudes of individual PADJEs, the ANN may also be used to predict DRAPBs, DRAPEs, spans between DRAPBs and DRAPEs of individual PADJEs, and transmission-efficiency parameters.

This present third variant has a similar relatively low unit cost as the first and second variants, but requires a once-off development of its ANN system. Its capabilities are, however, far higher. It can determine or predict all of the kinetic unseen-parameters, including all of the measures of torque, joint energy and joint power and many of the complex interactions which occur across groups of joints.

Reference is made to FIG. 12 which shows a flow chart depicting a variant of the second set of examples of coaching apparatus, as described above, where inverse-dynamics are not used and which uses already available additional knowledge and an artificial intelligence comprising artificial neural networks. The principle steps typically include the following. During the swing, changes in segment and club orientation angles are measured by a full or partial set of inertial sensors on the player's body segments and club. A depth sensor or high-speed camera and processor determine the static 3D positions of the player and club model at TOB. Information is obtained beforehand on the player's kinetic and kinematic downswing characteristics, which was determined during previous measurements of swings by the player. Impact timing is measured during the swing with a microphone. Clubhead speed is measured using the inertial sensor measurements or measurement by a separate speed measurement means. Kinetic parameters of the player's downswing are determined by an ANN and processor, trained using information with swings by a large representative number of other players, with inputs from the inertial sensors, depth sensor or high-speed camera and processor, microphone, and speed measurement means. Transmission efficiency is calculated with a processor using measured clubhead speed and calculated kinetic parameters.

Reference is also made to FIG. 4 which shows a player and apparatus as described in the second set of examples of coaching apparatus. The player is depicted executing a swing with a driver club. In this instance the player is shown with inertial sensors fitted to all principal segments, but smaller numbers of inertial sensors may also be used and swapped between segments, similar to that shown in FIG. 5. The following is an index of the reference numerals used in the figure.
1 Player.
2 Playing mat.
3 Ball in tee or starting position.
4 Inertial sensor.
5 Inertial sensor strap or harness.
8 Combined depth sensor and base controller with frontal view-angle.
10 Computer or monitor.

7.4 Third set of Examples of Coaching Apparatus. With Simpler Use or Lower Cost.

A third set of examples of coaching apparatus includes abbreviated versions of the examples already given or embodiments which employ some of the features of earlier described examples. These embodiments generally better satisfy certain market segments, for example they may incur lower capital cost, lower operational cost or greater user-convenience. Usually this will compromise some aspects of accuracy or provide a product which assesses or coaches a smaller number of unseen-parameters. These examples of coaching apparatus may particularly suit players undertaking practice coaching of unseen-processes without direct human instruction, between more in-depth lessons with a professional golf coach using one of the earlier-described examples of coaching apparatus. They may also suit players who do not have access to professional coaches equipped to coach unseen-processes.

7.4.1 Variant using a Depth Sensor or HSC and ANN but without Body Segment Sensors.

In a variant of the third set of examples of coaching apparatus, which again uses already-known information, the method and apparatus is similar to the second set of examples above, except that it does not comprise body segment sensors, such as inertial sensors. Its ANN predicts the required parameters solely from depth sensor or high-speed camera (HSC) information and time of impact information on the coached swing, together with already-known additional information obtained from the player's assessment-stage results as well as general player information comprised in the trained ANNs.

Because of the higher reliance on depth sensor or HSC information, it is particularly important that additional care is given to customising the depth sensor or HSC and skeletal-extraction software to suit the golf downswing. In addition, the ANN must also be trained with a large representative set of depth sensor or HSC information, far more than is necessarily required in the previous examples. Where the coaching system uses PADJE suppression means, such as those previously described, the database of swings used in training the ANN may also use swings where suppression means are used. Where a system of this type is used, an assessment stage is required, with apparatus which includes depth sensors or HSCs.

Ideally, club and relevant player segments are fitted with visual markers which accentuate or identify the positions or orientations of the club and player segments. These markers are duplicated or effectively duplicated in poses or images used in the coaching apparatus and the assessment apparatus.

The system additionally uses a variety of depth sensor or HSC view angles for coaching different joints or different aspects of particular joints. By view angle is meant the angle between a frontal view of the player and the direct central line-of-sight from the depth sensor or HSC to the player, as seen in plan view. The view angle may be selected to give minimum occlusion and/or to better show the articulation of a joint by giving a better view of the angle between its connecting segments. Where this is done, an appropriate number of additional poses is added to the library of poses and ANNs are trained with these additional poses. As already mentioned, where this system is used, depth sensor or HSC data will also be required from the player's assessment measurement which has been collected with the same view angle as inputs to the coaching stage ANN. That is to say, where this system is used, depth sensor or HSC data is collected and recorded at the assessment stage at all view angles which can be potentially used at the coaching stage. Usually just a few view angles are used.

Before commencing the coaching session, the player is instructed by the system as to the view angle he is to assume. The system is arranged to recognise if the player has not adopted the correct view angle to the depth sensor or HSC, which is easily achieved by it noting whether or not poses are being selected by the skeletal-extraction software from the correct part of the library of poses.

The system also obtains an accurate synchronised measure of the time of impact between club and ball using a microphone system, which is wire-connected to the processor of the base controller, which is also wire-connected to the depth sensor or HSC. The microphone system is very similar to the system described earlier which measures the impact event which re-initialises or terminates the collection of data from the inertial sensors of previous examples. The cost of a mass-produced microphone system, housed within the base controller along with the processor, is relatively low.

An accurate measure of time of impact is important because the data collection rate of typical depth sensors is too low to give an accurate measure. The collection rate of HSCs is better and less critical in this respect. In addition to providing information on the position of the player at a critical time in the swing, it also allows an accurate determination of the duration of the downswing, which is calculated by subtracting its recorded time from that of TOB determined by the depth sensor or HSC. The TOB event is much less affected by the data collection rate, because several poses will be obtained leading up to and following the TOB event, allowing the processor to interpolate a relatively accurate time for the event itself.

This apparatus of the third set of examples has the particular advantage of having very low unit cost, being relatively trouble-free and being very easy to use. These advantages make the apparatus particularly suitable for coaching and practice without assistance from a human coach or technician, in venues such as a home-use or other non-golfing venue.

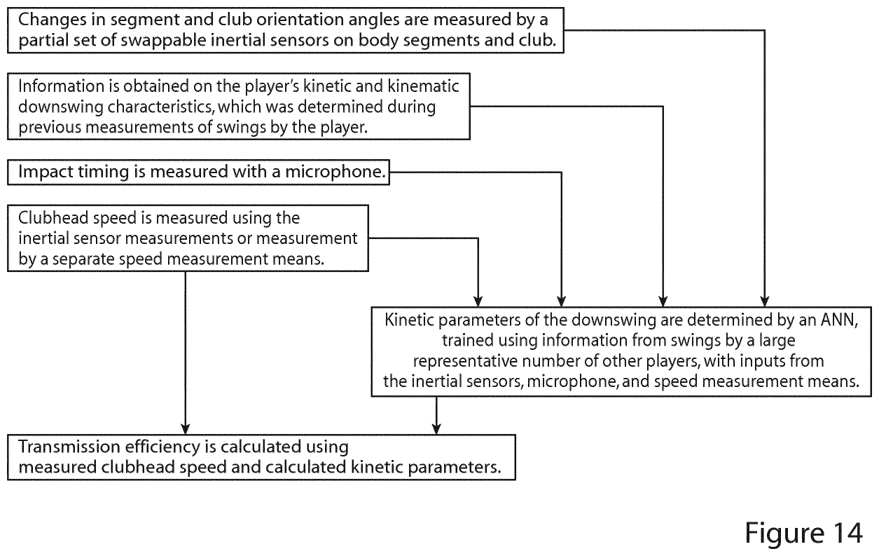

Reference is now made to FIG. 14 which is a flow chart showing a variant of the third set of examples of coaching apparatus, as described above where inverse-dynamics are not used and which uses already known information and an artificial intelligence comprising artificial neural networks. The flow chart shows the following steps. The player's kinematic downswing parameters are measured during the swing using one or two depth sensors, or high-speed cameras and a processor, which track the player's movements at high speed through the downswing. Where two depth sensors or high-speed cameras are used, they simultaneously track the player's movements, but at different view angles. The player and club are fitted with visual markers which accentuate or identify the positions or orientations of the player segments and the club. Information is obtained beforehand on the player's kinetic and kinematic downswing characteristics, which was determined during previous measurements of swings by the player. Impact timing is measured during the swing with a microphone. Clubhead speed is measured using speed measurement means. The player's downswing kinetic parameters are determined by a processor and ANN, trained using information using swings by a large representative number of other players, with inputs from the depth sensors or high-speed cameras and processor, microphone, and speed measurement means. A processor determines the player's transmission efficiency using the measured clubhead speed and calculated kinetic parameters.

7.4.2 Variant Using a Depth Sensor or HSC and ANN without Body Segment Sensors, but with Additional Clubhead Speed Measurement Means.

In a further variant of the third set of examples of coaching apparatus, the method and apparatus are similar to that previously described, except that it additionally comprises a clubhead speed measurement means. In this instance its ANN predicts the required parameters from depth sensor or HSC information, impact information and clubhead speed information on the coached swing, together with already-known additional information obtained from the player's assessment stage results as well as general player information comprised in the trained ANNs.

The assessment method and apparatus measure or otherwise obtain information on clubhead speed at the assessment which is comparable to that measured and used in the coaching process. This information is made available to the coaching apparatus along with the recorded depth sensor or HSC information taken at different view angles during assessment and impact information.

In its simplest format, the speed measurement means measures maximum clubhead speed and sends the value to the base controller. Maximum clubhead speed typically equals or almost equals clubhead speed at impact, which is related to clubhead total energy, which in turn is approximately proportional to total PADJE. It therefore provides a direct measure as to whether or not, and to what degree, PADJE has been added to or subtracted from a swing by a coached change. Needless to say, clubhead mass has a direct influence on the energy of the moving clubhead, and needs to be considered where a comparison is made between swings which use different clubs with heads of different mass.

Apparatuses for measuring clubhead speed are well known in prior art, with many radar versions selling at low prices. In operation, such devices are typically positioned with a view of the club as it moves to the impact position with the ball. Use of the maximum clubhead speed parameter does not require synchronisation with other apparatus of the swing. The time required for it to complete its computations, send its results to the base controller and have them inputted to the ANN is sufficiently short to allow fast feedback to be given to the player.

Where the clubhead speed device is synchronised with the depth sensor or HSC, the time of impact which typically closely coincides with maximum clubhead speed, can also be determined and inputted to an ANN, which is additionally trained to recognise its significance and assist in increasing the accuracy of predictions of unseen-parameters. Where the clubhead speed device is not synchronised with the depth sensor or HSC, time of impact may also be obtained by using a microphone system, similar to that described for a previous variant.

Other low-cost clubhead speed measurement means may also be used, including use of an inertial sensor attached to the club shaft, as discussed earlier with respect to other examples.

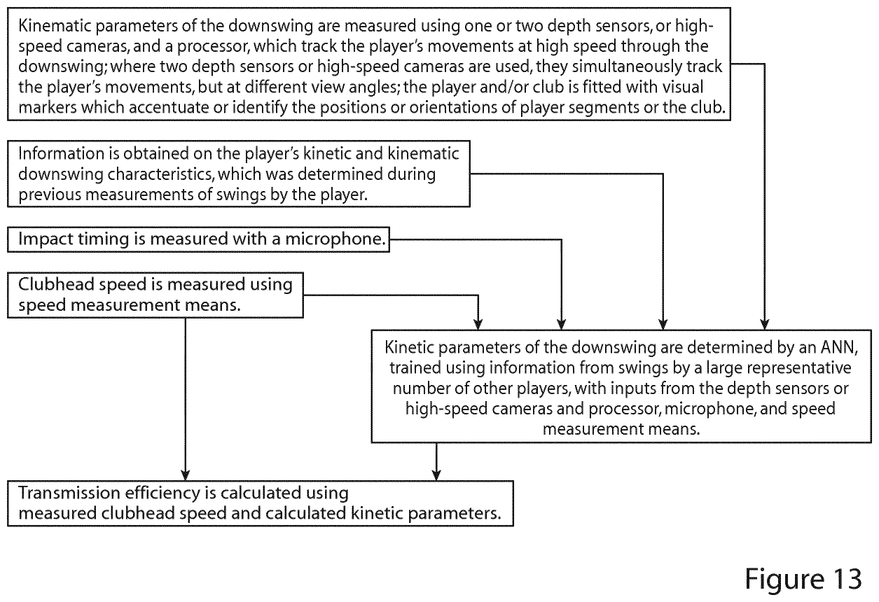

Reference is made to FIG. 13 which shows a flow chart, depicting a variant of the third set of examples of coaching apparatus, as described above, where inverse-dynamics are not used and which uses already known information and an artificial intelligence comprising artificial neural networks. It includes the following principal steps. The player's kinematic downswing parameters are measured during the swing using one or two depth sensors, or high-speed cameras, and a processor, which track the player's movements at high speed through the downswing. Where two depth sensors or high-speed cameras are used, they simultaneously track the player's movements, but at different view angles. The player and/or club is fitted with visual markers which accentuate or identify the positions or orientations of player segments or the club. Information is obtained beforehand on the player's kinetic and kinematic downswing characteristics, which was determined during previous measurements of swings by the player. Impact timing is measured during the swing with a microphone. Clubhead speed is measured using speed measurement means. The player's kinetic downswing parameters are determined by a processor and an ANN, trained using information using swings by a large representative number of other players, with inputs from the depth sensors or high-speed cameras and processor, microphone, and speed measurement means. A processor calculates the player's transmission efficiency using measured clubhead speed and the calculated kinetic parameters.

7.4.3 Variant using Body Segment Sensors and Artificial Intelligence, without Depth Sensor or HSC.

A yet further variant of the third set of examples of coaching apparatus with body-segment sensors and using artificial intelligence, omits the depth sensor which measures absolute positions of body and club segments at TOB. Aspects of this variant have some similarities to an earlier described assessment apparatus which also omits a depth sensor. The set of absolute positions of body and club segments are determined in the manner described below.

From body segment sensor and club sensor measured results, the TOB event is determined by tracking the angular movements backwards from impact to the point where typical TOB reversals or terminations of joint angular displacement occur. An artificial intelligence, such as an artificial neural network (ANN) is used to predict the absolute positions of body and club segments at one or more points in the downswing, typically at TOB or impact, or both. Where an ANN is used, the inputs to the ANN include details of the angular changes measured by the inertial sensors between TOB and Impact and relevant details of the player and club model geometry or BSIPs. The inputs may also include details of segment and club positions at TOB or impact as determined in the assessment. The ANN is trained using a database of swings from a large number of players, with training inputs of the database swings corresponding to those in the end-use ANN. Where the coaching system uses PADJE suppression means, the database of swings used in training the ANN may also use swings where suppression means are used. The training outputs are the absolute positions of body and club segments at TOB and/or impact of the particular database swing/player. In preparing the database, the absolute positions of body and club segments of database swings is obtained using any suitable motion capture means, including prior art means such as magnetic motion capture.

The absolute positions at TOB or impact, or an amalgam of both, are then used to determine the absolute positions of body and club segments throughout the swing. Where an amalgam is used, the TOB predicted positions may be preferentially used to determine the earlier positions of the downswing and the impact predicted positions preferentially used to determine the later positions of the downswing, with a gradual blend between the two over other parts of the downswing.

Reference is now made to FIG. 5, which shows a similar view to FIG. 4 except the depth sensor or HSC is omitted. A particular example is shown where the player is depicted with inertial sensors fitted to the left upper leg and left lower leg, where they may be used to coach improvement in left knee unseen-parameters. The inertial sensors may be swapped to other positions where other joints are measured. The following is an index of the reference numerals used in the figure.
1 Player.
2 Playing mat.
3 Ball in tee or starting position.
4 Inertial sensor.
5 Inertial sensor strap or harness.
9 Base controller.
10 Computer or monitor.

Reference is also made to FIG. 14, which shows a flow chart with the following steps which provide a typical example of this variant. The player's changes in segment and club orientation angles are measured during the downswing by a partial set of swappable inertial sensors on the player's body segments and club. Information is obtained beforehand on the player's kinetic and kinematic downswing characteristics, which was determined during previous measurements of swings by the player. Impact timing is measured during the swing with a microphone. Clubhead speed is measured using inertial sensor measurement or measurement by a separate speed measurement means. The player's kinetic downswing parameters in the swing are determined by a processor and ANN, trained using information from swings by a large representative number of other players, with inputs from the inertial sensors, microphone, and speed measurement means. A processor calculates the player's transmission efficiency using the measured clubhead speed and the calculated kinetic parameters.

7.5 Fourth set of Examples of Coaching Apparatus. Without separate Assessment.

In a fourth set of examples of coaching apparatus, the separate or remote assessment process is eliminated. Although this will compromise the accuracy of the system, it may for example be useful where assessment venues are not conveniently available, or where users require self-contained products.

7.5.1 Variant using ANNs and Multiple Inertial Sensors.

In a first variant of the fourth set of examples of coaching apparatus, a separate or remote assessment process is eliminated. The player executes a series of swings under directions from the processor or system, using apparatus which both assesses and coaches the swing. These swings are executed and assessed and provide the basis for comparison with later swings in the series, which may include the preparation of a coaching plan. This immediate assessment, is somewhat equivalent to the higher-level assessment previously described. It is built up each time the player uses the system, since sensors may be placed on different sets of segments in ongoing use by the player. The software is arranged to accommodate multiple players using the same equipment. Coaching then proceeds with further swings of the series being executed. The processor compares the results of these swings to the results of the earlier swings and provides fast feedback on coaching progress.

The apparatus comprises a set of inertial sensors which are attached to segments of the player and track the relative magnitudes of the principal joint angular displacements, velocities and time durations through the downswing. The apparatus also includes an artificial intelligence, such as an ANN, which has been trained with appropriate comparator values from a database of previous swings by a large number of other players who have been measured with accurate assessment means, for example where the assessment means is similar to the first example of assessment means using inverse-dynamics, described earlier in this specification. The end-use inputs to this ‘immediate’ assessment ANN include the measured parameters from the player's current initial swing together with details of the player, including a selection from the player's overall weight, height, gender, other readily-obtained BSIP parameters, age and downswing-handicap or official handicap. The end-use outputs from this ANN include predictions of the relevant unseen-parameters of the current swing. The ANN is trained using sets of appropriate comparator information on individual players in the database. For each player's swing, or averaged group of swings, the training inputs are swing measurements using apparatus of the same type as the present variant together with details of the player, equivalent to those used in the end-use ANN. The training outputs are the unseen-parameters for the same swing, or averaged group of swings, but using a relatively high-accuracy assessment means which may, for example, be similar to the first example of assessment means using inverse-dynamics. Where the coaching system uses PADJE suppression means, the database of swings used in training the ANN may also use swings where suppression means are used. A different format end-use ANN may be used for the ‘immediate’ assessment swings in the series than for the subsequent coached swings in the series. In one such arrangement, the most up-to-date results from the ‘immediate’ assessment ANN may be added to the inputs of the coached swings of the series, providing the ANN with a wider set of relevant data on which to base the analysis. Other ANN inputs may also be used. For example, a microphone means may be added which determines the time of impact, and thereby allows calculation of inputs giving the time durations between the start and finish of each sensor input relative to impact.

The present variant may be used with varying numbers of body segment inertial sensors. Where larger fuller sets of sensors are used, tracking all or most of the player's body segments, the ANN will be presented with increased information and predictions will be more accurate. Where reduced sets of sensors are used, and swapped between segments depending on whatever joints are being coached, the predictions will be less accurate but the cost and complexity of the apparatus is reduced and the time required to fit sensors is lessened.

Reference is made to FIG. 15 which shows a flow chart, depicting the steps outlined in a typical variant of the measurement example described above.

Changes in the player's segment and club orientation angles are measured during the downswing by a partial set of swappable inertial sensors on body segments and club. Impact timing is measured during the swing with a microphone. Clubhead speed is measured using the inertial sensor measurements or measurement by a separate speed measurement means. The apparatus builds up an increasing large record of the player's swings as more swings are taken and keeps separate records of players where more than one player uses the same apparatus. The player's kinetic downswing parameters are determined by a processor and ANN, trained using swing information from a large representative number of other players, with inputs from the inertial sensors, microphone, speed measurement means, and continuously built-up record of previous swings. A processor calculates transmission efficiency using measured clubhead speed and the calculated kinetic parameters.

Reference is again made to FIG. 5, which also depicts this variant. The following is an index of the reference numerals used in this figure.
1 Player.
2 Playing mat.
3 Ball in tee or starting position.
4 Inertial sensor.
5 Inertial sensor strap or harness.
8 Combined depth sensor and base controller with frontal view-angle.
10 Computer or monitor.

In a particular variant of this example, a depth sensor and microphone system are added to the apparatus and operated in a manner similar to that described in the second set of examples of coaching apparatus. The depth sensor determines the timing and model position at TOB and the changes in angles from the inertial sensors measurements and ANN predictions determine the movement of the player model from TOB to the impact event, which is measured by the microphone system.

7.5.2 Variant using ANNs and a Depth Sensor or HSC.

In a second variant of the fourth set of examples of coaching apparatus, the separate assessment process is again eliminated. The player again executes a series of swings, under directions from the processor or system, using apparatus which both assesses and coaches the swing. In this instance a depth sensor or HSC is used to capture the kinematic motion, in a similar manner to that described in a previous example. A first few swings from the series are executed and assessed and provide the basis for comparison with later swings in the series, which may include the preparation of a coaching plan. This immediate assessment, is again somewhat equivalent to the higher-level assessments previously described. It is built up each time the player uses the system, since different sets of poses or images will be captured and identified in ongoing use by the player. Similar to the previous example, the software is arranged to accommodate multiple players using the same equipment. Coaching then proceeds with further swings of the series being executed. The processor compares the results of these swings to the results of the first few swings and provides fast feedback on coaching progress.

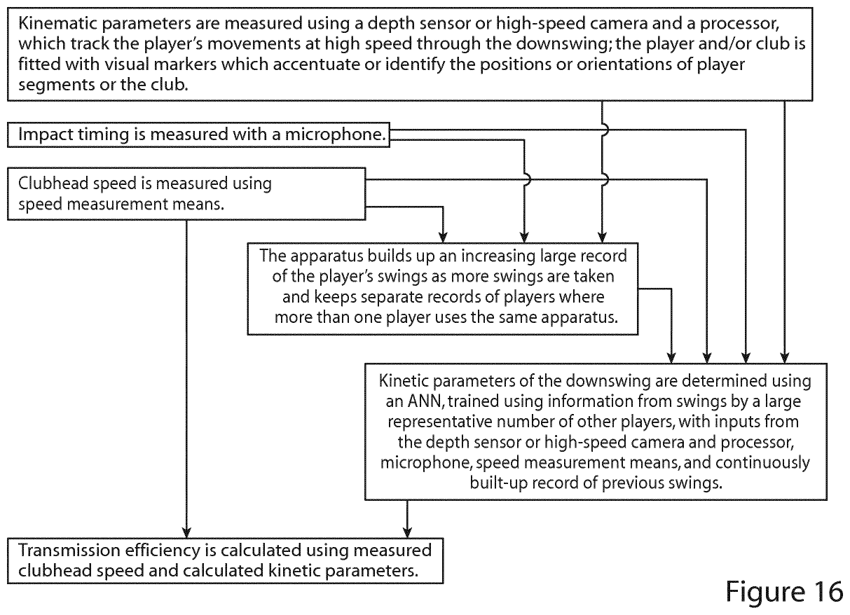

Reference is made to FIG. 16 which shows a flow chart, depicting the steps outlined in the measurement example described above. The player's kinematic parameters are measured using a depth sensor or high-speed camera and a processor, which track the player's movements at high speed through the downswing. The player and/or club is fitted with visual markers which accentuate or identify the positions or orientations of player segments or the club. Impact timing is measured during the swing with a microphone. Clubhead speed is measured using speed measurement means. The apparatus builds up an increasing large record of the player's swings as more swings are taken and keeps separate records of players where more than one player uses the same apparatus. The player's downswing kinetic parameters are determined using a processor and an ANN, trained using information using swings by a large representative number of other players, with inputs from the depth sensor or high-speed camera and processor, microphone, speed measurement means, and continuously built-up record of previous swings. A processor calculates the player's transmission efficiency using measured clubhead speed and the calculated kinetic parameters.

7.5.3 Minimal Variant Using a Reduced Number of Inertial Sensors.

In a further variant of the set of examples of coaching apparatus where the separate or remote assessment process is eliminated, the relative angular displacement of a joint in a downswing is measured using two inertial sensors and evaluated against relevant comparators. The angular velocity and time duration may also be simultaneously measured. The measurements may be used to decide the degree to which the joint is suitable for coaching and several joints may be measured before the most suitable coaching programme is formulated. Alternatively, the system or player may prioritise joints for testing based on existing knowledge of joints which are known to be most amenable to the coaching process or which are likely to have the most effective PADJE increases. In its simplest format, the apparatus comprises just two inertial sensors which track the timing and change in relative joint angle across the swing, from which it determines the angular-displacement, angular-velocity, DRAPB and DRAPE parameters and estimated torque characteristics. These are compared to the aforementioned known values of comparable swings, and to that of the previous swing or average of previous swings when coaching is carried out over a series of swings. As previously mentioned, certain torque characteristics can be estimated from changes in the combination of angular displacement and angular velocity. Ideally, the parameters are coached in an otherwise similar manner to that which has already been described, including communication of appropriate fast feedback to the player following each swing in the series of swings. Feedback will typically indicate whether the relevant parameter has increased or otherwise, the degree to which it has increased and how it compares to that of comparable players. The accuracy of the comparison to comparable players can also be improved where the system considers as many relevant details as possible of the subject player, including a selection from the player's overall weight, height, gender, physique, age and downswing-handicap or official handicap. These may be inputted to the system processor by a question and answer routine completed by the player, causing the processor to select the most relevant comparable parameters.

8. Activities Other Than Golf Downswings.

The invention also provides an apparatus and method for coaching or analysing equivalent unseen-parameters or processes of a wide variety of other intermittent high-speed, high-energy human action-processes with repeated elements, where the underlying processes are also largely internal and therefore chiefly not visible or readily understood by an observer either in real-time or slow-motion. Such action-processes include, inter alia, the following sports-related activities: baseball, tennis, squash, badminton, cricket, hockey, ice-hockey, hurling, polo, bowling, basketball, netball, soccer, rugby, American football, lacrosse, boxing and martial arts.

The methods and apparatus for coaching, assessing and measuring a golf swing, described in detail in this specification, provide an example by which a person skilled in the art can apply appropriate methods and apparatus to other intermittent high-speed, high-energy human action-processes with repeated elements, including those sports-related activities listed in the previous paragraph. Guidance shall now be offered to assist a person skilled in the art in making such application.

The invention always applies to specific intermittent, fast, high-energy human action-processes which are in particular ways equivalent to the non-putting golf swing. For clarity, these specific action-processes or portions of more general action-processes shall be referred to as ‘power-strokes’. Unlike the golf downswing, they do not always end with an impact with a ball. The power-stokes of common action processes occurring in the list above can be determined as follows:

The power-stroke will involve body movements or rotations, without reversals, where energy is generated.

In the golf swing, the power-stroke is the downswing, with an instrument, which comprises the club, moving in a rotating arc, without reversals, from TOB to impact, with PADJE energy generated across the joints of the body. The clubhead comprises the distal end of a kinetic chain running from the clubhead back through the connected segments of the human player's body. The power-stroke ends at impact, where the club impacts a projectile, which is a golf ball. The completion of the power-stroke, in the case of a golf swing may therefore be described by the following: a human and an implement, where the distal end of the kinetic chain comprises the implement, and a power-stroke is completed when impact occurs between the implement and a projectile.

The completion of power strokes may also occur in other ways, with the principal ones related to the aforementioned sports-related action-processes being included in the following list, where a projectile refers to a ball or other physically projected object, and where a hit-target refers to a portion of an object, such as another human, which is hit:
A human and an implement, where the distal end of the kinetic chain comprises the implement, and a power-stroke is completed when impact occurs between the implement and a projectile.
A human and a projectile, where the distal end of the kinetic chain comprises a body segment and a projectile, and a power-stroke is completed when the projectile is released from the body segment.
A human, where the distal end of the kinetic chain comprises a body segment, and a power-stroke is completed when impact occurs between the body segment and a projectile.
A human, an implement and a projectile, where the distal end of the kinetic chain comprises the implement and the projectile, and a power-stroke is completed when the projectile is released from the implement.
A human, where the distal end of the kinetic chain comprises a body segment, and a power-stroke is completed when impact occurs between the body segment and a hit-object.

More specific examples of these, which are similar to a golf swing are given in the following list:
Executing a non-putting golf swing or a golf-related swing, where the implement is a club and the projectile is a ball.
Batting in baseball, where the implement is a baseball bat and the projectile is a ball.
Serving in tennis, squash or badminton, where the implement is a racquet and the projectile is a ball or shuttlecock.
General hitting in tennis, squash or badminton where the implement is a racquet and the projectile is a ball or shuttlecock.
Batting in cricket, where the implement is a cricket bat and the projectile is a ball.
Hitting in hurling where the implement is a hurling stick and the projectile is a ball.
Hitting in hockey or ice-hockey, where the implement is a hockey stick and the projectile is a puck;
Hitting in polo, where the implement is a mallet and the projectile is a ball.
Casting in fishing, where the implement is a rod and the projectile is a selection from hook, weight and bait.

Further specific examples of these, which are less similar to a golf swing in that the power-stroke involves the human and a projectile, where the distal end of the kinetic chain comprises one or two body segments and the projectile, and a power-stroke is completed when the projectile is released from the body segment or body segments are given in the following list:
Pitching in baseball, where the body segment is a hand and the projectile is a ball.
Bowling in cricket, where the body segment is a hand and the projectile is a ball.
Bowling in bowling or boules, where the body segment is a hand and the projectile is a ball.
Throwing in basketball or netball, where the body segment or segments is one or two hands and the projectile is a ball.

Yet further specific examples of these, which are less similar to a golf swing in that the power-stroke involves the human, where the distal end of the kinetic chain comprises a body segment; and a power-stroke is completed when impact occurs between the body segment and a projectile, are given in the following list:
Kicking in football, soccer, rugby or American football, where the body segment is a foot or shod foot and the projectile is a ball.
Heading a ball in football or soccer, where the body segment is a head and the projectile is a ball.
Additional specific examples of these, which are less similar to a golf swing in that the power-stroke involves the human, an implement and a projectile; where the distal end of the kinetic chain comprises the implement and the projectile; and a power-stroke is completed when the projectile is released from the implement, are given in the following list:
Throwing in lacrosse, where the implement is a lacrosse stick and the projectile is a ball.
Slinging with a sling-shot, where the implement is a sling and the projectile is a shot or missile.
Further specific examples of these, which are less similar to a golf swing in that the power-stroke involves the human, where the distal end of the kinetic chain comprises a body segment; and a power-stroke is completed when impact occurs between the body segment and a hit-object, are given in the following list:
Throwing a punch in boxing, where the body segment is a hand or fist and the hit-object is an opponent human.
Hitting a martial-arts strike, where the body segment is a hand or foot and the hit-object is an opponent human.

The parameters which are coached, analysed or assessed in these various power-strokes are very similar to those coached, analysed or assessed in the golf downswing with respect to the invention. This arises because they are all primarily concerned with energy generated across the joints of the human body and transferred to the distal end of the kinetic chain of body segments, or, in most instances, body segments and implement where an implement is involved. Furthermore, in the aforementioned power-strokes, where the activity is carried out in an accomplished manner it will utilise energy generation widely across the body, similar to an accomplished golf downswing. Another advantageous similarity to the golf swing is that the power-strokes are of an intermittent nature, similar to the golf downswing, drawing on an intermittent use of high-energy levels, as opposed to an activity which requires more constant and sustained use of generated energy, such as cycling or running. A further advantageous similarity is that the intermittent nature of the power-stroke also allows coaching and assessment to be carried out in a limited physical location. It is a further insight of the invention that these various similarities to the golf swing allow similar methods and apparatus to be used for measuring, assessing, analysing and coaching. The methods or apparatus used in measuring, assessing, analysing or coaching these power-sequences, with judicious modification by persons skilled in the art, may be treated mutatis mutandis to methods or apparatus used in analysing, assessing or coaching a golf swing.

The acronym PADJE is used to describe positive across downswing joint energy in the golf downswing. The acronym PAPJE is used in the claims accompanying this description to describe positive across power-stroke joint energy in these other power-strokes described above, and is otherwise directly equivalent to the acronym PADJE.

9. Glossary of Acronyms and Unusual Terms.

| | |
|---|---|
| “unseen-parameters/processes” | Parameters or processes of the |
| | non-putting downswing which are |
| | largely not visible or readily |
| | understood either in real time |
| | or slow-motion. |
| “joint” | In addition to referring to an |
| | articulation in the body model, |
| | the term “joint” or a particular |
| | named joint, shall also refer to |
| | the joint and its associated |
| | muscle group. |
| “distal”/“proximal” | Closest to club or head/closest |
| | to ground contact. |
| “TOB” | Top of backswing. Where the |
| | swing changes from backswing |
| | to downswing. |
| “impact” | Impact between club and ball at |
| | end of downswing. |
| “downswing” | TOB to impact. |
| “joint energy” | Joint energy, generated across |
| | one or more joints of the |
| | player/model. |
| “research database” | Database comprising the |
| | applicant's test results. |
| “PADJE” | Positive across-downswing joint |
| | energy. Also, that portion of a |
| | PADJE which occurs between |
| | standard commencing and finish |
| | proportions of the joint energy, |
| | such as 15% and 85%. |
| “PADJEs” | Plural of PADJE. |
| “total PADJE” | Sum of all PADJEs generated in a |
| | player/model over the course of a |
| | downswing. |
| “kindred PADJE” | A PADJE which is one of a set of |
| | a player's PADJEs which are |
| | deemed to be more effectively |
| | coached as a set than coached |
| | individually. |
| “kindred joint” | A joint relating to a kindred |
| | PADJE. |
| “downswing-handicap” | Based on unseen-downswing |
| | performance with distance club |
| “distance club” | Driver club, wood, hybrid and |
| | long iron clubs. |
| “PADJE proportions” | The values of a player's PADJE |
| | of individual joints as expressed |
| | as proportions of total PADJE |
| | for that player. |
| “high-proportions” | PADJEs which are significantly |
| | higher than average as a |
| | proportion of total. |
| “low-proportions” | PADJEs which are significantly |
| | lower than average as a |
| | proportion of total. |
| “DRAPB” | Downswing-rotation-angle at |
| | PADJE-beginning. |
| “DRAPBs” | Plural of DRAPB. |
| “DRAPE” | Downswing rotation-angle at |
| | PADJE-end. |
| “DRAPEs” | Plural of DRAPE. |
| “Span between DRAPB and DRAPE” | Angular span between DRAPB |
| | and DRAPE. |
| “comparator or comparator value” | A value against which a player's |
| | parameter value can be compared |
| | and assessed, based on best |
| | scientific knowledge available. |
| “average comparator” | A comparator value based on |
| | averages of other relevant |
| | values. |
| “target comparator” | A comparator value which is at |
| | a higher target level than the |
| | player's corresponding value. |
| “style-variations” | Variations in play which are |
| | not deemed to be faults. |
| “transmission-efficiency” | Synonymous with “transmission |
| | efficiency”. The ratio of |
| | [energy transmitted to the |
| | clubhead by impact] to [total |
| | PADJE], |
| “transmission-efficiency-parameters” | Transmission-efficiency factors, |
| | including the proportion of |
| | segment kinetic energy remaining |
| | following impact, and the amount |
| | of negative joint energy absorbed |
| | in the downswing. |
| “SKE” | Segment kinetic energy remaining |
| | in the player's body. |
| “NJE” | Negative joint energy (NJE) |
| | absorbed in the downswing. |
| “GPE” | Change in gravitational potential |
| | energy of the player segments and |
| | club between the start and finish |
| | of the downswing. |
| “AF” | Air friction losses incurred |
| | during the downswing. |
| “body-focus” | Focused on body parts, such as |
| | a joint displacement. |
| “non-body-focus” | Focused on non-body parts, such |
| | as ball trajectory. |
| “overt non-body-focus” | Goal-orientated non-body-focus, |
| | such as hitting the ball further. |
| “covert non-body-focus” | Non-body-focuses which will |
| | direct the player to explore |
| | improvement with the selected |
| | coaching parameters. |
| “selected coaching parameters” | Those parameters which are |
| | identified and selected for |
| | coaching. |
| “PADJE suppression” | Part or full suppression of the |
| | natural performance of a PADJE |
| | joint. |
| “BSIP” | Body segment inertial parameter, |
| | including segment moments-of |
| | inertia about segment joints. |
| “GRF” | Ground-reaction force. |
| “ANN” | Artificial neural network, type |
| | of artificial intelligence. |
| ”HSC” | High-speed camera. |
| “power-stroke” | Equivalent of the downswing in |
| | a non-golf power-stroke. |
| “PAPJE” | Equivalent of PADJE in a non- |
| | golf power-stroke. |

It is to be understood that the invention is not limited to the specific details described herein, and that various modifications and alterations are possible without departing from the scope of the invention as defined in the appended claims.

1.-120.

121. A method of analysing a non-putting golf swing, involving a player and a club, using a computer and measuring apparatus; which comprises the following steps:
using the measuring apparatus to obtain measurements of the swing;
using the computer to determine swing parameters from said measurements, including kinetic swing parameters, utilising a model which mimics at least part of the player and club, and which mimics a plurality of body segments and at least one body joint, and at least one of the body joints connects two body segments;
selecting swing parameters for analysis; including swing parameters which are energy-related parameters related to energy generated across individual joints in said model; and
analysing the swing from the selected parameters, including evaluation and assessment; where an intended outcome is an improvement in the strength of the swing, where an improvement in the strength of the swing is understood to mean a selection from, an increase and prevention of a decrease, in a selection from clubhead speed at impact, clubhead kinetic energy at impact, ball speed, ball travel distance, combination of ball loft and speed, and combination of ball loft and ball travel distance;
characterised by:
A) selecting swing parameters for analysis by the computer,
a) on a tested and confirmed scientific basis;
b) with the computer prioritising the use of a selection from PADJE magnitudes and PADJE component magnitudes over:
i) the PADJE characteristics of consistency; contiguity; sequencing; vector components; energy peaking; energy rates of ramping up; and energy rates of ramping down; and
ii) the swing parameters of negative joint energy; style variations; segment energy; and segment energy sequencing; and
c) with the computer prioritising the use, over other energy-related parameters, of a selection from
i) PADJE angular displacement; and
ii) PADJE angular displacement and PADJE average torque; and
B) analysing swing parameters using the computer, using a selection from: evaluating said parameters; assessing said parameters; comparing said parameters to those of previous swings by the player; comparing said parameters to those of swings by other players; and comparing said parameters to those deriving from information on the swings of other players;
where the term ‘PADJE’ refers to: positive joint energy generated across a joint of said model, over a selection from: the course of the downswing; and a defined portion of positive joint energy over the course of the downswing, such as a portion which lies between the attainment and completion of defined proportions of the completed magnitude of a PADJE, such as 15% and 85%, respectively, of the completed magnitude of the PADJE; the term ‘3D vector components’ refers to vector characteristics of a selection from forces, angular displacements, angular velocities and torques associated with the generation of PADJEs; the term ‘consistency’ refers to consistency between individual swings; the term sequencing refers to the relative sequencing of individual blocks of energy generated at the different joints; the term ‘contiguity’ refers to the contiguity of blocks of energy generated at a joint; the term ‘smoothness’ refers to the smoothness of generation of blocks of energy at a joint; the term ‘energy peaking’ refers to peaking of PADJE joint power generated at a joint; the term ‘energy rates of ramping up and down’ refers to rates of ramping-up and ramping-down of blocks of energy generated at the different joints as muscle groups switch on and off at a joint; the term ‘negative joint energy’ refers to energy absorbed across a joint; the term ‘style variations’ refers to players' different technical styles where each of the styles is considered to represent accomplished swing performance; the term ‘segment energy’ refers to segment kinetic energy; and the term ‘segment energy sequencing’ refers to the relative sequencing of the development of segment energies in the swing; the term PADJE ‘angular displacement’ and ‘angular displacement’ refer to the angular change over the PADJE in the included angle between two segments connected by a joint of said model; the term ‘angular displacement’ is also understood to refer to powered angular displacement, where the movement of the joint is powered over the PADJE; and the term ‘PADJE average torque’ and ‘average torque’ refer to the average value of torque applied across the joint over the PADJE.

122. The method of claim 121, wherein swing parameters are selected for analysis with the computer uses strategies with a selection from:
i) an individual PADJEs and a component of an individual PADJE being individually coached to increase the magnitude of the said individual PADJE; and
ii) a set of up to three kindred PADJEs and a set of components of up to three kindred PADJEs, being individually coached to increase the magnitude of the said set of kindred PADJEs;
in contrast to traditional coaching methods which favour coaching much more wide-ranging body movements;
where the term ‘set of kindred PADJEs’ refers to PADJEs which are found to be best coached with other PADJEs of the kindred set rather than coached individually.

123. The method of claim 121, wherein swing parameters are selected for analysis with the computer using strategies where a selection from, PADJEs and PADJE components, of joints are prioritised using a selection from:
i) priority being given to those joints for which the player is found to be more below PADJE proportions relative comparator values; and
ii) priority being given to joints, based on a combination of those joints for which the player is found to be more below PADJE-proportions relative comparator values; and those joints which typically have higher absolute magnitudes of PADJE for a selection from average groups of players and comparator groups of players;
the term PADJE proportion value' refers to a player's individual PADJE value expressed as a selection from, a proportion of the player's total PADJE value and a proportion of the greater part of the player's total PADJE value, such as total PADJE less right knee PADJE for players who swing in the usual right to left direction; and where the term ‘relative comparator values’ refers to values, relevant to the player, against which the player's values can be compared, and which are relative rather than absolute values, such as a player's individual PADJE proportions values; and the term ‘comparator groups of players’ refers to groups of players against which the player can be appropriately compared, such as a group of players with similar handicap skill to the player.

124. The method of claim 121, wherein the apparatus uses parameters which are a selection from PADJEs and components of PADJEs, which include a selection from the following:
parameters which include a selection from individual PADJEs associated with left foot, left angle, left knee, left hip, right foot, right knee, right hip, lumbar, thorax, left inner shoulder, left shoulder, left elbow, left wrist, grip, right inner shoulder, right shoulder, right elbow, right wrist and neck joints;
parameters which include a selection from total PADJE and any combination of individual PADJEs;
parameters which include a selection from the following components of PADJEs, powered angular displacement, powered angular velocity; torque; joint power; time duration; and average values of each of those components;
parameters which include a selection from the kinematic values of angular displacement and angular velocity acting as measures of the kinetic parameters powered angular displacement and powered angular velocity, respectively; and average values of each of those components;
parameters which include a selection from averages of defined portions of PADJEs and averages of defined portions of components of PADJEs, which are used to avoid problems of using averages where PADJEs commence or end in irregular ways;
parameters which include a selection from averages and other statistical measures of defined groups of PADJEs and components of PADJEs;
parameters which are measures of a selection from the start and finish of a PADJE, and of a portion of a PADJE, such as the attainment and completion of a proportion of the completed magnitude of a PADJE; and
parameters which include a selection from PADJEs which are coached as portions of PADJEs commencing and ending when defined proportions of total PADJE have been generated.

125. The method of claim 121, wherein the apparatus uses strategies in coaching PADJEs, which include a selection from the following:
the apparatus uses the kinematic parameter angular displacement as an estimate of the kinetic parameter powered angular displacement;
the apparatus uses the kinematic parameter angular velocity as an estimate of the kinetic parameter powered angular velocity;
the apparatus estimates changes in a selection from the PADJE components of torque and average torque from changes in the combination of powered angular displacement and powered angular velocity by assuming no change in the PADJE component of time duration; and
the apparatus estimates changes in a selection from the PADJE components of torque and average torque from changes in the combination of powered angular displacement, powered angular velocity and the PADJE component of time duration.

126. The method of claim 121, wherein the apparatus assesses a swing parameter with respect to improving the strength of the swing, by comparing it to a relevant value termed a ‘comparator’ value, and where the comparator value includes a selection from the following:
the apparatus obtains the comparator value;
the comparator value is calculated with respect to the average value of the parameter for other players;
the comparator value is calculated with respect to the average value of the parameter for groups of players with similar characteristics to the player, such as characteristics related to energy generation and transmission in the player's body and characteristics related to the players physical characteristics, such as sex and age;
the comparator value is calculated on the basis of the player's previous performance;
the comparator value is calculated using regression analysis based on values of the parameter and values for similar characteristics to those of the player, deriving from information on other players;
the comparator value, uses a control variable in regression type analysis, which is based on values relating to total PADJE for comparator values for a selection from PADJE related magnitudes and PADJE component related magnitudes; and
the comparator value, uses a control variable in analysis, such as regression analysis which is based on values relating to clubhead energy or clubhead speed at impact, for parameters relating to the commencement or ending of PADJEs.

127. The method of claim 121, wherein a selection from analysis and coaching by the computer is carried out in a manner which includes a selection from the following:
operating in a pre-dominantly scientific rather than pre-dominantly empirical basis;
operating in a way that recognises differences between players and, in particular, takes account of differences in kinetic parameters;
controlling using a selection from operating without human intervention and operating in combination with human intervention, such as intervention by a human coach;
operating one type of club by coaching another club type, where club type refers to a selection from differences in club lengths; shaft types; and differences in clubhead types, such as woods, hybrids and irons.
measuring the swing in an automatic manner;
analysing the swing in an automatic manner;
providing feedback on the swing in an automatic manner.
measuring the swing in a partly automatic manner;
analysing the swing in a partly automatic manner; and
providing feedback on the swing in a partly automatic manner.

128. The method of claim 121, wherein the computer calculates kinetic swing parameters using a selection from:
inverse dynamics;
alternatives to inverse dynamics;
forward dynamics; and
nonparametric regression and learning methods.

129. The method of claim 121, wherein coaching is carried out in a manner where said computer is involved in a selection from the following:
formulating a coaching plan;
determining instructions for the player;
communicating instructions to the player;
determining feedback for the player;
communicating feedback to the player;
monitoring progress and making appropriate alterations to the coaching plan, and
automating coaching processes.

130. The method of claim 129, wherein the apparatus uses strategies in coaching PADJEs, wherein
i) the magnitude of total PADJE is increased by coaching an individual PADJE with a selection from being angularly earlier and increasing its angular span;
ii) the said individual PADJE is separately coached; and
iii) PADJEs which have an increase in magnitude need not necessarily include the said individual PADJE which was coached;
where the term “total PADJE” refers to the sum of all PADJEs generated over the downswing; the term “angularly earlier” refers to a selection from earlier time-wise and earlier angle-wise in the swing cycle in relation to measures following the angle of the club shaft as it rotates in the swing plane in a selection from, from top-of-backswing to impact, and the angle of other body or club parts which similarly rotate as the club shaft rotates, such as the player's lower arms; and the term “angular span” refers to the angular span between the beginning and end of a PADJE, in relation to measures following the angle of the club shaft as it rotates in the swing plane in a selection from, from top-of-backswing to impact, and the angle of other body or club parts which similarly rotate as the club shaft rotates, such as the player's lower arms.

131. The method of claim 129, wherein the swing is coached in a cycle which includes the player executing a swing, using apparatus to measure the swing, using apparatus to analyse the swing, using apparatus in the provision of fast feedback on the swing, and the player executing a further swing;
where said fast feedback on the swing:
i) is provided within one minute at most, of the swing being executed;
ii) is provided prior to the execution of said further swing; and
iii) is provided to a selection from: the said player; system apparatus; and a human involved in coaching the player.

132. The method of claim 129, wherein the swing is coached, without directly targeting particular individual PADJEs, by using apparatus to supress the natural performance of individual PADJEs to encourage the player's subconscious self-organising system to compensate by increasing the magnitude of other PADJEs, whereby, a higher level of PADJE is ultimately generated in the swing.

133. The method of claim 129, wherein
A) the swing is coached using apparatus, by a selection from, increasing and preventing a decrease in, the transmission efficiency of the swing, where transmission efficiency refers to the relative proportion of the player's PADJE energy which is transmitted to the clubhead as kinetic energy at or just before impact;
B) the swing is coached using parameters which are directly related to the efficiency at which the player's PADJEs are transmitted to the clubhead at impact with a ball, which will be referred to as ‘transmission efficiency parameters’, and which include a selection from: player segment and club kinetic energies during the downswing, player negative joint energies and their components, and player segment and club potential gravitational energies during the downswing; and
C) transmission efficiency is improved by reducing the magnitude of a transmission efficiency parameters.

134. The method of claim 129, wherein the apparatus uses strategies in coaching PADJEs which include a selection from the following:
increasing the sum of the individual PADJES;
maximising the sum of the individual PADJES;
increasing the sum of the individual PADJES, other than of the right knee for players who swing in the usual right to left direction, and of the left knee for players who swing from left to right;
prioritising PADJEs or their components for coaching where their values are less than those of relative comparator values;
prioritising PADJEs for coaching in approximate proportion to a selection from their average absolute values in the general population or to their average absolute values in comparator groups of players;
prioritising PADJEs or their components for coaching based on a combination of their values compared to relative comparator values, and to a selection from average absolute values in the general population and to their average absolute values in comparator groups of players;
commencing individual PADJEs earlier in the swing cycle to increase the value of total PADJE, where the term earlier in the swing cycle is understood to mean a selection from earlier time-wise and earlier angle-wise in relation to measures following the angle of the club shaft as it rotates in the swing plane from top-of-backswing to impact, or the angle of other body or club parts which similarly rotate as the club shaft rotates, such as the player's lower arms;
ending individual PADJEs earlier in the swing cycle to increase the value of total PADJE; and
increasing the differences between the commencements and ends of individual PADJEs, in the swing cycle, to increase the value of total PADJE.

135. The method of claim 129, wherein the apparatus coaches some individual PADJEs as a group of kindred PADJEs, with the kindred group determined using apparatus by ways which include a selection from the following:
the apparatus determines a player's kindred PADJEs by association with typical kindred patterns for player's with similar relevant characteristics;
the apparatus determines a player's kindred PADJEs by association with typical or average kindred patterns for player's with similar PADJE proportions, where the term PADJE proportion refers to the magnitudes of the player's individual PADJEs expressed as a proportion of the player's total PADJE.
the apparatus determines a player's kindred PADJEs by association with typical kindred patterns for player's being coached with the particular individual PADJE or PADJEs selected for coaching;
the apparatus determines a player's kindred PADJEs by commencing coaching with an initial set of PADJEs, assessed to be most likely to be kindred PADJEs, and then reviewing, and altering where necessary, the initial set of PADJEs assumed to be kindred PADJEs, depending on its assessment of coaching performance; and
the apparatus determines a player's kindred PADJEs by commencing coaching with an initial set of PADJEs, deemed to be most likely to be kindred PADJEs, and then reviewing, and altering where necessary, using an artificial intelligence means, the initial set of PADJEs deemed to be kindred PADJEs, depending on measured coaching performance.

136. The method of claim 129, which includes a selection from the following:
the apparatus provides communication to a player, which encourages the employment of the player's sub-conscious self-organising ability as opposed to the player's conscious ability, and which includes a selection from the following:
the apparatus provides feedback in a format which does not include verbal and written feedback;
the apparatus provides feedback which is short and simple where it is given in a format which is verbal;
the apparatus provides feedback with a non-body focus, where a non-body focus refers to a focus on intended outcomes or movement outcomes;
the apparatus using communications to a player which involve a preference, where feasible, for avoiding an emphasis on conscious focusing on movements of body parts, as opposed to focusing on intended outcomes or movement outcomes; and
the apparatus using communications to a player which involve a preference, where feasible, for promoting use of a selection from non-verbal and non-written communication.

137. The method of claim 129, which includes a selection from:
the apparatus coaches the swing in a cycle which includes the player executing a swing, using apparatus to measure the swing, using apparatus to analyse the swing, using apparatus in the provision of feedback on the swing, and the player executing a further swing, where said feedback on the swing is provided to a selection from the said player, the system apparatus and a human coach involved in coaching the player; and
the apparatus coaches the swing by repeating a cycle of swing execution—swing measurement—provision of feedback—further swing execution, over a plurality of cycles with the element of further swing execution becoming the start of a new cycle beginning swing execution.

138. The method of claim 129, wherein
A) measuring the swing, using apparatus, which includes a selection from:
measuring kinematic parameters of the player and club using sensors attached to a selection from player and club segments, where the sensors do not require the provision of an electromagnetic reference field;
measuring kinematic parameters of the swing using a selection from a depth sensor which can sense a 3D optical image of the player and club, and a high-speed camera which operates with software to capture images and 3D information on the player and/or club, in real time and without manual clean-up; and
measuring information related to the player's body segment inertial parameters using a selection from a high-speed camera which operates with software to capture images and 3D information on the player and player segments, in real time and without manual clean-up of data, and a depth sensor which can sense a 3D optical image of the player and player segments, without the need for manual palpation of the player and the provision of an electromagnetic reference field; and
B) analysing the swing with apparatus using a selection of parameters from: the following energy-related parameters, which are components of PADJEs: powered angular displacement, average powered angular velocity, average torque, angular displacement and average angular velocity;
where the term ‘angular displacement’ refers to the angular change over the PADJE in the included angle between two segments connected by a joint of the model of the player or player and club; the term ‘average angular velocity’ refers to the average velocity of that angular change over the PADJE; ‘average torque’ refers to the average value of torque applied across the joint over the PADJE; and the term ‘powered’, where added to the parameters angular velocity, and angular displacement, indicates that the parameter is a kinetic parameter applied to that portion of the movement of the joint which is powered over the PADJE.

139. A method of analysing a non-putting golf swing, involving a player and a club; using a computer and measuring apparatus; which comprises the following steps:
using the measuring apparatus to obtain measurements of the swing;
using the computer to determine swing parameters from said measurements, including kinetic swing parameters, utilising a model which mimics at least part of the player and club, and which mimics a plurality of body segments and at least one body joint, and at least one of the body joints connects two body segments;
selecting swing parameters for analysis; including swing parameters which are energy-related parameters related to energy generated across individual joints in said model; and
analysing the swing from the selected parameters, including evaluation and assessment;
where an intended outcome is an improvement in the strength of the swing, where an improvement in the strength of the swing is understood to mean a selection from, an increase and prevention of a decrease, in a selection from clubhead speed at impact, clubhead kinetic energy at impact, ball speed, ball travel distance, combination of ball loft and speed, and combination of ball loft and ball travel distance;
characterised by:
selecting swing parameters for analysis by the computer,
a) on a tested and confirmed scientific basis;
b) with the computer using strategies where a selection from:
i) an individual PADJE and a component of an individual PADJE, being individually coached to increase the magnitude of the said individual PADJE; and
ii) a set of up to three kindred PADJEs and a set of components of up to three kindred PADJEs, being individually coached to increase the magnitude of the said set of kindred PADJEs;
in contrast to traditional coaching methods which favour coaching much more wide-ranging body movements; and
c) with the computer using strategies in coaching PADJEs, where a selection from, PADJEs and PADJE components, of joints are prioritised for coaching using a selection from:
i) priority being given to coaching those joints for which the coached player is found to be more below PADJE-proportion relative comparator values; and
ii) priority being given to coaching joints, based on a combination of: coaching those joints for which the coached player is found to be more below PADJE-proportion relative comparator values; and coaching those joints which typically have higher absolute magnitudes of PADJE for a selection from average groups of players and comparator groups of players;
where the term ‘PADJE’ refers to: positive joint energy generated across a joint of said model, over a selection from: the course of the downswing; and a defined portion of positive joint energy over the course of the downswing, such as a portion which lies between the attainment and completion of defined proportions of the completed magnitude of a PADJE, such as 15% and 85%, respectively, of the completed magnitude of the PADJE; the term ‘set of kindred PADJEs’ refers to PADJEs which are found to be best coached with other PADJEs of the kindred set rather than coached individually; the term PADJE-proportion' value refers to a player's individual PADJE value expressed as a selection from, a proportion of the player's total PADJE value and a proportion of the greater part of the player's total PADJE value, such as total PADJE less right knee PADJE for players who swing in the usual right to left direction; and where the term ‘relative comparator values’ refers to values, relevant to the player, against which the player's values can be compared, and which are relative rather than absolute values, such as a player's individual PADJE-proportion values; and the term ‘comparator groups of players’ refers to groups of players against which the player can be appropriately compared, such as a group of players with similar handicap skill to the player.

140. A method of analysing and coaching a non-putting golf swing, involving a player and a club; using a computer and measuring apparatus; which comprises the following steps:
using the measuring apparatus to obtain measurements of the swing;
using the computer to determine swing parameters from said measurements, including kinetic swing parameters, utilising a model which mimics at least part of the player and club, and which mimics a plurality of body segments and at least one body joint, and at least one of the body joints connects two body segments;
selecting swing parameters for analysis; including swing parameters which are energy-related parameters related to energy generated across individual joints in said model; and
analysing the swing from the selected parameters, including evaluation and assessment; where an intended outcome is an improvement in the strength of the swing, where an improvement in the strength of the swing is understood to mean a selection from, an increase and prevention of a decrease, in a selection from clubhead speed at impact, clubhead kinetic energy at impact, ball speed, ball travel distance, combination of ball loft and speed, and combination of ball loft and ball travel distance;
characterised by:
A) selecting swing parameters for analysis by the computer,
a) on a tested and confirmed scientific basis;
b) with the computer prioritising the use of a selection from PADJE magnitudes and PADJE component magnitudes over:
i) the PADJE characteristics of consistency; contiguity; sequencing; vector components; energy peaking; energy rates of ramping up; and energy rates of ramping down; and
ii) the swing parameters of negative joint energy; style variations; segment energy; and segment energy sequencing;
B) analysing said swing parameters using the computer, using a selection from:
evaluating said parameters; assessing said parameters; comparing said parameters to those of previous swings by the player; comparing said parameters to those of swings by other players; and comparing said parameters to those deriving from information on the swings of other players; and
C) coaching the swing in a cycle which includes the player executing a swing, using apparatus to measure the swing, using apparatus to analyse the swing, using apparatus in the provision of fast feedback on the swing, and the player executing a further swing;
where said fast feedback on the swing:
i) is provided within one minute at most, of the swing being executed;
ii) is provided prior to the execution of said further swing;
iii) is provided to a selection from: the said player; system apparatus; and a human involved in coaching the player;
where the term ‘PADJE’ refers to: positive joint energy generated across a joint of said model, over a selection from: the course of the downswing; and a defined portion of positive joint energy over the course of the downswing, such as a portion which lies between the attainment and completion of defined proportions of the completed magnitude of a PADJE, such as 15% and 85%, respectively, of the completed magnitude of the PADJE; the term ‘3D vector components’ refers to vector characteristics of a selection from forces, angular displacements, angular velocities and torques associated with the generation of PADJEs; the term ‘consistency’ refers to consistency between individual swings; the term ‘sequencing’ refers to the relative sequencing of individual blocks of energy generated at the different joints; the term ‘contiguity’ refers to the contiguity of blocks of energy generated at a joint; the term ‘smoothness’ refers to the smoothness of generation of blocks of energy at a joint; the term ‘energy peaking’ refers to peaking of PADJE joint power generated at a joint; the term ‘energy rates of ramping up and down’ refers to rates of ramping-up and ramping-down of blocks of energy generated at the different joints as muscle groups switch on and off at a joint; the term ‘negative joint energy’ refers to energy absorbed across a joint; the term ‘style variations’ refers to players' different technical styles where each of the styles is considered to represent accomplished swing performance; the term ‘segment energy’ refers to segment kinetic energy; and the term ‘segment energy sequencing’ refers to the relative sequencing of the development of segment energies in the swing.
